(19) United States
(12) Patent Application Publication
(10) Pub. No.: US 2025/0386778 A1
(43) Pub. Date: Dec. 25, 2025

(54) METHOD OF REDUCING THE CO2 LEVELS IN THE ATMOSPHERE BY ADDITIONAL CARBON SEQUESTRATION IN EXISTING TREES THROUGH APPROPRIATE TREE SELECTION AND OPTIMIZATION OF SUPPORT MEASURES

(71) Applicants: Martin Tuser, Roztoky (CZ); Zaneta Tuserova, Roztoky (CZ)

(72) Inventors: Martin Tuser, Roztoky (CZ); Zaneta Tuserova, Roztoky (CZ)

(21) Appl. No.: 19/311,187

(22) Filed: Aug. 27, 2025

Related U.S. Application Data
(63) Continuation of application No. PCT/CZ2024/000009, filed on Feb. 29, 2024.

(30) Foreign Application Priority Data
Mar. 3, 2023 (CZ) PV 2023-86

(51) Int. Cl. A01G 23/00; A01G 15/00; B01D 53/34; B01D 53/62; B01D 53/84

(52) U.S. Cl. CPC A01G 23/00; A01G 15/00; B01D 53/346; B01D 53/62; B01D 53/84; B01D 2257/504; B01D 2258/06

(57) ABSTRACT

A method of reducing atmospheric CO2 levels by additional carbon sequestration in existing trees through tree selection and optimization of supporting measures is provided. A territory where the measures are to be implemented is defined. A group S trees is selected, which represent trees that are important for carbon sequestration into biomass and are suitable candidates for adoption of support measures. Supporting measures for Set S trees are implemented that ensure maximum carbon sequestration over a longest possible period and minimize costs of management and implementation of the measures. The method will prevent the felling of the trees and will bring about a natural and additional growth of tree biomass that would not otherwise happen. As carbon sequestration is directly dependent on the gain in tree biomass, this additional growth will lead to an increase in the amount of CO2 sequestered in the tree.

This application is a continuation of international application number PCT/CZ2024/000009 filed on Feb. 29, 2024 and claims the benefit of Czech application number PV 2023-86 filed on Mar. 3, 2023, which are incorporated herein by reference in their entirety and for all purposes.

### TECHNICAL FIELD

The invention relates to a method of maximizing the reduction of CO2 levels in the atmosphere by additional carbon sequestration in existing trees through tree conservation, tree inventory and appropriate selection of trees, watering trees, application of other measures for improving their habitat, implementation of special interventions on trees and optimization of the implementation and sequence of these steps. Reducing CO2 levels in the atmosphere is one way of combating climate change.

In addition to the CO2 reduction that is realized by conserving the existing tree, maintaining its natural potential to sequester carbon from the atmosphere, and additional support the tree with the objective of maximizing additional carbon sequestration, another effect of the invention is to preserve and maximize other ecosystem services of the tree, advantageously with a simultaneous emphasis on maintaining operational safety and long-term perspective of the tree.

Another benefit of the invention is the cost savings and opportunity cost savings, such as space for combating climate change through nature-based solutions, which is scarce, saving trees stock to plant, which is scarce, and saving various types of costs. The invention also contributes to the creation of new jobs.

The invention is based on existing green infrastructure, particularly the trees already growing, which are now available both in settlements and in the open landscape. This means that the invention is about combating climate change using natural solutions. It uses existing state-of-the-art methods, the new use and combination of which will make the fight against, mitigation of, and adaptation to climate change significantly more effective, especially, but not exclusively, in human settlements.

The invention has an almost immediate effect in the fight against climate change, unlike many other solutions in use today or planned for the future. This is a significant benefit, as the later the causes of climate change are eliminated, the higher the cost of eliminating the climate change and the damage associated with it.

The invention also describes the further use of the results of the tree inventory and selection of trees, their watering, the adopting of measures for improving their habitat, and the implementation of special interventions on trees, whereby implementing the measures according to the present invention it is possible, in particular by using modern precision forestry methods, often from existing data, to define a carbon credit resp. an ecosystem services credit, which can be sold on the market and thus ensure that the trees already growing in the settlements are conserved, and that sufficient and additional care is given to these existing trees thanks to the new financial resources available to tree owners thanks to the invention. Moreover thus contribute to additional carbon sequestration that would otherwise not be sequestered.

Thus, the invention primarily describes steps to optimize the use of existing methods of improving habitat conditions of purposely selected trees and other standard and special tree interventions to achieve the most efficient use of resources to minimize the carbon footprint of actions associated with CO2 sequestration and storage of carbon that would otherwise remain in the atmosphere. Optimization is based on the selection of the appropriate steps that lead as quickly as possible to the desired result of reducing the CO2 content in the atmosphere when these steps are supported by the incentive for the actors in the form of the definition of the carbon credit mentioned above, without which the selection and optimization itself would probably not be effective, and the CO2 reduction would not occur.

### STATE OF THE ART

Current natural-based strategies (solutions) for combating climate change currently only use trees in sets (e.g., forest), including currently the closest mechanism that works with trees in urban areas, the City Forest Credits protocols, or new tree plantings, but not existing large trees individually. Therefore, we can find measures that lead to the preservation of forest or green space in large areas, corresponding to the present invention's conservation part. These projects cannot provide further additional support for the production of forest ecosystem services, including carbon sequestration, through implementing other measures because the forests are too large and often remote. We can also see a large number of tree planting initiatives that will only bring benefits in the distant future, however, if these newly planted trees survive. The mortality rate of newly planted trees is high, and the expected life span of a tree in urban areas is 7-28 years, according to various sources (Roman, Lara &S catena, Frederick. (2011). Street tree survival rates: meta-analysis of previous studies and application to a field survey in Philadelphia, PA, USA. Urban Forestry & Urban Greening-URBAN FOR URBAN GREEN. 10. 269-274. 10.1016/j.ufug.2011.05.008.), and on top, their planting leaves a significant carbon footprint. A tree planted in a city becomes carbon negative after a period of about 30 years, but the vast majority of the trees will not reach that age. Aaron C. Petri, Andrew K. Koeser, Sarah T. Lovell, Dewayne Ingram; How Green Are Trees?—Using Life Cycle Assessment Methods to Assess Net Environmental Benefits. Journal of Environmental Horticulture 1 Dec. 2016; 34 (4): 101-110. doi: https://doi.org/10.24266/0738-2898-34.4.101.

The CO2 levels in the Earth's atmosphere has risen from an average of about 280 ppm in 1750 to an average of about 410 ppm in 2021 (according to IPCC report, 2021, (7)), and the levels continue to rise. This increase of the CO2 levels is largely anthropogenic, i.e. caused by humans. Humans burn fossil fuels, in which carbon from the past is trapped, and fossil fuels oxidation produces CO2, which is released into the atmosphere. Along with increasing concentrations of other greenhouse gases, the CO2 is the main cause of climate change through amplifying of greenhouse effect. If humans did not burn fossil fuels, the Earth's carbon cycle would be balanced (stored and emitted carbon would be approximately equal) and the greenhouse effect caused by greenhouse gases would operate as it has in the past. The Earth's temperatures were favorable for life even under some natural oscillation.

We consider climate change to be a phenomenon that is negatively affecting and will in the future affect not only human life, but the entire biosphere on our planet and may lead to the Earth becoming uninhabitable for humanity. It is therefore in everyone's interest that humanity fights climate change. Any way that mitigates or stops climate change is valuable. In practice, it is a whole complex of different solutions, because no single solution is capable of solving climate change on its own, or it has its limits. Therefore, these solutions must be combined.

Very roughly, we can summarize that annual anthropogenic greenhouse gas emissions are equivalent to about 40 GT of CO2 (40 billion metric tons), with CO2 being the major share of emissions.

The application of this invention will not only reduce CO2 levels in the atmosphere, but will also result in an extreme increase in the production of other ecosystem services of trees in urbanized landscapes, leading to an improved quality of human life in settlements, including a reduction in damages to human health caused by climate change and the associated costs. It will also lead to a reduction in CO2 emissions from energy consumption, e.g. because the increased ability of trees to cool their surroundings will reduce electricity consumption for cooling of buildings.

### Precision Forestry

Precision forestry is a set of technologies and methods that can be used separately, leading to more efficient forest management and increased biomass production and quality. These practices are beginning to be used by forest owners/managers to increase yield and reduce costs.

Precision forestry practices include, for example, the digitalization of forest inventories, often using 3D technologies (e.g., LIDAR) combined with camera imagery in different light spectrums, carried by drones, humans, or vehicles, and subsequent input into geographic information systems connected to analytical tools for harvesting and forest management planning. In addition, precision forestry methods include, for example, modifications of soil conditions, including fertilization, based on accurate soil analyses for the particular site. These modern methods can also include, for example, using mobile devices or phone apps for, e.g., forest data collection or harvest planning or recording. Another area of application of modern methods relates to fully mechanized harvesting and logistics, targeted efficiency of seedling cultivation, or breeding of new varieties suitable for specific sites.

One of the earliest applications of precision forestry was the introduction of the so-called Cut-To-Length (CLT) mechanism about 20 years ago when individual manual operations performed by a forest worker based on his ad-hoc decisions were replaced by a harvester that did many of the worker's operations automatically or on a plan planned ahead of time.

The problem with using these new precision methods in forest management is that the use is limited to increasing forest productivity efficiency, i.e., reducing costs and optimizing processes and biomass yield. Their use is not related to the fight against climate change.

This means that even those trees that are most effective at mitigating climate change are removed from the forest during harvesting, even though the benefits of their ecosystem services production are many times greater than the value of the wood. In temperate mainland forests, we can encounter situations where individual trees 200 years old or more, e.g., remnants of native forest, are found in commercial forest plantations and harvested. As these are trees of a different species than the monoculture of the forest, the wood is sold as firewood. As an example, we can mention a situation we have personally encountered. In the spruce monoculture in the Czech Republic, beech or oak trees often grow to mark the boundaries of individual plots, often with a diameter (DBH) of 150 cm. These are massive trees, but because they make up only a fraction of the total number of trees felled, it is not worthwhile to find buyers for their wood, and they are sold off locally for firewood. With such sizes, they can store an estimated 25 tonnes of CO2 and sequester 300-400 kg of CO2 annually. If the invention can be applied in practice and includes an incentive component in the form of carbon credit, it will be a valuable source of income for small forest owners who are unaware of such a large tree's function. The tree would stay in place growing and could continue providing its ecosystem services, including carbon sequestration, for 100-200 years. Without the application of the invention, these trees will continue to disappear from forest stands.

In the management of non-forest trees (including trees in settlements), these methods are mainly used in the field of tree inventory. Here, their use is limited to creating or updating records (e.g., using LIDAR scans and positioning devices) and data storage as such (GIS), so, at most, they have an auxiliary function in obtaining and storing information. The benefit of using these methods is that they streamline the recording and storage processes. However, this information is not used to combat climate change actively, i.e., e.g., deliberately repeating measurements at regular intervals, detecting tree biomass growth, and implementing measures to encourage such growth.

### Green Space Inventory in Settlements

Owners or managers of green spaces in populated areas, e.g., in cities, create green space inventories (passports). Owners or managers of smaller green spaces, such as school grounds, botanical gardens, and similar institutions, also keep these inventories. Road managers also keep inventories, who must ensure road safety, and manage some of the trees near roads. They are often obliged to create such records, whether for legal reasons, as required by insurance companies, or similar.

Inventories are very expensive and time-consuming to acquire. Although the records currently benefit owners and managers of green spaces, especially in streamlining maintenance and planning processes, not all owners (e.g., cities and municipalities) can afford to process them to a sufficient extent and quality, or they are not done frequently, haphazardly.

Green space inventories today are mainly in the form of geographic information systems, although it is also possible to use more primitive methods, such as a notebook with information written by hand. Inventories, including GIS systems, contain information down to the level of the individual tree. The information in the records provides, for example, data on the location and species of the tree, its size and age, its health status, its history of care, and often also photographs of the tree, as well as other data. An extension of the GIS inventory is also a record of the ecosystem services provided by trees or sets of trees, including carbon quantification in the tree biomass, often in appropriate units (e.g., kg). These ecosystem services can also be quantified in monetary terms according to methodologies accepted in a given area (e.g., country). Information stored in GIS and simpler forms of records can also be aggregated or filtered to generate reports on data, including ecosystem service volumes, for tree sets or larger area units.

These green space inventories in the form of GIS serve primarily to register assets, but they can also serve as a basis for planning green care, monitoring costs, or a tool for public information.

Green space inventories may include data on trees, shrubs, and other vegetation elements, such as lawns. For the purpose of the present invention, we will focus on data on trees or sets of trees only, called tree inventories.

The information for the GIS records is collected through field collection. Data collection is done either manually (by people) or by machine.

During manual data collection, a trained person goes from tree to tree and obtains data directly at the tree by visual assessment, measurement by instruments, documentation, and recording of the data obtained, e.g., by entering the data into a database, often in the form of a geographic information system (GIS).

During the manual data collection, among others, the tree species is determined, the circumference or trunk diameter (DBH) is measured in the breast height (130 cm; the height value may vary according to local practices in the territory), and the height of the tree. These data are important, among others, for the most accurate calculation of tree biomass. Standard tree measurement and survey tools are used to collect these data. Traditionally, a tree diameter tape, a forestry tree caliper, or/and a measuring bar are used to measure the diameter of a tree. More accurate results are possible by measuring these data with, for example, rangefinders, hypsometers, and clinometers based on laser or similar technologies. The instrumentation and measurement procedure are dealt with in more detail in the sectoral methodologies, which vary in detail in different territories (countries). In the Czech Republic, for example, Adolt R., [symbol] M. (2021). [symbol] [symbol] [symbol] [symbol] [symbol] [symbol] [symbol] [symbol] [symbol] (2016-2020). [symbol] [symbol] : [symbol] [symbol] [symbol] [symbol] [symbol] (ÚHUL), 644 s., ISBN 978-80-88184-35-5., abroad it is, e.g., Leverett R., Bertolette D. (2015): American Forests Tree-Measuring Guidelines. The Native Tree Society. https://www.americanforests.org/champion-trees/how-to-nominate-a-tree/.

Newer measurement methods also use more accurate methods of so-called precision forestry, i.e., 3D modeling based on data captured by a LIDAR scanner. From these data collections, it is possible to read the stem diameter and height, which are then entered into the records.

The tree's location is determined by the address or any positioning system, e.g., GPS positioning coordinates.

In machine data collection, data are acquired by a set of devices such as positioning devices, e.g., GPS modules, still cameras or motion picture cameras with sensitivity to different spectrums of light, including visible light and/or 3D scanners, e.g., LIDAR scanners, which are placed on portable or mobile platforms, whether ground or airborne or on mobile phones or tablets. Aerial or satellite imagery is also used and can supply part of the data used for green space inventory.

When measuring, either with manual or machine data collection, it is possible to measure and capture canopy diameter and height of canopy cover, which are important for calculating some ecosystem services. Another way to enrich the data in the green space inventory is to measure leaf area and foliage quality, e.g., with cameras.

The GIS inventory software may also include modules that provide data on the carbon content stored in the tree and projected carbon sequestration in the future, typically 1 year. These data are calculated by the system or manually based on so-called allometric equations. However, no one proactively works with this data, so far it only serves as information that can also be made available to the public. Otherwise, this data is of no further use.

The green space inventory process can also include the implementation of AI and machine learning principles to help refine the data.

The problem is that even though this information is available, it is not of much use, and, according to our information, green space managers do not process and, more importantly, do not actively use this information, including actively using it to combat climate change. There are no incentives, that, based on this data, would support the fight against climate change. There is also a financial barrier that reduces the quality or timeliness of the inventory data, limits its scope, or is a barrier to inventory acquisition at all. The randomness of data collection also makes it impossible to work with the data to combat climate change, mitigate it, and adapt urban landscapes to climate change.

### Tree Inventory in Forest Stands

Similarly, forest owners or managers also keep records. They use the same technologies, or rather, most of the instruments, procedures, and technologies used for making green space inventories in settlements are taken from the forest inventory area. The main objective of the forestry inventory is to determine the number of trees and the stock of timber, which is then used for planning harvesting and other forestry activities.

Since suitable trees for the application of this invention are also found in forest stands, it is possible to apply this invention to forest stands, in particular, to focus on individual trees with the highest production of ecosystem services.

The problem is that while forest inventory information exists, it is not proactively used to combat climate change. There are no incentives that, based on this data, would support the fight against climate change in terms of preserving and/or supporting the most productive tree individuals in the stand. Moreover, this information is often acquired as sums for the entire stands (forest), and it is also often acquired based on selected samples of the forest area (sample plots), and results of these are then extrapolated to the whole stand, but not to the level of individual trees.

Owners of trees on private land, e.g., in private gardens or company premises, do not usually measure their trees and acquire tree inventory. The vast majority know nothing about the ecosystem services trees provide, even though they generally value trees. However, even on these private properties, there are trees that are suitable for the application of this invention.

Because there is no accurate data based on standard inventory procedures, it is impossible to quantify trees' ecosystem services on private land. Therefore, it is impossible to define any incentives that would support tree owners on private land and use them to combat climate change.

A completely identical approach to the use of this invention can be applied to trees outside forests, growing in open landscapes, which often have very significant ecological benefits. For the purpose of the present invention, it is possible to measure them using traditional techniques or precision forestry methods and to acquire an inventory. Subsequently, the data from the inventory can be used for the purpose of the present invention.

For the purpose of the present invention, it is advantageous if the measurements during the application of the invention are as accurate as possible. In particular, this involves determining whether and when each individual tree is under stress, particularly from drought, how it responds to the measures within the invention, and also what the results of the measures are, in particular, what the biomass gain of the tree is.

Furthermore, it is essential to say that it is very difficult even for a qualified person to asses without instruments whether an established tree is suffering from water stress (from lack or excess of water). Advanced solutions are the only way to determine this with certainty.

A number of methods and instruments are used for this. The problem is that these instruments and methods are only used in research or limited use in agriculture, not in tree management in urban areas or on private land. Their deployment, ideally on every tree to which the invention is applied, would, in combination with the measures implemented within the scope of the invention, contribute to maximizing the production of ecosystem services by the tree, including additional carbon sequestration, and thus maximizing climate change mitigation and adaptation of the tree's near and distant surroundings to climate change.

### Instruments Applicable for Measuring Tree Drought Stress Intensity

### Soil Moisture Measurement

Moisture meters (soil moisture sensors) working on the principle of measuring the change in electrical capacitance; the result of the measurement is a percentage of soil moisture. The disadvantage of these instruments is the difficulty in interpreting the measured data. E.g., the measurement results soil moisture content of 20%. In clay soil, it means extreme drought; in sandy soil, it is a high moisture level, although the 20% value is the same. The instrument's price ranges from 2,000 CZK; a professional one for permanent use costs about 12,000 CZK.

Soil moisture meters working on the principle of measuring the suction force (tensiometers) or on the principle of gypsum blocks and the change of their electrical resistance. The measurement results in information on how difficult it is for the plant to get water from the soil. Tensiometers are more commonly used in agriculture, and their disadvantage is the maximum suction force limitation. But they are exact. Gypsum blocks are cheap but far less accurate. However, they are a good choice for determining whether the soil is dry or wet.

Measuring photosynthesis and stomatal conductance using porometers. This method is extremely expensive and time-consuming, taking 5-20 minutes per measurement, and therefore not applicable in practice. However, recently, instruments using the principle have appeared that take less period to measure and are more affordable, giving hope that this accurate method may be applicable in urban forestry practice (LI-COR Biosciences GmbH, product Li-600).

Measuring of chlorophyll fluorescence. This method is cheaper than measuring through conductivity; it is also fast, but the measurement shows an indication of drought only at higher levels of tree stress, so it does not fully satisfy the measures' proactivity condition within the scope of the present invention. However, it is a method of monitoring the long-term stress of the tree as a whole.

Measuring of hydraulic conductivity by magnetic resonance imaging. This method is not yet applicable to embodiments of the invention.

Measuring of hydraulic conductivity by sampling and laboratory tests. The result of the measurement is an index that documents the degree of damage to the vascular system of the tree. This method may be a complementary diagnostic method when the cause of reduced tree growth needs to be identified and is not of such practical importance to embodiments of the invention.

Measuring sap flow (transpiration current) using sensors inserted into the tree trunk. This is discussed in a separate chapter below.

Measuring water potential with a pressure chamber is a relatively simple method used in agriculture, especially in viticulture. The more intensive the drought, the more energy must be used to pressurize a certain amount of water from a sample shoot. This method has limitations concerning the necessity to measure water potential at specific times during the day, specifically at night before sunrise.

Measuring the water potential using a psychrometer, which is automatic and continuous. The limitations of this method are its susceptibility to vandalism and the need to reinstall the psychrometer every two to three weeks in a new location on the tree. The instruments for this method are also quite expensive.

Measuring water potential using a dendrometer is an advantageous method because of its relatively low cost and because, in the context of the invention, we are also using dendrometers to monitor tree growth over time, and we also use them to accurately measure tree stem growth and more accurately quantify incremental biomass.

The spectral reflectance method measures drought stress by reflecting light spectra at frequencies in the near-infrared spectrum. This method is applicable to embodiments of the invention because it shows data in near real-time, often using cameras that are carried by satellites or vehicles. This method is promising, especially in the future, when the resolution of satellite data will be higher, and the data will be more accessible.

### Dendrometers

Dendrometers are used to accurately measure the diameter of tree trunks and other parts of the trunk, especially in scientific research. These are precision measuring devices that measure the circumference/diameter of the trunk or other part of the tree, either by means of a tape measure around the trunk, or by means of a point measurement or an expanding frame.

Cameron Clonch, Mark Huynh, Bryson Goto, Alexander Levin, John Selker, Chet Udell., High precision zero-friction magnetic dendrometer, HardwareX, Volume 10, 2021, e00248, ISSN 2468-0672, https://doi.org/10.1016/j.ohx.2021.e00248. (https://www.sciencedirect.com/science/article/pii/S246806722100078X).

The circumference/trunk diameter measurements are either recorded manually by manual reading and recording in a written record or database, or the values are recorded automatically, according to a selected time interval. Data from automatic readings are stored in data loggers or sent directly to the data center for processing wirelessly, e.g., via LPWAN or LPWA network, or, e.g., via GSM network.

The advantage of these instruments is the long-term measurement (even years), the high accuracy of the measurements, and the consistency of the measurements because the dendrometer can stay in one place on the trunk for a long time, and also the data density of the measurements because the interval can be set to, e.g., 10 minutes. This means that it is possible to record accurately, e.g., thickness changes due to temperature changes, water availability etc. It is also possible to optimize the watering, both in terms of the quantity in the watering dose and also the daily watering application time.

The problem is that these devices are only used for research or in agriculture. If we applied the dendrometer to each of the set S trees, we could both measure the biomass growth very accurately and thus refine the results of the application of the present invention, and we could also optimize technical measures to maximize the growth of the tree biomass very precisely.

### Methods and Instruments for Measuring Soil Moisture

Since the amount of water available to a tree is a major factor influencing tree growth, in addition to temperature and access to light, water availability is a very important element in maximizing the production of ecosystem services.

There are a number of methods and they are discussed comprehensively, for example in the presentation [symbol] [symbol] [symbol] . RNDr. [symbol] [symbol] , AMET, [symbol] [symbol] [symbol] , April 2010, available at: https://is.muni.cz/el/1431/jaro2010/Z0075/um/Prednaska_Dr_Litschmann_PudniVlhkost.pdf.

A complete overview of the methods can be found in English, e.g., in the document Soil Moisture: The Complete Researchers Guide. METER Group Inc. https://www.metergroup.com/en/meter-environment/education-guides/researchers-complete-guide-soil-moisture-or

Soil Water Measurement: A Practical Handbook. J. David Cooper. 2016. John Wiley & Sons, Ltd. Print ISBN: 9781405176767 Online ISBN: 9781119106043 DOI: 10.1002/9781119106043

In practice, soil moisture is most often measured using sensors from which the data are remotely read and usually stored in a computer database, where the effects of any watering are evaluated advantageously. Each sensor has its own interpretation methodology, so it is impossible to say in general what values the soil moisture measured at the sensor should be. Advantageously, for the purposes of the present invention, the sensor measurements are only an auxiliary tool to ensure that, on the one hand, the ecosystem service production of the tree is close to the maximum value but that the stability and long-term perspective of the tree is not compromised. This can be achieved, advantageously, by:

Moisture will be measured at the boundary of the root system, i.e., at or beyond the canopy drip line. Furthermore, the water supply (watering) will be adjusted so that the soil moisture oscillates and is not completely stable and so that at least once a year, the tree will be in a drought-stress situation.

### Measuring Sap Flow (the Transpiration Current)

Another method to obtain information on whether the tree has optimal conditions for growth in terms of water availability is to measure the sap flow. Sap flow represents the volume of water that flows through the trunk and skeleton of the tree over a certain period, typically 1 day. The largest volume of a tree and tree stands is represented by a tree water-conducting system, including both wood and phloem; changes in the size of the conducting system represent growth. Current technology allows us to measure quantitative parameters of water transport, structure, and growth at the level of whole trees and stands and combinations of these at the level of individual trees and whole groups of trees, with a mobile set of instruments independent of stationary objects.

Measuring sap flow is very effective in detecting water stress in trees. Lack of water in the soil (drought stress) or excess water causing lack of air (hypoxia) are among the most common causes of individual or mass tree dieback due to abiotic factors.

For example, heat balance or heat flux deformation methods are used to measure sap flow in trees. The measurement results in the volume of fluid (e.g., in liters) containing water, nutrients, and other substances that flow upwards through the tree over a specific time. Because this volume varies over time and under different conditions, we can infer from the interpretation of the data whether or not the tree is suffering from a water deficit. It also allows us to determine, advantageously in combination with a dendrometer, whether our measures, especially watering, are effective and whether the tree has used the irrigation water.

The advantage of this method is the completely direct measurement of water use by the tree; the disadvantage is that the technology is invasive. In order to measure the sap flow, two to three holes have to be drilled in the tree, into which probes are inserted to enable the measurement. Nevertheless, within the scope of the present invention, we consider this method very effective, especially when using a sample measurement on a few selected trees as a representative sample and continuously improving (optimizing) the applied measures.

### Ecosystem Services of Green Spaces, Especially Trees

Ecosystem services are the multiple benefits provided to humans by the natural environment and healthy ecosystems. The ecosystem services of trees are the focus of attention in times of climate change, as many of them help us to mitigate the effects of climate change. This attention has resulted in much research that quantifies many ecosystem services, some even translating them into financial terms.

There is no exhaustive list of ecosystem services provided by trees, but examples of ecosystem services provided by green spaces, especially trees in cities, include cooling of the surrounding space through evapotranspiration (and consequently reducing energy requirements for cooling the interior of buildings), cultural and aesthetic value, shading (and thus reducing heating of surfaces, also reducing electricity consumption for cooling), reduction levels of dust particles and generally air pollutants (and thus increasing the quality of the air we breathe), avoidance of stormwater runoff (and thus reducing sewerage capacity requirements and also increasing water retention in the landscape), increasing the value of buildings in the surrounding area, oxygen production, noise reduction, and many others.

One of the essential ecosystem services of trees is the sequestration of CO2 from the atmosphere, binding carbon in the tree's biomass and storing it for the future. This ecosystem service is exceptional in that its volume, which can be accurately quantified, has begun to be traded on markets as a commodity.

The problem we see with ecosystem services is that the resources invested in research and talking about it are not fully utilized, and the links to tackling climate change are not direct. Moreover, often only partial measures are taken, not comprehensive ones. Arboriculture and dendrology, for example, are entirely isolated from the fight against climate change and only deal with trees' safety and improving their vitality. At the same time, there is, for example, a sustainable development and climate change adaptation manager at the city government level, i.e., the majority owner of the green spaces in the city. However, he or she only wants to plant new trees and is completely unaware of the relationship: ‘the higher the growth of the larger the tree, the higher the ecosystem services production.’ Although arboriculture has the means to achieve more significant tree growth (and thus more significant production of ecosystem services), it does not use them for this purpose. At the same time, both sides lack the financial resources to invest. As a result, not enough is being done to fight climate change effectively. The implementation of this invention radically changes this model situation.

A recent study examining carbon storage in forests in the Pacific Northwest is one of the major scientific papers highlighting the importance of large trees in combating climate change. The study showed that although large-diameter trees (≥53 cm) make up only 3% of the total stems of about 600,000 trees studied, they contribute 42% of the total above-ground carbon storage. The researchers stress the importance of protecting large trees and adjusting the existing forest management policies so that the large trees can continue to sequester carbon and provide valuable ecosystem services as a cost-effective natural solution to climate change in forest ecosystems worldwide.

Mildrexler David J., Berner Logan T., Law Beverly E., Birdsey Richard A., Moomaw William R. (2020). Large Trees Dominate Carbon Storage in Forests East of the Cascade Crest in the United States Pacific Northwest, USA. Frontiers in Forests and Global Change, March 2020, PAGES=127, https://www.frontiersin.org/article/10.3389/ffgc.2020.594274 DOI=10.3389/ffgc.2020.594274ISSN=2624-893X.

Based on this study, a model was developed that was initially intended to market our other invention (CZ33544U1/WO2021027980A1) and answers the question of how many trees need to be planted to replace one large tree that is cut down. Leverett Robert, Tuser Martin, Moomaw William. 2021, We can't plant our way out of the climate crisis. Available at https://www.treeib.com/carbon-storage-in-large-trees-by-robert-leverett. If we compare, in terms of the amount of carbon stored, a 100-year-old oak tree with a trunk diameter of 130 cm and a height of 30 m with the trees we plant in our cities (trunk circumference of 14-16 cm, age of about 7 years), the replacement amounts to about 3,000 such trees (calculation of the biomass of the tree and the carbon stored in it according to the FIA COLE model, Bob Leverett et al., taxon Quercus rubra). If the wood from a large tree is burned (the stored carbon is released back into the atmosphere), we must roughly double this number. Moreover, if we add to this the mortality of newly planted trees in cities, we may end up with a figure of 10,000 newly planted trees per large tree felled. Even if we wanted to plant that number of trees, we would have no space for them, and the financial cost would be extremely high, as would the carbon footprint created throughout the process of growing, planting, and aftercare of the new trees.

If we look at the same question of replacing a large tree by planting new ones in terms of the amount of carbon (CO2) sequestered per year, the numbers are not so high, but the result depends very much on how much the tree grows in a given time. The volume of almost all ecosystem services trees provide is directly related to their annual biomass incremental growth. The annual CO2 sequestration of our model oak tree can range from negative values (with the loss of larger branches) to an average of 250 kg of CO2 to 1 ton of CO2 if the tree grows well. In contrast, for our model newly planted tree with a trunk circumference of 14-16 cm, if it grows at all in the early years, the amount of CO2 sequestered ranges from zero values to an average of 1 kg to 3.5 kg in extreme growth. In the case of annual carbon sequestration, we are, therefore, in the range of 250-280 newly planted trees per large tree. Leverett Robert, Tuser Martin. 2021.

If we then want to calculate carbon sequestration in the following years, we find that a younger tree will never catch up to a 100-year-old tree, even though it may appear to grow faster visually.

The situation is similar for other ecosystem services.

Relationship Between Ecosystem Services Provided by Trees and their Biomass Growth

There is a very clear link, and a direct correlation, between tree biomass growth and the ecosystem services volume the tree provides.

The clearest correlation is confirmed for carbon sequestration. The volume of CO2 sequestered is determined by the volume of tree biomass that is added. About half of the dry biomass is carbon, so the relationship is linear.

However, similar relationships could be found for other ecosystem services. The larger the tree, its leaf area, and its root system, the more water it can evaporate through evapotranspiration. The more water it evaporates, the more energy it removes from the environment to convert water into vapor, and the more it cools the microclimate. Similarly, e.g., for shading or noise reduction, a better-growing tree has a larger leaf area or/and, at the same time, a higher density of leaves, and thus the tree provides more shading or noise reduction, etc.

The problem today is that these contexts are not well known; if they are known, they are not communicated and used comprehensively to combat climate change. Moreover, the owners of trees and other green spaces are not rewarded for the services that their property provides to all and are not incentivized to maximize them. Maximization means, in particular, encouraging maximum tree growth.

### Relationship Between Tree Cooling Effect and Sap Flow

The ability of trees to cool the microclimate is well known, which is why trees are so valued in settlements. That is why many experts are trying to test tree species that can survive the warming climate, higher number of very warm days, stronger solar radiation, compacted soil, and other stress factors that limit the viability and longevity of traditional urban trees. Each region's newly tested tree species range varies according to the local climate. However, almost all trials are aimed at finding drought-tolerant tree species. However, this may hide a danger that is being neglected.

There is a great deal of variation between different species of tree species in terms of their cooling effect on the microclimate. The cooling effect of trees depends mainly on two factors. These are the leaf area index (LAI) and the transpiration rate, represented by the sap flow.

Gillner Sten, Sten, Vogt Juliane, Tharang, Roloff Andreas, Dettmann Sebastian. (2014). Cooling effects of different urban street tree species. 10.13140/2.1.2945.2807.

Unfortunately, most drought-tolerant trees either have a smaller leaf area index or a lower transpiration rate, which are their adaptation tools for dry and hot habitats. However, the problem is that if we plant drought-tolerant trees everywhere, we will lose much of the cooling potential of the trees we now have in cities. As an example of reduced cooling potential, the small-leaved linden (Tilia cordata), which is common in our region, could be replaced to a large extent by, for example, Ginkgo biloba, which is more drought resistant but has less cooling effect.

Therefore, it is extremely important to preserve the existing trees we already have in the settlements, as it is possible that we may not be able to use these species in the future.

### Method of Cooling Settlements and Preventing the Heat Island Effect

High ambient temperatures are a hazardous accompanying phenomenon of climate change. This means that the climate is warming, represented by, for example, an increase in average temperature, but also by an increase in weather extremes such as heat waves, an increase in very warm days (the definition of which depends on the territory) and ever higher hottest temperature records. This has negative consequences for the population's quality of life and the economy, the burden on the health system, and the impact on everything living in the area with increased temperatures.

The accumulation of heat energy, especially from solar radiation, together with other influences, causes a heat island effect, where, in simple terms, the temperature in the city is higher than in its surroundings. These are the primary reasons why, for example local governments and other entities try to cool the city.

If we look at the recommendations to reduce or prevent high temperatures in the city, we find solutions such as converting roofs and paved surfaces to reflect more solar radiation, converting conventional roofs to green roofs, building green facades, using water bodies and features, and future planning measures such as designing urban sprawl to avoid the heat island effect. A final, very common recommendation is planting new trees or, eventually, creating other green spaces.

These recommendations, including tree planting, demonstrate a misunderstanding of the cause of urban overheating, offer only solutions to the symptoms, and produce an extreme carbon footprint, contributing to climate change's acceleration. For example, the green facade in the Central European region usually has to be continuously irrigated by a system connected to an electric pump and is grown in plastic boxes on an additional built structure. Plants are planted in them, and their production creates a carbon footprint that will never be offset because green walls need intensive maintenance. Often, if the power goes out, most plants wither and must be replaced. Specifically, green facades are extremely expensive both to acquire and to operate.

The problem with this practice is that it is a reactive solution to the problem of high temperatures, i.e. an after-the-fact solution that does not address the cause. The primary cause is the high CO2 level in the atmosphere. These recommendations do not include a proactive component, i.e. efforts to mitigate climate change in the short term, they also produce large amounts of additional greenhouse gas emissions, especially CO2.

This invention can provide a very effective urban cooling solution with a negative carbon footprint, applicable and effective almost immediately at a lower cost, which brings many other cobenefits. Moreover, that is the use of existing trees already growing in the city, especially the large ones, so that selected trees with the greatest cooling potential are intentionally watered to cool their surroundings on hot days. Without the application of the invention, that is, intentional watering, the tree's surroundings would be cooled less due to the natural response of the trees to high ambient temperatures, i.e., the closing of the stomata to reduce transpiration and tilting of the leaves to reduce the leaf area index. In doing so, additional carbon sequestration will occur, preserving the tree and the carbon stored in it and maximizing other ecosystem services such as aesthetic value or oxygen production. This cooling will be more effective than without the application of the invention because all the implemented measures will interact synergistically and will thus lead to an ideal result limiting close to the maximum volume of ecosystem services produced according to the genetic makeup of each tree.

### Decision on Tree Conservation and Support of Trees

We know from our cooperation with large owners of trees in urbanized landscapes (local governments, urban green managers, and others) and from our experience in putting innovative tree care practices into practice (CZ33544U1/WO2021027980A1) that above-standard tree care is a purely political decision. Decision-making at lower levels of municipal leadership is completely ineffective because the increased care costs are not later approved by the highest levels of municipal government. However, if the method according to the present invention is implemented, each tree is converted into a financial asset that generates a profit to cover the increased care costs. This concept of converting the value of a tree into a measure of value-money, can make policy decisions easier because it is a universally accepted and understood concept.

The urban green management system is usually completely separate from the climate-related policies of cities. Climate action includes targets such as ‘we plant a million trees.’ In contrast, urban green space management targets include measures such as ‘we will ensure the safety of the tree so that it does not endanger the safety of people.’

This needs to change because large trees store and sequester disproportionately more carbon than small trees. The relationship is not linear, and a person outside the field cannot imagine how effectively large trees store and sequester carbon.

### Preventing Tree Damage and Avoiding Tree Felling

Preventing tree damage is of great importance for the embodiment of the invention, particularly its optimization. This is because almost all damage to a tree that results in a reduction in its performance in ecosystem services production or necessitates its removal can be avoided by prevention. An example is damage to the root system by excavation. The moment a root that is more than 10 cm in diameter is cut at any distance from the trunk, there is a very high probability that, over time, pathogens entering the wound will cause rot. This rot will gradually, depending on the particular tree's conditions, reach the trunk and its tissues over several years and cause the trunk to rot. The result is a cavity in the tree trunk that weakens the trunk strength. So, it is common for the tree to be cut down 10-20 years after the damage because it is a safety risk to people and property. In a worse case, where the risk is not identified, the tree can cause direct damage to health, life, or property. This damage would be unlikely if the large diameter root had not been damaged. The root would not be damaged if the excavation was carried out at a suitable location or if a gentle technology, such as excavation with a pneumatic spade, was used.

Another example is the failure to water a tree during a drought episode. Visually, assessing whether a tree is suffering from drought stress is very difficult. Instrumental methods are described in the present invention for assessing the risks associated with water stress, but these are not used in everyday practice. Similarly, watering mature trees is very rarely used. Drought stress is cumulative and can result in reduced biomass growth over the next few years, damage to roots or a reduction in the root system, and greater susceptibility to damage by pathogens. Crown dieback due to drought results in pruning, thereby reducing the mass of stored carbon (C0) and the creation of large wounds that later lead to cavities (the mechanism is similar to the previous case of root damage). After two or five years, drought stress may result in the complete death of the tree, which must be felled. This results in losing its value in producing ecosystem services, including carbon storage and sequestration (C0 and C1 or C2). This loss of value would not occur if 500-9,000 liters of water had been supplied to the tree at the right time in the right place during the drought episode.

The arboriculture and tree physiology literature describes the vast majority of procedures and principles. An example is the arboricultural standard SPPK A01 002:2017 Ochrana [symbol] [symbol] [symbol] . [symbol] Jaroslav et al. [symbol] [symbol] [symbol] . Agentura ochrany [symbol] a [symbol] ČR. Available online at https://nature.cz/platne-standardy. Unfortunately, although these procedures and principles exist, they are not applied in daily life, and therefore, significant losses occur, even if they are not visible immediately after damage happens, but in several years.

Preventing the felling of trees in urbanized landscapes through regulations and policies is still dysfunctional and is related to a fundamental misunderstanding, or rather ignorance, of the importance of the large trees presented in this invention. It is essential that cities, municipalities, and other tree owners, especially in urbanized landscapes, make every effort to prevent the loss of large trees. Indeed, as the present invention shows, we cannot replace the ecosystem services of a large tree by planting a new tree or a group of small trees anytime soon, not to mention the overall carbon footprint of the entire operation.

### Proactive Tree Interventions

Today, the main problem of tree care is the reactive implementation of measures. Reactivity, in this sense, means that we react to damage that has already occurred by taking action. Examples include a lack of rainfall and trees being under severe drought stress for three months. By the end of the season, 20% of the trees will have crown dieback. As this is an emergency situation, immediate action is needed, and dead branches are removed by pruning. This lack of proactivity results in significant losses:
Significant financial costs are incurred for tree pruning.
An allocation of workforce for that operation could be used to work on climate change mitigation elsewhere.
Some of the stored carbon in tree biomass is lost when it is cut.
There is a loss in the potential for producing ecosystem services, including carbon sequestration, as cut branches lose their function.
There is a loss of biomass growth potential in subsequent seasons, as the drought results in the dieback of a large portion of fine root biomass that is involved in storing the tree's nutrients through the dormancy period until the start of the next season. The consequence is a weakened tree biomass growth in the next few seasons.
A carbon footprint is generated by removing dry branches, transporting them, and disposing of waste.

Proactivity in this sense of this invention means detecting a negatively acting stressor and taking measures to eliminate or mitigate it before the damage has occurred. In the context of the previous example, it may be suggested that trees should start to be watered after 1 month under drought stress. In this way, losses are eliminated or at least mitigated, and the total costs of remediation are lower than those of reactive measures. However, most importantly, the maximum potential for producing ecosystem services from trees that we need now in the short term of the next 30 years is maintained and utilized.

Other examples of proactivity include eliminating the possibility of vehicles driving in the area of the root system, all measures to protect trees during construction activities, and others. One important group of such proactive measures is the formative pruning of newly planted and young trees. In the case of on-time formative pruning, small-diameter wounds are created because the removed branches are not yet large in diameter. Small wounds cannot cause the cavities that form on large-diameter wounds. Such branches may not be removed in the future, e.g., as part of dangerous co-dominant leaders' remediation operations, and will not create a large wound that does not heal completely. Such an approach significantly increases the tree's chances of reaching maturity, carbon neutrality, and extensive ecosystem service production.

Although these measures exist, they are rarely applied and applied sporadically and randomly. The preference for proactivity over reactivity in the context of the present invention significantly reduces tree mortality, extends tree life, reduces the cost of implementing the measures, reduces the loss of biomass and stored carbon, and significantly promotes maximization of ecosystem service production by the tree. Because measures applied proactively in time often do not require heavy machines, the carbon footprint of proactive measures is often lower than that of reactive interventions.

### Strategies to Combat Climate Change

In a very simplistic way, and this is only illustrative, the strategy for mitigating or reversing climate change is mainly to reduce greenhouse gases in the atmosphere.

This has two basic mechanisms: reducing greenhouse gas emissions into the atmosphere now and in the future and removing greenhouse gases from the atmosphere, both by natural and technical means.

There are several greenhouse gases, e.g., methane, in addition to CO2, and a mechanism for converting other greenhouse gases to CO2 equivalents is used to quantify the emissions causing climate change.

There are two primary sources of funding for these mechanisms to combat climate change: the system of emission allowances (e.g., in the EU, EUA-EU Allowances) and their trading on the so-called mandatory market for emission allowances (e.g., in the EU, EU ETS-European Union Emissions Trading Scheme) and the trading of carbon offset credits from carbon offset programs on the so-called voluntary market for carbon offsets. These are organized by various entities, most often non-profit organizations. Voluntary markets are mainly intended for entities not legally obliged to buy emission allowances issued by the state and wish to offset their carbon footprint or for individuals and other entities.

In particular, the voluntary market for carbon offsets is relevant for the purpose of this invention, but the invention can also be financed by the mandatory market or directly from public budgets.

### Combating Climate Change Through Trading Carbon Offsets

Climate change is mainly caused by excess of greenhouse gases in the atmosphere. There are more of them than before the Industrial Revolution, which is why the Earth's average temperature is rising. This effect is undesirable because it is causing climate change, the consequences of which are well known.

The main greenhouse gas is carbon dioxide (CO2), but many other gases cause the greenhouse effect, such as methane. Greenhouse gases present in the atmosphere cause the greenhouse effect. To the extent that it did in the past, the greenhouse effect causes conditions on Earth that are suitable for life because, without it, the average temperature on Earth would be about −18° C. (0° F.) compared to about 15° C. (59° F.) today.

On Earth, CO2 participates in the carbon cycle, where, on the one hand, CO2 is released into the atmosphere, e.g., through animal respiration or the decomposition of dead plants, and on the other hand, it is consumed, e.g., bound by photosynthesis in plant tissues or stored in the geosphere in the form of shells of aquatic animals (e.g., shells to form limestone) or coal, where it is fixed for millions of years.

In pre-industrial times, until about 1750, this carbon cycle was in balance, meaning that the volume of CO2 removed from the atmosphere was approximately equal to that of CO2 released. After about 1750, humans began to release the carbon stored in the geosphere into the atmosphere, mainly by burning fossil fuels and, for example, by producing building materials such as lime, made from limestone. Climate change is, therefore, caused by releasing additional carbon, mainly in the form of CO2, which has hitherto been stored in the geosphere. If we fail to bring the carbon cycle into balance, the average temperature on Earth will continue to rise, and climate change will continue, with serious negative consequences for civilization and also other organisms living on Earth.

According to the Intergovernmental Panel on Climate Change (IPCC), the world must halve man-made carbon dioxide (CO2) emissions by 2030 (and significantly reduce emissions of other greenhouse gases) to maintain a 50% chance of avoiding the worst impacts of climate change.

By 2050, CO2 emissions will have to reach carbon neutrality, which means that the amount of CO2 emitted into the atmosphere will have to be in balance with the amount absorbed from the atmosphere. Such reductions require global and local action by national and local governments, together with business and civil society.

Countries, companies, and others will need to use all the tools at their disposal to achieve their emission reduction targets.

The best measure towards carbon neutrality is to avoid greenhouse gas emissions. This is possible, for example, by stopping the use of fossil fuels or replacing all the petrol and diesel consumed by stopping driving cars. It is clear from such an example that avoiding emissions has limitations; emissions cannot be entirely eliminated without civilization ceasing to exist in its present form. This means that a combination of tools must be used to reduce emissions as much as possible. Those greenhouse gas emissions that cannot be eliminated must be offset by other instruments. From a global perspective, the IPCC believes that it is irrelevant whether emissions are eliminated in one place or perhaps on the other side of the world because greenhouse gases move throughout the entire volume of the planet's atmosphere and work as a unit. It is equally indifferent by what means (instrument) emissions are eliminated.

Such instruments are called carbon offsets, which, if used responsibly, are a critically important part of the fight against climate change.

A carbon offset is a reduction in carbon dioxide or other greenhouse gas emissions made to offset emissions produced elsewhere. The benefits of carbon offsets are measured in metric tonnes of CO2. A carbon offset is usually implemented through an offset project that is part of an offset program, and the project follows the offset program's methodology. Converting carbon offsets into tonnes of CO2 generates carbon offset credits. A carbon offset credit is a tradable unit corresponding to 1 tonne of CO2 that an offset project removes from the atmosphere and stores for a sufficiently long period.

Carbon offset credits are commonly traded in markets similar to stocks. In many territories, there are two types of markets for credits: compliance and voluntary. The compliance credit market is usually organized directly by national governments under the Kyoto Protocol and is determined by the territory's legal system. It is mandatory for entities listed in the territory's legislation to purchase carbon offset credits. These include, for example, power producers, air carriers, or lime and cement producers. The proceeds from the sale of such offset credits are usually received by the state/government that organizes the compliance market and usually uses the proceeds for system changes leading to GHG emission reductions or other activities leading to climate change mitigation or adaptation. The voluntary market is then used by those entities that want to offset their carbon footprint for various reasons but do not need to participate in the compliance market. These include socially responsible companies in all sectors, individuals, or, for example, social event organizers.

On the voluntary market, carbon offset credits, which usually come from offset projects organized by, e.g., non-profit organizations or other entities, are traded.

We have analyzed various offset projects typical for trading on voluntary carbon offset markets, and we have listed their main disadvantages.

### Offset Programs (Consisting of Projects)

1. Nature Based Projects
   I. Projects to prevent the destruction of existing carbon stocks, i.e., projects to prevent deforestation and land degradation:
      Carbon sequestration occurs, or continues to occur, in large quantities immediately, but there is no component that supports further additional carbon sequestration beyond natural forest growth. Projects often take place in remote locations and monitoring is problematic. There is also often fraud, e.g. duplication of support for protected forests, which is unacceptable in terms of carbon offsets. Thus, a major scandal recently broke out in Australia. The government's offset program, the Emissions Reduction Fund, has 70-80 projects that were qualified completely wrong. For example, private forests that were already protected for biodiversity reasons with government financial support were put on the carbon credit market. The money collected was used to purchase neighborhood forests that had been completely cut down. If the neighborhood forests had not been purchased, it is highly likely that they would not have been clear cut. Putting such credits on the market was counterproductive, as there was no additional carbon sequestration and the CO2 emitters were not incentivized to reduce their emissions (4).
   II. Projects supporting carbon sequestration via afforestation and reforestation of previously forested areas:
      Planting trees generates a carbon footprint that must be offset by their growth. Trees sequester carbon very slowly at the beginning of their growth, so that carbon neutrality occurs after about 15-35 years. The output of newly planted trees relative to the area where they are planted is very low. In the urgent time when we need to sequester carbon the most, i.e. in the next 30 years, this method is ineffective. In urban areas, the carbon footprint offset of planting a new tree is calculated to be 26-33 years, often it might be longer.
      There are relatively high costs associated with planting new trees and tree mortality is high, averaging about 5% per year, but with large variations.
      In many areas, there is no more space for afforestation, and that doesn't just apply to cities. There is growing tension in Wales as much farmland has already been bought up and reforested and there is demand for more. Future agricultural production, on which the Territory's economy is based, is under threat.
      In cities in general, there is very little space for planting new trees anymore.
      Carbon offsets are sold for 50-80 years in advance (one-off) and it is not at all clear whether trees will exist in a given place after, say, 50 years. The measurability of the effect of these projects is very problematic.
   III. Projects promoting carbon storage through soil management techniques (e.g. no-till):
      These projects face resistance from farmers, reducing or completely stopping crop yields. They have a social impact on employment in the territories. Their measurability is based on a few soil samples taken from a large area. With massive deployment of these projects, food shortages are imminent.
2) Methane projects—These projects capture and use methane, for example in hot water or electricity generation:
   The projects are extremely expensive and slow to build. Although methane is captured, which is about 25 times more dangerous than CO2 in terms of the greenhouse effect, the methane is then burned in a heating plant or power station, and so another greenhouse gas (CO2) is released into the atmosphere anyway.
3) Energy efficiency projects—These projects often work on the basis of calculations that the higher purchase price of a product will be offset by the lower costs required for subsequent maintenance or use. These include, for example, the insulation of buildings:
   These projects require high acquisition costs and take period to implement. They aim at the right goal, i.e. reducing emissions by reducing energy consumption, but do not produce any additional benefits (as e.g., trees do). In addition, their implementation is linked to the production of other products that will be waste in the future (e.g. polystyrene for insulation).
4) Renewable energy projects—Projects working with hydro, wind, solar, biomass and other renewable energy sources. These projects facilitate the transition to widespread use of low-carbon technologies:
   Converting the energy sector to renewable sources is one of the few ways to reduce or stop the production of greenhouse gases, especially CO2.
   However, these projects are extremely expensive and take a long period to implement (e.g. building a wind farm). They are a source of waste in the future (wind turbine blades or solar panels are difficult to recycle) and also produce negative side effects. These include, for example, flooded areas at hydroelectric power stations, noise at wind farms (threatened biodiversity, social impacts) or the use of agricultural land primarily for the production of non-food commodities (biofuels).
5) Projects focusing on the technical capturing of CO2 from the atmosphere (CCS) and storage in depositories, mostly underground:
   Such projects may be one of the few paths to carbon negativity (i.e. reducing the total amount of CO2 in the atmosphere) in the future, which is desirable because today the atmosphere contains about twice as much CO2 as in the pre-industrial era. The projects are the most expensive of the projects listed here, and the future is technologically uncertain for now. Their massive efficiency is still a long way off, and building such facilities is time consuming. As an example, the announced construction of a facility in Colorado (a collaboration between YUMA ETHANOL LLC and Carbon Capture America, Inc.) is expected to take 2 years and cost $100 million. In doing so, it will sequester about 350,000 tons of CO2 per year, which is the amount we can sequester with trees in a large city in one year. Such facilities are likely to produce negative side effects (e.g. noise), consume energy, and their construction certainly leaves a huge carbon footprint. These projects do not produce no positive co-benefits, such as trees that produce ecosystem services.
6) Projects converting biomass (mainly wood mass) into charcoal, which is then stored underground or used as part of a fertilizer:
   In most scientific studies, charcoal production comes out as carbon negative. However, the costs of building facilities are high and the period to start production is also not negligible. Such plants are likely to produce negative side effects (e.g. noise), consume energy and their construction certainly leaves a huge carbon footprint. Apart from charcoal production, these projects do not produce any positive co-benefits, as do, for example, trees that produce ecosystem services. But it is certainly one way to use waste biomass and use it as fertilizer.
7) Projects aimed at burying woody mass underground so that the carbon stored in the biomass cannot be released back into the atmosphere:
   Newly on the market, offset projects fund projects to harvest organic biomass and bury it deep enough underground that the CO2 stored in the biomass cannot be released back into the atmosphere as it decomposes. This approach verges on a waste of resources that could be used elsewhere (wood mass for energy production, building material, or just keeping growing for carbon sequestration), and the carbon neutrality of the process must be influenced by the way the biomass is harvested and the geographical distance of the biomass source to the storage facility. For example, the overall carbon balance must be inherently problematic if biomass is to be transported 200 km to the project site. Some projects consider harvesting organic matter from the forest understory, which has a fatal impact on biodiversity.
8) Projects that reward companies that use materials that produce less CO2 emissions, such as slag panels:
   These projects contribute to reducing the carbon footprint, which is a good thing. But these “offsets” occur anyway, the buildings are built anyway and the client would have paid for the buildings anyway. In addition, the projects generate a profit for e.g. the construction company, which pays for the cost of the material, which can be even cheaper because it is waste treatment. So basically there is no reason why entities should be rewarded for using these materials.
9) Projects that reward companies that use wood for construction and store carbon for more than 50 years:
   The same applies as for point 8)

### Funding of Green Spaces in Settlements

We can divide green spaces in settlements into three subgroups:
Public green spaces (green spaces publicly accessible, parks and accompanying green spaces)
private green spaces together with institutional green spaces (gardens, orchards, usually fenced, serving private users or areas with limited access)
protective and insulating green spaces (barrier greenery, protection against negative effects of noise, dust, and visual pollution).

Each green space has its own owner, which is determined according to the legislation of the particular territory. The owner of the green space bears the risks associated with ownership of the green space, but the green space benefits everyone.

The creation and maintenance of the green space is most often financed from the owner's budget. This is, for example, the municipal budget or, in the case of private green space, the landowner—a private person.

In some cases, funds from other sources may be used for selected tasks related to creating and maintaining green spaces—for example, planting new trees. Again, in most cases, these are public budgets (subsidies). Only a fraction of such funding comes from private sources, where the provider is an entity other than the owner. Such entities are, for example, public charities or non-profit organizations. However, the usual practice is that these funds are usually for a limited operation, most often the planting of the tree itself, but do not cover the costs of the aftercare of the tree. This considerable cost is again financed by the owner (usually the municipality) from its budget and is, therefore, again expenditure.

An actual direct financial income derived from ownership of green spaces in a city is very limited. These are revenues from the sale of wood from fallen trees, wood chips from their branches, or fruit growing on fruit trees. It should be noted, however, that the sale of wood for the purpose of combustion, i.e., to produce heat, is very problematic in terms of combating climate change because the carbon accumulated in the biomass of the tree is released back into the atmosphere as CO2 when the biomass is burned, increasing its volume in the atmosphere and thus contributing to global warming. It can also be considered negative that if a tree is felled, the dead root system, which also stores carbon, is left behind (usually in the ground), and its decomposition releases CO2 back into the atmosphere. There are technical methods and solutions to prevent the release of CO2 from the wood mass into the atmosphere, such as converting the wood mass into furniture or charcoal, but this adds further complications and costs to the whole wood processing process. It is, therefore, the most logical and cheapest to let any growing tree grow, and it is best to encourage biomass growth to support the production of ecosystem services. This is also the objective of the present invention.

There is a significant disparity between the costs of establishing and maintaining green spaces and the direct revenues. Thus, from a purely financial point of view, green spaces are the budget expenditure. Therefore, there is always a shortage of funds for establishing and maintaining green spaces. No money is left to directly support existing green spaces to increase their benefits by promoting biomass growth, leading to increased carbon sequestration and higher production of other ecosystem services.

Indirect quantifiable benefits from the ownership of urban green spaces can be expressed in terms of ecosystem services. Ecosystem services are, e.g., stormwater management, capturing air pollutants, absorbing noise waves, regulating temperature, or, e.g., regulating climate by sequestering carbon dioxide or increasing the value of properties in the vicinity. These benefits of green space are quantifiable in monetary terms but are not financial revenue for the owner of the green space.

In recent years, offset projects for planting new trees have started to appear. The developers of these projects offer carbon offsets that will be generated in the future by the growth of their newly planted trees. The funds for the planting are raised by selling carbon offset credits for the project. As part of the planting project, based on the number of trees and their species, a projected amount of carbon is calculated, which, in the long term, usually in 50-80 years, the trees store in their biomass. It should be noted, however, that planting trees in urban landscapes is carbon positive (i.e., it does not contribute to combating climate change but causes it) for some time, averaging about 10-30 years from the time of planting to the final habitat. The carbon footprint created by the whole process of growing the seedlings in nurseries, planting them in their final habitat, and subsequent care, e.g., watering, is usually not included in the overall balance of offset projects. Moreover, many of these trees will not even live to the planned age of 50-80 due to lack of care, disease, or felling because of development.

### THE ESSENCE OF THE INVENTION

The invention relates to a method of reducing the CO2 levels in the atmosphere by additional carbon sequestration in existing trees, which consists of preserving the trees, performing and utilizing tree inventory, selecting the trees appropriately, and implementing and optimizing supporting measures, after which the tree can maximize its carbon sequestration, i.e., carbon removal from the atmosphere, and these measures relate in particular to improving the tree's vitality and habitat. In order to select suitable candidates, it is advantageous to use the output data from the tree inventory and tree habitat alternation methods to combat climate change by intentionally reducing atmospheric CO2, which is bound and stored in tree biomass.

According to the present invention, the method substantially eliminates the shortcomings of the prior art methods described in the preceding section. The technical effect of the method according to the present invention is, in addition to the effective additional reduction of the CO2 content in the atmosphere by means of its binding in tree biomass, i.e. carbon sequestration, that the benefit of additional ecosystem services production is also achieved, which are advantageously supported by the incentive element of the definition of a carbon credit, which creates a systemic incentive to conserve the tree individuals preferred for CO2 sequestration and providing ecosystem services, while minimizing or eliminating inefficient and/or counterproductive steps and methods aimed at reducing the CO2 content of the atmosphere, which may include, for example, the unsystemic planting of new trees, which in turn create the conditions for additional CO2 production, whereby the benefits of their planting cannot be expected in terms of achieving carbon neutrality in the timeframe of the next thirty years, thus for the purpose of reducing CO2 in the atmosphere, it is preferable to wait or limit the planting of new trees and engage now in a method according to the present invention that supports tree individuals through which significantly more carbon can be sequestered from the atmosphere while at the same period the carbon footprint to support them is minimal. These selected specimens also provide a significant volume of other ecosystem services.

The invention newly integrates two basic strategies that have been used separately to combat climate change through nature based solutions: conservation, i.e. letting trees grow, and sequestration, i.e. stimulating additional carbon sequestration. Conservation strategies are now being applied, for example, to forests by preventing them from being cut down using various tools. At the same time, however, the additional sequestration of the trees thus protected is not stimulated, i.e. the maximum growth of the trees, which is determined by the genetic make-up of the individual tree species, is not encouraged. Sequestration strategies, in the case of trees, are implemented by planting new trees. However, a newly planted tree in a city is carbon negative only after about 30 years (Aaron C. Petri, Andrew K. Koeser, Sarah T. Lovell, DewayneIngram; How Green Are Trees?—Using Life Cycle Assessment Methods to Assess Net Environmental Benefits. Journal of Environmental Horticulture 1 Dec. 2016; 34 (4): 101-110. doi: https://doi.org/10.24266/0738-2898-34.4.101), making plantings rather counterproductive from a carbon balance perspective.

The application of the invention in this combination will prevent the felling of trees, will bring about a natural and additional growth of their biomass that would not have occurred without the application of the invention, and since carbon sequestration is directly dependent on the increase in biomass, this additional growth will lead to an additional increase in the amount of CO2 sequestered in the tree biomass. At the same time, through habitat alternation measures and other actions described in the present invention, further additional carbon binding into tree tissues will occur based on the targeted maximization of their ecosystem services.

The application of this invention also creates financial instruments to finance measures for the protection and support of trees in urbanized landscapes, for which owners and managers of green spaces would otherwise not have the money. During the application of the present invention, among other things, the localized carbon credits of individual trees are quantified and sold on carbon credit markets. The revenues go to the tree owner or manager. This tree owner or manager is advantageously contractually obliged to use these funds to protect and support the tree specimens for which the credits were issued and, in particular, to use them to pay for the measures described in this document to ensure that the ecosystem services of these trees are maximized. Such operations are subject to a contractual commitment by the owner or manager of the trees, which includes, inter alia:
Declaration of ownership: the legal relationship of the owner or manager of the trees to all trees to which the invention will be applied must confer the right to receive and dispose of the financial funds generated from the sale of credits, i.e. the trees must either be owned or the owner must be responsible for the care of the trees.
Commitment to sustainability: the owner or manager of the trees commits to preserve, not cut down, or threaten the existence of the trees in the future for the duration of the application of the present invention, denoted herein as period t.
Commitment to skilled care: the tree owner or manager commits to care for the trees with competence, advantageously according to the applicable tree care certification scheme in the region, and to seek to maximize ecosystem services through the measures described in this invention.
A commitment to back-offset reversals of carbon sequestration from the atmosphere, i.e. a commitment that if the owner or manager can prevent the removal of the tree (e.g. cutting it down for new construction) by his or her own power, called avoidable reversals, and fails to do so, the money paid for the carbon credits will be returned to the person who bought them or other compensation will be provided. Conversely, for losses of trees that are beyond the control of the owner or manager, e.g. accidental explosion, windstorm, disease for which there is no countermeasure, etc., the losses will be compensated from the carbon credit reversal funds that are created under this invention.

It must be stressed that we are currently in a time of climate emergency. The objective is to keep the global temperature rise below 1.5° C. at all costs (COP26). Meeting this objective is conditional on a reduction in the intensity of the greenhouse effect, i.e., in particular, a reduction in the volume of greenhouse gases in the atmosphere. This can happen either by reducing greenhouse gas emissions or by increasing the removal of greenhouse gases from the atmosphere, or a combination of both. COP26 aims to achieve net greenhouse gas neutrality in 2050, which would lead to meeting the target of a maximum increase of 1.5° C. Net neutrality occurs when the amount of greenhouse gases produced from human activities is equal to the amount that is removed from the atmosphere. That is why we must make every effort now and in the next 15 years to provide tree-based solutions. We must not lose a single more tree in cities, especially individuals of the species growing to a large size.

Planting trees now that will only have an effect in the future will not solve anything. By then they will have been replaced by CCS technology (which does not diminish the value of the trees themselves). Therefore there is an urgent need to address the situation now, and it is convenient to do just that through large trees, which is the subject of the present invention.

The invention, in a basic embodiment, comprises implementing the following steps to achieve the technical effect of maximizing carbon sequestration into the biomass of existing trees and minimizing the cost of these measures, the method comprising the following three basic steps as illustrated in FIG. 1:
A. Definition of the territory where the measures under this method are to be implemented;
B. Selection of the group of trees named Set S, where this group represents trees that are significant for carbon sequestration into biomass and are suitable candidates for implementing supporting measures and should be included in the conservation system;
C. Implementing supporting measures for Set S trees that ensure maximum carbon sequestration over the longest possible period and minimize the costs of managing and implementing these support measures. The supporting measures schematically illustrated in FIG. 4 include, in particular, all the acts described in the present invention as the state of the art, preferably in a suitable combination. The flow of the steps is then illustrated in FIG. 5.

The above basic three steps are further advantageously supplemented by the following intermediate steps, which are illustrated in FIG. 2, as follows:
A. Definition of the territory where the measures under this method are to be implemented, this step includes:
   Determine the period t for which the support measures are to be implemented according to step C; and
   Determining the moment TO at which the implementation of the support measures according to step C starts, which is usually at the time of the tree biomass calculation, but can also be, for example, at the time of the inventory of a specific tree;
B. Selection of Set S trees that are significant for carbon sequestration into biomass and are suitable candidates for implementing supporting measures and should be included in the conservation system, with the following intermediate steps:
   conducting tree inventory, advantageously with a definition of technical measures for implementation at period t;
   calculation of tree biomass, advantageously all trees, less advantageously only on Set S trees, down to the single tree level;
   determination of C0(T0) for each tree for which a biomass calculation has been performed, where C0(T0) is the total mass of carbon, typically given in metric tonnes, contained in the above-ground portion of the biomass of the tree, advantageously in the above-ground and below-ground portion of the biomass of the Set S tree at moment T0.
   C0 is associated with the ecosystem service of carbon storage and is a static quantity, i.e., it is a value given at one point in time. C0, carbon stored, conservation corresponds to the conservation strategy of the present invention. Alternatively, C0 can be expressed in CO2 equivalent, preferably in metric tonnes.
   Determining C1(T0) for each tree for which a biomass calculation has been performed, where C1(T0) is the total mass of carbon, typically given in metric tons, that is predicted, at moment T0, based on current scientific knowledge, to be sequestered naturally by the Set S tree over period t if it is allowed to grow, is not cut down, and no other technical measures described in the present invention are performed on the tree that cause additional growth of the tree.
   C1 is associated with the ecosystem service of carbon sequestration, is a dynamic quantity, and is related to the results of natural tree growth over period t or over another unit of time, e.g., 1 year. It is the future potential that will be fulfilled if the tree is maintained alive. This potential is a transition between the conservation and sequestration strategies of the present invention, where it is closer to the conservation strategy. This future carbon sequestration potential cannot be fulfilled if the tree is cut down. The value of C1 is given by calculating the result of the allometric equation (modeling the growth of the tree over time) that corresponds to the tree species. Allometric equations appropriate for most tree species are already described in the scientific literature. Alternatively, C1 may be expressed in equivalent, preferably metric tons.
   The grouping of measures proposed during the inventory process and the ranking of these groups of measures according to priority, with speed and lowest cost being the main decision-making factors, or the most favorable ratio between resource requirement and achieved output, where CO2 emissions are also a resource, and where the measures work synergistically together;
C. Implementing of supporting measures on the Set S trees ensuring maximum carbon sequestration rate for the longest possible period and minimizing the cost of managing and implementing these supporting measures, as shown in FIG. 4, where the supporting measures are implemented over period t and optimization is ongoing over period t, whereby:
   at the end of period t, at moment T1, a tree inventory of the set S trees, advantageously of all the trees in the territory, is made, advantageously with recommendations for supporting measures for the next round at period t2, where period t2 represents the next time period chosen for repeating the implementation of the steps according to the above procedure, and advantageously immediately following moment T1;
   followed by the determination of C0(T1) and advantageously also C1(T1), for Set S trees, preferably for all trees in the territory, as preparation for the next round at period t2, wherein C0(T1) is the total mass of carbon, typically given in metric tons, contained in the above-ground, advantageously in the above-ground and below-ground part of the biomass of the tree at moment T1, wherein C1(T1) is the total mass of carbon, typically given in metric tonnes, which is assumed, at moment T1, based on current scientific knowledge, to be sequestered naturally by the Set S tree throughout period t2 if it is allowed to grow, is not cut down and no other technical measures described in the present invention are carried out on the tree to cause additional growth of the tree;
   and a calculation of C2(T1), is made where C2(T1) is the total mass of carbon, usually given in metric tonnes, that has been additionally sequestered by the Set S tree only due to the adoption and implementation of the supporting measures in the period t, where the additional sequestered carbon of mass C2 is the most valuable contribution of the invention and its value C2 is calculated according to the following formula:

$$C {2}_{( T 1 ) =} C {0}_{( T 1 ) -} C {0}_{( T 0 ) -} C {1}_{( T 0 )}$$

alternatively, C2 is expressed in CO2 equivalent, advantageously in metric tonnes.

The method, according to the present invention, further advantageously comprises the further step or steps of promoting the implementation of the support measures, in that after the calculation of C0, C1, and C2, the conversion of the mass of carbon represented by these quantities to the equivalent mass of CO2, as described in the preceding paragraphs, and this mass is converted into so-called K0, K1, and K2 carbon credits, which represent an expression of the value of the stored or sequestered CO2 in the Set S tree, whereby one carbon credit corresponds to a predetermined mass of CO2, e.g., according to market practice or the offset program methodology, advantageously one credit corresponds to one metric tonne of a given category C0, C1 and C2 converted to CO2 equivalent, whereby the carbon credits are further expressed as:
K0 represent the conservation strategy of the invention according to the previous paragraph and their total number corresponds to the mass of CO2 stored in the tree at moment T0;
K1 represents a transition between the conservation and sequestration strategies of the present invention according to the previous paragraph, and their total number is equal to the mass of CO2 that will most likely be stored in the tree in a future period t naturally, without any additional intervention;
Credit K2 represents the sequestration strategy, the additional carbon sequestered by the supporting measures according to the preceding paragraph, along with the production of many of the cobenefits so crucial for adaptation of settlements to climate change, and in the context of the method according to the present invention, serves as a representation of the volume of the commodity, i.e., the carbon stored or sequestered, for sale in the carbon offset market.
   Examples include:
The ratio between 1 metric tonne of stored or sequestered CO2 and one credit is set at 1:1, i.e. 1 credit equals 1 metric tonne of CO2.
Then K0 corresponds to 1 metric tonne of CO2 stored in a Set S tree.
Then K1 and K2 correspond to 1 metric ton of CO2 sequestered.
If one metric tonne of CO2 is sold on the market for 100 Euros, then the price of 1 credit is 100 Euros.
The method of calculating K0 and K1 credits is shown in FIG. 3, the calculation of K2 credits and the reckoning of K0 and K1 credits is shown in FIG. 5.

The invention can also be simplified in other words by implementing the following steps:
1. On the Set S trees, in the predefined territory, the carbon stored at moment (T0) is measured and the result, C0(T0), is found (by a new tree inventory process or the data from an existing tree inventory can be used if it was carried out on the trees we selected);
2. The period t is chosen to be one year;
3. The data are entered in a database, advantageously in a GIS, to complete the tree inventory;
4. Each tree, according to its size, and age, and species, will be entered into the so-called ecosystem services calculator, which is freely available, for example, at https://www.itreetools.org/or www.ekobenefity.cz or similar, where the system will calculate how much carbon the tree is expected to store the following year. This number will also be entered into a database, advantageously a GIS, and this will produce a prediction of the carbon sequestered by the tree during the following year, C1(T0);
5. Advantageously, supporting measures will then be implemented to ensure that Set S trees will sequester as much carbon as possible that would not otherwise be sequestered without these supporting measures. In the less advantageous option, no supporting measures will be implemented and the trees will therefore only act as carbon storage (C0);
6. After one year, a new measurement is taken-manually, by LIDAR scanning, including the use of LIDAR on a mobile phone, by dendrometer or by other technology—to determine how much carbon the trees have sequestered over the period t and to calculate the difference between the expected mass of carbon stored without support and the actual carbon stored. This difference will define how much extra carbon has been sequestered due to the application of the present invention (C2). This carbon would otherwise never have been sequestered by the trees. By this step, the owner of the Set S trees has contributed to the additional carbon stored in the atmosphere;
7. If no measures are taken to maximize tree growth, it is very likely that the value C2 will be close to zero;
8. After this calculation, we can resume the application of the invention again for another period to again promote additional carbon sequestration. It will also be possible to add new trees that have already grown to a bigger size, etc., and thus meet the conditions for inclusion in Set S;
9. Periods tx can be repeated continuously until the end of the tree's life.

Further variant embodiments and in particular the details of the individual steps are given later in this section, whereby the above-mentioned method does not exclude the use of additional accompanying steps.

FIG. 6 shows the procedure, which consists of three basic steps at period t.

Selection and quantification-takes place at moment T0 and selects, from the tree inventory, the most efficient specimens of trees, called Set S, for the application of this invention, using volumetric analysis of the trees to determine the mass of stored carbon C0(T0) (in metric tons, given converted in metric tonnes of CO2) in the tree or trees and C1(T0)—the mass of carbon naturally sequestered at period t (in metric tonnes, given converted in metric tonnes of CO2) in the tree or trees, according to allometric equations appropriate to the tree species.

Part of the variables C0 and C1, is moved to a reversal pool (reserve fund), in the volume of 10-30%, advantageously 20%. At this stage, the supporting measures to be implemented in the next step are also defined, if not already defined in the past, whose adoption will lead to maximizing the growth of each individual tree while maintaining its safety (stability) and long-term perspective. The C0 and C1 masses are transformed into carbon credits, offered for sale on the carbon credit market, and the funds from their sale are used to execute the supporting measures in the next step.

Implementation—trees are protected against felling, support measures are being implemented to bring additional tree growth, and reference checks are carried out to monitor whether and how the measures are being carried out and whether the trees are still in the declared spot (fraud prevention). A portion of the revenue from the sale of carbon credits is allocated for control activities.

Validation and Reckoning—takes place at moment T1, i.e. after period t has elapsed, and a new tree inventory is executed. This creates the basis for a new volumetric analysis. The calculation of dendromass and stored carbon is performed, advantageously with the same method as in the first step at moment T0, but since period t has already elapsed, during which the trees have grown, the balance can be evaluated. Thus, the volumetric analysis gives the value C0(T1). The balance of C0 and C1 is evaluated. The quantity C2 is determined, which represents the most accurate possible mass of carbon that has been additionally sequestered by contribution of the supporting measures, can be expressed in CO2 equivalent and is defined as:

$${C}_{2 ( T 1 ) =} {C}_{0 ( T 1 ) -} {C}_{0 ( T 0 ) -} {C}_{1 ( T 0 )}$$

C2 represents the most valuable carbon credit of the whole cycle because its main characteristic is additionality, i.e. it would not have been generated if the invention had not been applied. As long as there is no negative balance, the rest of the carbon credits from the reversal pools can be released into circulation. If there is a negative balance, e.g. due to a natural disaster, the reversal pool will be used to cover these losses.

These 3 steps may or may not be repeated. However, by repeating them, the effect of the invention is amplified because the maximum growth of the tree occurs continuously. If the tree grows more leaves than usual in spring, it produces more nutrients (assimilates) which are stored in the root ball of the tree in summer and autumn. If the tree has optimum overwintering conditions (especially sufficient water soil content in the autumn), almost all of the fine roots will survive the winter, and is a source of growth in the spring. If it is dry in autumn, the fine root die, nutrients are not available in spring and the tree grows less.

The period t of the implementation part is set in years, ranging from 1 to 100 years, is adjustable, and its chosen length takes into account two factors:
It must be long enough that we are able to evaluate the tree biomass growth between two measurements, i.e. at least one year.
It must to be reasonably short in order to capture any significant changes in a dynamic environment such as an urbanized landscape, e.g. new construction etc., and thus limit the risks associated with the potential loss of trees in the defined Set S. As the tree owner commits to not felling the trees for a period of t and to give them extra care, it is advantageous to set the length of period t so that it can be considered as commonly acceptable.

The period t takes values of 1-100 years, more advantageously 2-50 years, even more advantageously 3-20 years and most advantageously 4-10 years.

### Selection and Quantification:

FIG. 7 describes the first step of the invention. The selection and quantification takes place at moment T0 and is based on the outputs of a green space inventory, more specifically a tree inventory, advantageously in the form of a GIS, most advantageously in combination with defining of supporting measures down to the level of a single tree. It is possible to use records/data that already exist if they are of sufficient quality and up-to-date, or a new tree inventory can be made. In this basic scenario, it is assumed that the acquisition of data for the tree inventory is executed manually, by measurement and assessment on-site, at the tree, by a human, which is still the most common method of acquiring data for a tree inventory today.

To proceed further in accordance with the present invention, we need at least the following data for each tree in the inventory:
Taxon (species) of the tree.
Location of the tree, ideally in geographical coordinates
The height of the tree, ideally in accuracy to millimeters or similar length equivalent in local units
Tree diameter at breast height (DBH), ideally in accuracy to millimeters or similar length equivalent in local units
Advantageously tree health assessment
Advantageously tree stability assessment
Advantageously tree vitality assessment

When using inventory records/data that already exist and that were not acquired for the purpose of the invention, it is necessary to exclude data that may be outdated and/or do not provide sufficiently accurate or all of the required data. The timeliness of the records must be set so that any errors in the records do not cause the reversal pools to be overdrawn at the time of reckoning at time T1. Setting a usability expiration period of less than 1-3 years, the most advantageously 2 years, seems sufficient.

If definitions of supporting measures are not part of the data from past records, it is preferable to do definitions in this step.

Mapping using 3D scanning with LIDAR or similar remote sensing or precision forestry technologies as described in the state of the art can be used as an advantageous alternative to obtaining tree inventory data.

### Definition of Set S

The selection of trees to be further worked with in the invention is essential. The Set S is a subset of the set of all trees in a given territory, or inventory, and defines which trees will be supported in the second phase. The definition of the selection criteria may be modified, e.g. in the context of legislative changes or new scientific findings. Today, the selection of Set S is determined by three factors: the expected level of effectiveness of the supporting measures, the legal framework and the level of risk that the tree will be lost during period t. The very basic principle is that the larger the tree and the better its condition, the greater the volume of ecosystem services it provides.

The definition of Set S advantageously contains the following criteria, which should all be met at the same time for a given individual tree. The definition of the criteria may be based on the practices in the territory or the strategy chosen by the person who will apply the invention, advantageously using the example of the criteria below, which was compiled according to the Czech Arboriculture Standard SPPK A01 001:2018: [symbol] et al. [symbol] í [symbol] [symbol] . AOPK ČR and Mendel University Brno.
Trunk diameter (DBH) ≥15 cm, advantageously ≥20 cm, most advantageously ≥25 cm.
Health status less than or equal to 3 when assessed according to the following categorization:
   A summary characteristic defining the state of mechanical damage of an individual. The main meaning is to express the operational safety of the tree.
   health condition excellent to good
   health condition impaired
   health condition significantly impaired
   severely disrupted
   critical/disintegrated tree
Vitality less than or equal to 3 when evaluated according to the following categorization:
   A summary characteristic describing the viability (dynamics of the course of physiological functions) of a tree as a living organism. Decline in vitality may be caused by unsuitable habitat conditions, pest infestation, or the influence of the surrounding vegetation.
   vitality excellent to slightly reduced
   vitality visibly reduced, crown beginning to dry out
   vitality significantly reduced, drying out continues dynamically
   residual vitality
   dry (death) tree
Stability when evaluated according to the following categorization less than or equal to 3:
   Estimation of the potential threat to operational safety by an individual based on observable defects of branches, trunk infection, presence of cavities or cracks in the trunk and crown, or visible root system damage. The assessment is primarily of resistance to breakage, with only visually visible symptoms in the area of resistance to uprooting.
   no symptoms of static disturbance detected
   slight disturbance of static conditions (further monitoring required)
   significant disturbance of the tree stability (frequent inspection is necessary-1-2 times a year, possibly rehabilitation) risk of falling big branches, large defect (if no remediation of the defect is possible, removal of the tree is necessary)
   5. Critical status, disintegrating crown or trunk

Where other scales or assessment categories are present in the existing tree inventory, or according to local practice in a given territory, it is always necessary to first establish the appropriate criteria to the criteria listed above, against which Set S will be defined.

### Machine Exclusion of Risk Trees

If available, it is advantageous to use biomechanical tree analysis to refine the definition of the S group, which determines the so-called tree safety coefficient using a LIDAR scan or calibrated photography. The coefficient takes values of 0-100%. The higher the coefficient, the higher the stability of the tree and the lower the risk of falling. It is therefore advantageous to exclude from Set S in the first stage all trees that do not achieve a safety coefficient greater than 80%, advantageously 90%, and most advantageously 100% in the biomechanical analysis.

### Exclusion of Invasive Trees

Set S shall not contain woody plants that are classified as invasive species by legislation or practice in the territory.

### Ownership

For all trees in Set S, the owner must be known, as only the owner or his/her/its authorized manager is entitled to decide on the measures to be taken. The owner or his/her/its authorized manager is also the beneficiary of the funds from the sale of carbon credits.

This concludes the selection of Set S.

### Design of Supporting Measures

In the current urban forestry praxis, the design of supporting measures is a list of activities and interventions that only lead to increased safety, improved tree vitality, or prolonged life of the tree on the site. Examples of such measures include pruning with the objective of bio-mechanical stabilization, installing a cabling system or felling, and less commonly, for example, applying fertilizers and soil amendments or tree watering. These recommendations usually define a professional qualified in arboriculture or related fields.

For the purpose of the present invention, supporting measures are given a new purpose, namely, maximizing growth while maintaining the safety of the tree and its long-term perspective. Since CO2 sequestration directly depends on tree growth, we will use these measures to maximize CO2 sequestration from the atmosphere. Advantageously, these measures are applied systematically and on a large scale so that each tree in Set S has conditions that are limitingly close to the optimum in a given territory.

It is advantageous if these measures are defined for each tree when the tree inventory is being acquired. If this is not the case, such a design must be made additionally.

### Volumetric Analysis

We perform a volumetric analysis of above- and below-ground tree biomass on the qualified Set S to determine the mass of carbon stored in the Set S trees and also the mass of carbon that will be sequestered in the future, at period t. For this, it is advantageous to use the state of the art, e.g. the certified methodology Zemek et al. (2021): [symbol] [symbol] [symbol] [symbol] [symbol] [symbol] . [symbol] [symbol] [symbol] [symbol] AV ČR, v. v. i. ISBN 978-80-87902-31-8. Alternatively, from abroad, e.g., a tool i-Tree, at www.itreetools.org, which gets an entirely new dimension when used for this purpose. Information that is merely interesting and merely states a state of affairs becomes information that serves directly as a tool for combating climate change.

A volume analysis of the trees at moment T0 will result in the following values:
The mass of carbon stored in the underground and aboveground biomass of the tree (C0T0) in metric tons, then converted to CO2 equivalent by multiplying by 3.664.
The mass of carbon that we expect to be stored in the underground and aboveground biomass of the tree in period t (C1T0) in metric tons, then converted to CO2 equivalent by multiplying by 3.664.

As an alternative to determinate C0 and C1, it is possible to use the determination of biomass by 3D scanning with LIDAR or similar remote sensing or precision forestry technologies, preferably at the individual and taxon (tree species) level, because each taxon has a specific wood density and ratio of carbon and other substances in the tree biomass. The aim is to determine the mass of carbon, i.e., stored and future sequestered CO2, as accurately as possible.

Combining these two methods of determining the values of C0 and C1 at different times is possible, when replacing the manual procedure with 3D scanning is more advantageous than vice versa.

It is advantageous to store the values of C0 and C1 in a database for further use, advantageously entered into a green space inventory system, preferably maintained in GIS, for each individual tree to which it belongs. It is essential to keep the values so that further calculations can be made with them and also to add up the totals for groups of trees. It is then possible to get the sum of values for trees, e.g., in one particular street, in a whole city, or to look up the figure for one particular tree. It is also necessary to record the moment (date) of measurement (T0) because period t starts from this moment.

The conversion of the mass of carbon contained in the tree biomass to the mass of stored CO2 is based on the atomic masses of carbon, oxygen and CO2. The following equation shows the calculation of the coefficient k, which is used to multiply the mass of carbon resulting from the measurements to get the mass of CO2:

$$k = \frac{Ar ( C ) + 2 \times Ar ( O )}{Ar ( C )}$$

The coefficient k may vary depending on what source of information about the atomic masses of the elements is used for the calculation, and it may also depend on the level of human knowledge. The atomic mass data are still subject to refinement. For the purpose of describing the present invention, we have chosen data based on standard atomic weights according to the CIAAW convention:
Aᵣ, standard (O): 15.999, by convention
Aᵣ, standard (C): 12.011, by convention

$$k = \frac{44.009}{12.011}$$

The coefficient is then conveniently rounded to 3.664.

Often a 44/12 ratio is used for the purpose of conversion, but the subsequent result is not as accurate. In general, the conversion should be made according to the ratio that most closely approximates reality based on current human knowledge.

### Quantification of Carbon Credits

The underfunding of urban green spaces around the world means that, among other things, the potential of greenery, especially mature trees, to sequester CO2 from the atmosphere is not being fully exploited because they simply do not grow as much as they could, but tend to grow less, more slowly. The sequestration of CO2 is directly proportional to the rate of growth of the tree's biomass. The more a tree grows, the more it sequesters CO2.

Trees are also not an income-producing asset for owners, so it is relatively easy to cut them down, for a variety of reasons, most often for new construction. Thus, the potential for further CO2 sequestration in future is lost, and it is also very likely that some or all of the carbon that has already been sequestered and stored in the tree biomass will be released back into the atmosphere, e.g. by burning or decomposition of the wood and root system.

Therefore, the carbon credit sales scheme (carbon offset program), which is already a standard mechanism for financing various climate actions, is the ideal instrument to finance the second phase of this invention.

From the C0 and C1 values, which are converted to CO2 equivalent in metric tonnes, we get values that quantify the carbon credits K0 and K1. One tonne of stored or sequestered carbon corresponds to one credit of that category.

K0 represents the conservation strategy of the invention and is equal to the mass of CO2 stored in moment T0 in the tree. K1 represents the transition between the conservation and sequestration strategies of the present invention and is equal to the mass of CO2 most likely to be sequestered by the tree in future period t naturally, without any additional intervention. The K2 credit, which represents the additional carbon sequestered by the supporting measures along with production of many cobenefits, so important for the adaptation of settlements to climate change, will be quantified in the Validation and Reckoning step. By cobenefits, we mean increases in the production of almost all ecosystem services of a tree, i.e., e.g., increases in noise reduction, increases in oxygen production, increases in microclimate cooling, etc.

### Implementation:

FIG. 8 describes the execution of Implementation phase that runs during period t. It consists of three parts that run simultaneously.

### Publication

It is advantageous if the results of the quantification phase, particularly the results of the volumetric analysis, the C0 and C1 values, and the numbers of credits issued and sold, are made available, in full or on a limited basis, to the public. It is also advantageous that information on who bought the credits is made public if the buyer is interested. It is also advantageous to disclose whether, for a given tree in a given period, a K0, K1, and/or K2 credit has already been sold or is available for purchase by interested parties.

This publication can take place in any way, advantageously also in the form of making it available on the Internet, more advantageously in the form of a GIS system, most advantageously in the form of a GIS system with the possibility of displaying information down to the level of an individual tree and with the possibility of grouping and filtering information, e.g., displaying data for the entire street, and similar.

### Periodic Monitoring

Periodic monitoring is carried out during period t. Its main objective is to verify that the Set S trees are still in place and that the supporting measures are being implemented in the way recommended.

### Implementation of Supporting Measures

Implementations of supporting measures known as state of the art, used for a different and new purpose, are the main contribution of the invention. So far, the measures have only been used to improve the vitality and operational safety of the tree. However, in today's era of climate change, these objectives are wholly inadequate.

Moreover, many of the supporting measures are not used or are used only to a very limited extent for two reasons:

There is no awareness of the direct dependence between tree biomass growth rate and production of ecosystem services volume, especially among those who own and/or manage green spaces, and there is no mechanism to teach or somehow motivate them to use these measures in the short time we have to mitigate climate change.

Even if we could convince all owners and/or managers of green spaces that using these methods is the right thing to do and beneficial for combating climate change, there is no funding for widespread use.

FIG. 8 shows the measures that can be taken to conserve a tree and increase its biomass production and thus increase its carbon sequestration. The objective of conserving a tree specimen corresponds to the conservation part of the offset credit program, and the measures to increase the biomass production of the tree correspond to the sequestration part of the offset credit program. However, sequestration measures can contribute to the simple conservation of a tree under stress; watering the tree can be named as an example.

### Watering and Alternation of Tree Habitat

If the tree has optimal conditions for growth, its growth is maximized at each age stage. The following measures serve to optimize growth conditions and, therefore, maximize carbon sequestration, in particular by encouraging additional carbon sequestration from the atmosphere by Set S trees. If not implemented, it is very likely that the standard predicted carbon sequestration, i.e., C1, will be minimal and no C2 will be measured at final validation and reckoning. These measures mainly lead to maximizing carbon sequestration from the atmosphere and, to a minor extent, can support the conservation of a tree.

### Watering

Tree growth, and thus the amount of carbon sequestered over period t, directly depends on the availability of an optimal amount of water in the soil throughout the season. Other growth factors by the already existing tree cannot be influenced, such as the tree species, its exposure to light, and the temperature pattern at period t. Then, there are growth factors that can be influenced but are less appropriate, difficult, or expensive to use. These include, for example, fertilization or expansion of the rootable space. Therefore, we may consider watering the most advantageous embodiment of the present invention at this stage. In addition, watering protects against the destructive effects of high temperatures during periods of extreme heat. It is generally considered that trees with sufficient water supply are well adapted to survive transient extreme heat: Marchin, R. M., Backes, D., Ossola, A., Leishman, M. R., Tjoelker, M. G., & Ellsworth, D. S. (2022). Extreme heat increases stomatal conductance and drought-induced mortality risk in vulnerable plant species. Global Change Biology, 28, 1133-1146. https://doi.org/10.1111/gcb.15976

### The Process of Watering a Mature Tree

Watering should be carried out at least whenever there is a 10% drop in rainfall compared to normal in a given month, and this should be done when the substrate temperature is above 6° C. This means that it is advantageous to run it also very early in spring and late in autumn. Watering should be appropriate to the biology of the tree (FIG. 8a), the most advantageously at the presumed outer edge of the tree root system, advantageously at or beyond the canopy dripline of the tree to a distance equivalent to 2 to 3 times the distance of the canopy dripline from the trunk (FIG. 8b), least advantageously below the crown of the tree and never to the trunk of the tree, as is still often incorrectly applied. Watering of the tree towards the trunk is of little use, as there are only a minimum of fine water-absorbing roots at the trunk, and fungal diseases and other pest infestations may increase due to the higher moisture. Under-canopy watering can adversely affect the size of the tree's root system, reducing drought resistance and adversely affecting the tree's stability and resistance to uprooting.

The frequency of watering should ensure sufficient water volume for the tree, but also the occasional drying of the substrate in the root system so that soil gases are exchanged. In any case, watering should not take place once a week or more often, advantageously once a month, more advantageously once every two months, most advantageously 4 to 5 times a season, taking care to ensure sufficient moisture in the marginal periods of spring and autumn. This will ensure maximum growth of the tree and maximum sequestration of carbon in the biomass without the root system being reduced or deformed by irrigation, making the tree less resilient if watering ceases. Watering with a frequency of more than once a month leads to shallow rooting and loss of tree stability after only one year of watering (FIG. 8c). This is because the life span of about 80% of fine tree roots is less than 1 year, and these roots grow where water and nutrients are most readily available (FIG. 8d).

The timing of watering doses must be based on the biology of the trees in a given climate zone. The aim of watering is to maximize root and aboveground biomass growth and maintain maximum root system volume through the dormant season. The following terms are defined for humid continental climate zones according to the Köppen climate classification, i.e., zones Dfa, Dsa, Dwa, Dsb, Dwb, Dfb, or oceanic climate zones according to the Köppen climate classification CfB, Cwb, Cfc.

Watering should be carried out in the following periods if rainfall falls 10% below average for the period:
When the substrate temperature first exceeds 6° C.
During the growth spurt to ensure that new biomass growth, especially leaves, is maximized. In temperate climates, this corresponds roughly to the month of May.
Watering once or twice during the summer, when watering in August should not be neglected, as the nutrients start to be stored in the root system for the next season.
Once before the substrate temperature drops below 6° C., i.e. around September/October, sometimes in November, so that the fine roots do not dry out during the winter. No scientific reasons have been found for watering during the dormant season, when the substrate temperature drops below 6° C.

An exception may be made for these above-specified periods if the purpose of the watering is to immediately cool the microclimate around the tree which is watered. In this case, it is possible to water the tree more frequently during heat waves when the tree is supplied with water that is released into the surroundings through evapotranspiration and the space is cooled more efficiently than with street sprinkling.

The amount of irrigation solution delivered per watering is given by at least 5 times, advantageously at least 10 times, the estimated daily volume of water evapotranspirated by the tree. As a rough guide, the following volumes can be given by crown volume:
10 m³: 150-400 l
150 m³: 1,000-2,000 l
500 m³: 2,000-4,000 l
1000 m³: 3,000-8,000 l
5000 m³: 6,000-9,000 l

The desired amount of irrigation solution can also be advantageously determined by precise methods such as porometry, sap flow or Bowen ratio.

### Watering Procedure:

The watering dose must be delivered slowly so that water does not run over the surface or penetrate to a depth where it is no longer accessible to the tree. The watering dose should be applied for 5-48 hours, advantageously 8-24 hours. Water should penetrate at least 30 cm, more advantageously 40 cm of the substrate (FIG. 8e). The application of the watering dose must not damage the root system of the tree.

For the purpose of application, any method of irrigation solution application that meets the above conditions, can be used, it is advantageous to use the principle of drip irrigation. Less advantageous is the use of a drip hose, which will be positioned preferably in the desired area of the canopy drip line and beyond. Barrels or cisterns of water can also be used, which will deliver a given amount of water at the desired location and for the desired time using a drip hose. Similarly, small watering bags for newly planted trees (U.S. Pat. No. 5,117,582A, US20140366438A1) or other similar bags may be used and will be placed along the tree canopy drip line or beyond. However, this way of application is extremely time-consuming and the bags have no anti-theft security and may fly free across the landscape or into the nearby roadway during wind gusts. Therefore, they are least suitable for the use of the present invention. It is also not suitable for the purposes of the present invention to use sprinklers or any other similar form of surface application of irrigation fluid whereby use, there is high evaporation and little water penetration to greater depths. This causes shallow rooting of the tree, deformation of the root system and loss of stability of the tree with the risk of uprooting.

It is most advantageous to use the watering bags for mature trees (CZ33544U1/WO2021027980A1), which are designed for watering at and beyond the canopy dripline, are mobile, not susceptible to damage and can be used for multiple trees.

It is completely inappropriate to use a splash hose through which water flows in a stream and runs down the surface. The water is thus very little used by the tree, and the soil around the tree is often washed away (FIG. 8d).

### Blanket Mulching

The surface mulching for the purpose of the present invention will be carried out with organic material (e.g. bark, wood chips) or inorganic material (gravel), in a layer of 50-100 mm, on the surface where the root system of the tree is assumed to be located. The mulch must not be in contact with the trunk of the tree, leaving a gap of approximately 100 cm between the trunk and the starting mulch. Mulch will be checked once a year, organic mulch must be replenished to the original height as needed. The area to be mulched is determined as a minimum from the trunk to ½ crown projection, advantageously from the trunk to the entire crown projection, i.e. up to the tree's canopy drip line, most advantageously from the trunk to the edge of the root system, i.e. from the trunk to 2-3 times the distance of the canopy drip line from the trunk.

### Retention and Infiltration of Rainwater

The use of rainwater to maximize tree growth for the purpose of the present invention can be accomplished by a number of known technologies that ensure that water that falls onto impermeable surfaces around the tree is diverted into the root system area of the tree rather than into a storm drain (sewer) that carries it away from the area. Often, all that is needed is a modification to the design of the paved area to divert water from roof eaves into a permeable infiltration area or, for example, to break the kerbs of the road next to which the tree is growing. In order to increase the infiltration of rainwater, it is advisable to replace impermeable paved surfaces with permeable surfaces, i.e., e.g., asphalt pavement with pavement made of stone blocks or permeable concrete. Both of these measures must be implemented in such a way that there is no long-term waterlogging of the tree's root zone. Even flooding a tree for 24 hours has negative consequences and long-term negative effects on its biomass growth.

### Mechanical Loosening of Compacted Soils

For the purpose of the present invention, it is convenient to loosen the soil if it is compacted, e.g., by trampling or by vehicles traveling over the surface. This leads to an elimination of the limitation of water infiltration into the soil in the area of the root system and a restoration of soil gas exchange. The treatment also leads to the avoidance of restricted root growth due to the hard substrate into which the roots have to penetrate.

The principle for the application of this measure is that the root system of the tree must not be damaged. To carry out soil loosening, it is advisable to use manual removal of the vegetation cover with a hand tool such as a trowel or hoe, followed by gentle loosening (hoeing) of the substrate. More advantageously, a stream of compressed air is generated by equipment for removing loose materials, e.g., soil, using high-pressure air (e.g. EP0251660A1. AT82027T, U.S. Pat. No. 5,966,847A), also called pneumatic spades with a pressure nozzle (e.g. U.S. Pat. No. 5,782,414A, U.S. D408830S) at the end, operating at a gas pressure of 50-200 psi, more advantageously 80-120 psi, most advantageously 90 psi. The pneumatic spade is connected to a compressed air source, such as a compressor, which is advantageously an independent compressor, using an electric, diesel, or gasoline generator to generate pressure. The connection is made by means of a pressure control valve in the form of a gun (e.g., U.S. D512122S1).

Special aerators, mainly used for aerating lawns, can also be used for loosening, but these are the only ones that cannot be used at a distance of less than 3 meters from the tree trunk.

Particularly for deeper loosening of compacted soils, it is most advantageous to use pressure injection devices for the tree root system, which work on the principle of compressed air (U.S. Pat. Nos. 4,379,679A, 5,868,523A). A probe with a diameter of 1.5-5 cm and a length of 10-120 cm in the form of a metal needle fitted with openings for conducting air into the surrounding area is introduced to a depth of 1-100 cm from the soil surface. The probe is connected to a compressed air source, such as a compressor, which is advantageously an independent compressor, using an electric, diesel, or gasoline generator to generate pressure. The connection is made by means of a pressure control valve in the form of a gun (e.g., U.S. D512122S1).

### Change of Vegetation Cover

If there is vegetation cover under the tree in the root zone, e.g., grass, perennials, shrubs, etc., it is likely that this vegetation is draining nutrients and water from the soil; the water is then evapotranspired into the atmosphere, and the tree itself suffers from drought stress. Nutrient availability is also reduced, and if the biomass of the vegetation cover is regularly removed (removal of grass clippings), the soil loses organic matter. If this vegetation cover was removed and replaced with mulch, the tree would have more resources to grow and its biomass gain for the purposes of the present invention would be greater. An alternative solution is to replace the vegetative cover plants from water and/or nutrient-demanding plants with plants with lower demands.

The procedure for changing the vegetation cover is as follows. Existing vegetation is removed from part or all of the anticipated area of the tree root system. The removal shall not disturb the roots of the tree. The cleared area may be covered with organic or inorganic mulch (as specified under Area Mulching), or plants less demanding than the original vegetative cover may be seeded or planted.

### Radial Mulching (Radial Trenching)

Radial mulching is another measure carried out mainly to fix soil compaction in the root zone, which causes insufficient water infiltration and soil gas exchange. It is carried out using any non-destructive trenching technology, advantageously using a stream of compressed air generated by equipment for the removal of loose materials, e.g., soil, using high air pressure (e.g. EP0251660A1. AT82027T, U.S. Pat. No. 5,966,847A), also called pneumatic spades with a pressure nozzle (e.g. U.S. Pat. No. 5,782,414A, U.S. D408830S) at the end, operating with a gas pressure of 50-200 psi, advantageously 80-120 psi, most advantageously 90 psi. The pneumatic spade is connected to a compressed air source, such as a compressor, which is advantageously compressor independent, using an electric, diesel, or gasoline generator to generate pressure. The connection is made using a pressure control valve in the form of a gun (e.g., U.S. D512122S1).

In the root space of the tree, trenches are dug 5-50 cm deep, advantageously 10-40 cm deep, and most advantageously about 30 cm deep. They should be between 10-50 cm wide, advantageously approx. 30 cm. These trenches are made on a maximum of 20% of the entire area of the tree's root system. The trenches are either made in concentric circles with the trunk forming the center or in a ray pattern from the trunk to the crown drip line and beyond to a distance of 2-3 times the drip line distance from the trunk. When digging these tranches, the roots must not be damaged, and the use of a standard spade or excavator is entirely inappropriate.

These trenches are then filled with a suitable substrate to the original ground level. The substrate choice depends on the habitat's nature and consists mainly of coarser and finer fractions of rock aggregate, sand, soil, organic matter, porous materials such as zeolite or charcoal, and similar materials. These substrates may be enriched with substances that further improve the conditions of the tree in the habitat, e.g., humates, superabsorbent polymers, especially carbonates and polyacrylates, fertilizers, or soil amendments with mycorrhizal organisms.

The roots in the trenches shall be kept moist and shall not dry out during the entire period from the start of trenching until the trenches are filled.

### Vertical Mulching

Vertical mulching is another measure carried out mainly to fix soil compaction in the root zone, which causes insufficient water infiltration and soil gas exchange. It is carried out using hand-dug or drilled holes throughout the tree's root zone, 10-40 cm deep and 5-25 cm in diameter. These holes shall be located outside the tree's main roots, and the nearest permissible distance between the hole and the trunk shall be at least 250 cm.

The excavated holes are then filled with suitable substrate to the original ground level. The choice of substrate depends on the nature of the habitat and consists mainly of coarser and finer fractions of rock aggregate, sand, soil, organic matter, porous materials such as zeolite or charcoal, and such materials. These substrates may be enriched with substances that further improve the conditions of the tree in the habitat, e.g., humates, superabsorbent polymers, especially carbonates and polyacrylates, fertilizers, or soil amendments with mycorrhizal organisms.

The roots in the trenches shall be kept moist and shall not dry out during the entire period from the start of trenching until the trenches are filled.

### Depth Soil Injecting

Depth soil injecting should be used if the soil in the root system area is very compacted, not only at the surface but also at greater depths, up to 70 cm. The injectors inject pressurized air underground into the root zone and can also supply water or solutions or granules containing fertilizers and habitat soil enhancers.

Thus, for the purpose of the present invention, the injection is used to fix soil compaction less frequently for fertilization and mild watering of the tree.

The devices for depth soil pressure injection of the tree root system work on the principle of compressed air (U.S. Pat. Nos. 4,379,679A, 5,868,523A). A probe with a diameter of 1.5-5 cm and a length of 10-120 cm in the form of a metal needle equipped with holes for conducting air into the surrounding area is introduced to a depth of 1-100 cm from the soil surface. The probe is connected to a compressed air source, e.g., a compressor, preferably an independent compressor, using an electric, diesel, or petrol generator to apply pressure. The connection is made through a pressure control valve in the form of a gun (e.g. U.S. D512122S1) used to operate the injector.

The injection is applied over the entire surface of the root system at distances of 100-400 cm apart, avoiding large roots and not applying closer than 250 cm from the trunk. The injector needle shall be placed on the ground surface at the intended application point. The needle is inserted at the depth by manual pressure or a pneumatic hammer, which is part of the injector device. This will facilitate penetration of the needle to the intended depth of application. When the planned depth is reached, the valve is opened to supply the needle tip with pressurized air and, if applicable, a mixture of additives in water solution or granules. The pressure-driven mixture of air and liquid penetrates a large substrate volume, thus loosening and enriching it with additives. When the application is completed at one point, the needle is withdrawn, and the application is continued at the next application point until the desired coverage of the entire root system is achieved.

Granules or water solutions of additives can contain both macro- and micronutrients to enrich the substrate with nutrients, as well as other substances, such as porous materials like zeolite or charcoal, and substances that further improve the conditions of the tree in the habitat, e.g., humates, superabsorbent polymers, especially carbonates and polyacrylates, fertilizers, or soil amendments with mycorrhizal organisms.

### Soil Replacement in the Root Zone

If the soil in the root system is degraded, it is advantageous to use a total soil replacement and replace the soil with a substrate that provides better conditions for tree growth than the original soil on the site due to its structure, soil pH, nutrient content, and other substances content.

Only a maximum of 50% of the area of the root system can be replaced at once into a depth of 15-30 cm. If it is desirable to replace the soil in the entire area of the root system, the work must be divided into two stages. Replacement of the second half should only follow at least two months after the first stage in the case of active root growth. The dormancy period is not counted in the two-month period.

Soil replacement begins by staking out a maximum of 50% of the area of the root system. In this area, non-invasive technology removes the substrate to the planned depth. Advantageous, and essentially the only way to do this at this time, a stream of pressurized air is generated by equipment for removing loose materials, such as soil, using high-pressure air (e.g., EP0251660A1. AT82027T, U.S. Pat. No. 5,966,847A), also called pneumatic spades with a pressure nozzle (e.g., U.S. Pat. No. 5,782,414A, U.S. D408830S) at the end, operating at a gas pressure of 50-200 psi, advantageously 80-120 psi, most advantageously 90 psi. The pneumatic spade is connected to a compressed air source, such as a compressor, preferably a compressor independent, using a diesel or gasoline generator to apply pressure. The connection is made by means of a pressure control valve in the form of a gun (e.g., U.S. D512122S1).

The soil is separated from the tree's roots by a high velocity and pressure air stream and blown away from the work area in one direction. The soil is then removed. A substrate adapted to the nature of the tree habitat and the type of tree growing on the site is carefully transported into the root space, thus freed. The substrate choice depends on the habitat's nature and consists mainly of coarser and finer fractions of rock aggregate, sand, soil, organic matter, porous materials such as zeolite or charcoal, and similar materials. These substrates can be enriched with substances that further improve the conditions of the tree in the habitat, e.g. humates, superabsorbent polymers, especially carbonates and polyacrylates, fertilizers, or soil amendments with mycorrhizal organisms.

The roots of the tree must be kept moist and not allowed to dry out during the entire period from the start of the removal of the original substrate until refilling.

### Application of Fertilizers and Tree Habitat Soil Enhancers

For embodiments of the present invention, any supply of nutrients to the tree and improvement of nutrient uptake, particularly from the set S trees, that leads to maximization of carbon sequestration from the atmosphere is appropriate, advantageously under the condition of maintaining stability and maintaining the long-term perspective of the tree. This includes the application of soil pH modifiers, the application of inorganic and organic fertilizers, surface mulching with organic mulches or humic substances and organic matter leachates, the delivery of superabsorbent polymers and wetting agents to the soil in the root zone, and the initiation or promotion of mycorrhizal activity by the tree. (FIG. 9). These agents include amendments in the form of powders, granules, crystals, liquid formulations, or organic matter in its natural form.

These products are applied by spreading on the soil surface by hand or by spreader, advantageously by spreading over the entire soil surface in the area of the presumed root system, by mixing into the additional substrate supplied, by incorporation into the soil, by depth soil injecting using tree root system pressure injection equipment, working on the principle of compressed air (U.S. Pat. Nos. 4,379,679A, 5,868,523A), by watering or adding to the irrigation fluid, which is applied by means of a hose connected to a mobile or stationary tank with irrigation fluid, by soaking with drip irrigation applied e.g. by means of a drip hose connected to a mobile or stationary irrigation fluid tank, sprinklers and other means of surface irrigation, advantageously by watering bags for newly planted trees (U.S. Pat. No. 5,117,582A, US20140366438A1) distributed over the entire surface of the area, where the extent of the root system of the tree is presumed, the most advantageously by means of watering bags for mature trees (CZ33544U1/WO2021027980A1), spread over the entire surface of the area where the extent of the root system of the tree is presumed, or also by application to the surface of the tree or its assimilatory apparatus, i.e. leaves and needles, by spraying, mist spraying or fogging, under the condition that the sun does not shine brightly. The application is carried out by hand sprayers, mechanical pressure sprayers, motorized sprayers, or pressure sprayers with compressors or mist sprayers). Nutrients can also be applied by micro- and macro injection using so-called injectors (e.g. JP6538749B2, U.S. Pat. No. 1,756,453A), i.e. devices for delivering the nutrient solution to the tree trunk. The fertilizer solution is then distributed through the tree's sap circulation system to all the tree's tissues, and its effect is very rapid.

The tree uses, among other sources, the nutrients contained in the soil of the habitat for its growth. These include inorganic substances such as biogenic elements (nitrogen, phosphorus, potassium), secondary biogenic elements (calcium, sulfur, magnesium), and trace elements such as boron, chlorine, manganese, iron, zinc, copper, and molybdenum.

The tree adapts to its habitat over time, and although the exact mechanisms are not entirely clear, it is known that various species of micro-organisms, especially fungi, help the tree to use the nutrients. This phenomenon is called mycorrhiza, and the cooperation is mutual. This means the tree also invests part of its energy in this cooperation and supplies the fungi, particularly with energy resources in the form of metabolites-organic substances.

In nature, this is a continuous balanced process of nutrient cycling, where the tree slowly adapts to the nature of the habitat, including the composition of the soil in which it grows. The composition and quantity of mycorrhizal fungi may also change according to the tree's needs. Both inorganic and organic matter are supplied to the soil by the decomposition of organic matter on the soil surface, especially leaves, fallen fruit, and wood. Moreover, unless there is an extreme imbalance, the tree grows and generates new biomass every year.

However, fallen leaves and other organic matter are removed in urbanized landscapes, e.g., by raking fallen leaves. This deprives the soil substrate of nutrients and organic matter in the root system, which, among other things, retains water in the soil. A further complication in urbanized landscapes, particularly in cities, is that the soil into which trees are planted is completely altered, does not correspond to the natural structure of the soil layers, is very heterogeneous in its properties, often contains a large proportion of human activity residues such as concrete, and is generally very unfavorable for plant growth, including a lack or excess of certain nutrients. Another problem of urban soils is the frequent disbalance of soil pH values, particularly towards the alkaline spectrum, primarily due to dust and materials containing calcium and its compounds. Any extreme in the pH response of the soil towards acidity or alkalinity, i.e., a pH lower than 5 and higher than 8, has a significant impact on nutrient uptake and the activity of soil microorganisms.

For the purpose of the present invention, it is essential that the tree gains biomass as much as possible while maintaining the long-term perspective of the tree. The growth can be supported by adjusting the pH of the soil, application of soil amendments or modification of soil nutrient balances and stocks, either by application to the substrate, its surface, or the assimilative apparatus of the tree.

For applying fertilizers and soil amendments to the tree, adding biogenic elements, especially nitrogen and phosphorus, should be the last-to-choose measure to improve the tree's growth, and the other solutions, according to the present invention, should be given priority.

It is essential that any change in pH or nutrient ratio is slow (i.e., 1-5 years), especially for trees over 20 years old.

### Soil Analysis

If there is an assumption or presumption that a tree is suffering from an imbalance or lack of nutrients in the site, it is always advantageous to analyze the soil in which it grows. Soil samples should be taken, advantageously, from two depths, advantageously 30 and 60 cm, advantageously from at least two points around the tree, advantageously under the crown and at the canopy dripline, using a non-destructive method without damaging the roots, about 1 kg of substrate from each point. It means that ideally, at least 4 samples are available. These are advantageously placed in an airtight transport container and sent to the laboratory, where they should be processed as quickly as possible. Alternatively, samples can be placed in paper bags, spread out in the shade, and allowed to air dry. They are then transported to the laboratory. At least 4 test results will, therefore, be available at the end of the analysis. Using a narrow-tipped probe is less advantageous because of the possible damage to the root system by the sharp tip of the probe.

Sampling and analysis can be carried out throughout the year, but due to the variability of values throughout the year, it is advantageous to sample in late winter, when it is also possible to determine relevant soil nitrogen values.

Soil sample tests should be conducted using a method that allows the results to be related to one of the systems of reference values known in the region. The reference values are used to assess whether the analysis results indicate a deficiency, optimum levels, or excess of the tested substance. In the Czech Republic, these include the determination of pH using a logarithmic scale of 1-14, with 7 being the neutral value, and the Mehlich III analytical method for determining soil nutrient content. The Mehlich III extraction solution contains 0.2 mol. L-1 CH3COOH, 0.015 mol. L-1 NH4F, 0.013 mol. L-1 HNO3, 0.25 mol. L-1 NH4NO3 and 0.001 mol. L-1 EDTA for the determination of essential nutrient levels-potassium, phosphorus, magnesium, and calcium. After extraction, the leachate is measured, often in the presence of other reagents, for the individual nutrients using a spectrometer. Specific extraction reagents are used to determine the content of trace elements in the soil, where the following methods can be used:
Boron—hot water—according to Berger and Truog
Molybdenum—a mixture of ammonium oxalate and oxalic acid according to Grig
Copper, manganese, zinc and iron-group leach according to Lindsay and Norvell—mixture of DTPA, CaCl2 and TEA

### Determination of Soil Type

Since the soil type is important for defining the optimum content of certain nutrients in the soil, the first step in the soil analysis should be to determine the soil type. Take the soil in the fingers, moisten with water (30-40° C. warm), knead between the fingers and assess the proportion of sandy and clay particles:
Light soil—predominantly quartz sand
Loam soil—contains equal proportions of clay and sand particles
Heavy soil—contains mostly fine clay particles (soil is sticky)

### Soil Reaction

The pH of the soil is determined using standard methods, e.g., using a test kit, advantageously by instrumental methods using a pH meter, and most advantageously in a laboratory. The test result is a value of 0-14, advantageously to one, most advantageously to two decimal places.

### Soil Nutrient Levels in Soil

Next, the analytical method is used to determine the nutrient content of the samples, in particular nitrogen, potassium, phosphorus, magnesium, and calcium. The content of the so-called micronutrients, i.e., in particular, boron, molybdenum, copper, manganese, zinc, and iron, can also be advantageously determined.

### Adjusting the Soil Reaction

For the purposes of the present invention, it is advantageous if the pH of the soil is adjusted to the ideal level for the particular tree taxon growing at the treated site. Although there are trees that are considered tolerant of acidic or alkaline soils, maximum biomass growth generally occurs in the pH range of 5.5-8.0, preferably 6-7.5, and most preferably 6.2-7. The soil reaction influences the availability of nutrients, and in general, nutrients are most available to the tree in these defined intervals. Miller, Jarrod. (2016). Soil pH Affects Nutrient Availability. https://www.researchgate.net/publication/305775103_Soil_pH_Affects_Nutrient_Availability

Therefore, adjusting the soil pH towards the desired range before any further fertilization is advantageous. The adjusting can be done in the following ways:

### Increasing Soil pH

The acidic pH of the soil can be increased by applying calcium carbonate (limestone) in the form of fertilizing lime or wood ash. Finely ground limestone is more easily absorbed by plants, while coarsely ground limestone remains in the soil for a more extended period, and the change is slow. It is, therefore, best to use a mixture of fine and coarser limestone fractions. Different amounts of limestone are needed to adjust the pH of soils based on the soil type and the original basal pH. As a guide, the following list can be given:

| Light soil | | Limestone | Loam soil | | Limestone | Heavy soil | | Limestone |
|---|---|---|---|---|---|---|---|---|
| pH | [symbol] | [symbol] | pH | [symbol] | [symbol] | pH | [symbol] | [symbol] |
| to 4.5 | 1.20 | 2.40 | to 4.5 | 1.50 | 3.00 | to 4.5 | 1.70 | 3.40 |
| 4.6-5.0 | 0.80 | 1.60 | 4.6-5.0 | 1.00 | 2.00 | 4.6-5.0 | 1.25 | 2.50 |
| 5.1-5.5 | 0.60 | 1.20 | 5.1-5.5 | 0.70 | 1.40 | 5.1-5.5 | 0.85 | 1.70 |
| 5.6-5.7 | 0.30 | 0.60 | 5.6-6.0 | 0.40 | 0.80 | 5.6-6.0 | 0.50 | 1.00 |
| | | | 6.1-6.5 | 0.20 | 0.40 | 6.1-6.5 | 0.25 | 0.50 |
| | | | | | | 6.6-6.7 | 0.20 | 0.40 |

[symbol]

, M. Ph. D. [symbol] [symbol] [symbol] [symbol] [symbol] [symbol] [symbol] . 02/VR. [symbol] [symbol] a [symbol] [symbol] [symbol] . 2021.

Dolomitic limestone can only be used to a limited extent to raise pH because it also contains magnesium bound as CaMg(CO3)2, and increasing magnesium content blocks the uptake of other nutrients.

Wood ash contains significant amounts of potassium, calcium, and small amounts of phosphate, boron, and other nutrients. A single application is not very effective, but wood ash can significantly contribute to rising the soil pH with regular repeated application.

The effectiveness of limestone application varies according to other factors and soil analysis and applications should be repeated at intervals of 2-10 years.

### Lowering Soil pH

Nitrogen fertilizers containing ammonia, sulfates, elemental sulfur, or organic matter with a pH lower than 7 can be used to lower the pH of the soil. For the purpose of the present invention, it is most advantageous to use elemental sulfur at a rate of 100-250 g/m2, which acts slowly as it must first be converted to sulfate in the soil. The use of amendments containing sulfates, where the conversion to the more accessible form of elemental sulfur has already taken place, appears less advantageous. It is possible to use, for example, aluminum sulfate (Al₂(SO₄)₃), where aluminum aids the uptake of sulfur. However, aluminum is toxic to plants in high concentrations in its inorganic form, so its use is limited to highly alkaline soils. The toxicity limit for plants is between 1.0-3.0 ppm. Another option is to use ferric sulfate Fe₂(SO₄)₃ or ferrous sulfate (FeSO₄) because of the lower toxicity of iron compounds. Another sulfate suitable for lowering soil pH is ammonium sulfate (NH4)2SO4, but this adds nitrogen to the soil, which may not be desirable. Sulfate dosing should be staggered as pH reduction can occur very quickly and have a negative effect on trees.

Slow reduction can be accomplished by surface application of organic matter with a pH below 7, e.g., organic mulch such as leaves, leaf litter, or compost, over the entire root system area.

To control the soil reaction, using humates, products containing humic substances such as fulvic acids, humic acids, and more advantageously activated humic acids or humins is advantageous. These substances regulate the pH in both directions towards a neutral value of 7.

Amendments containing humic substances are made from coal, especially leonardite, found in some coal deposits, and are also made from peat or wood. They are commercially available as powders, granules, or liquid preparations. Their primary use in soil improvement is agriculture or to promote turf growth. However, they are not used to maximize ecosystem services to trees.

Its application is simple: throughout the year, preferably from early spring to late autumn, the granular or powdered product is regularly applied by sprinkling over the entire area of the tree root system on the soil surface. Alternatively, the powder or granules may be incorporated into the soil at a 0-20 cm depth from the surface. Alternatively, we can apply the appropriate dose in the entire volume of the substrate we are using for soil replacement in the area of the root system or if we are expanding the rootable space volume of the tree. In this case, the powder or granules are mixed in advance to the entire volume of the substrate to be added, and then the enriched substrate is used for the task.

Liquid amendments can be surface applied throughout the root system area to the soil or used as an addition to the watering liquid, where watering bags for mature trees can be used advantageously.

The total amount of humates applied for the purposes of the present invention should range from 0.5 g to 100 g per m2. The application should be repeated, generally after 3-5 years.

### Adding Nutrients to the Soil

Adding nutrients to the soil means the application of inorganic and organic fertilizers with nutrients lacking in the soil so that their content and availability in the substrate of the whole root system are in line with or close to optimum values, which may be supported by surface mulching with wood chips or other organic matter, application of humids or organic matter leaches.

By soil analysis, we determine the nutrient content in the soil of the tree site, i.e., the content of biogenic elements (nitrogen, phosphorus, potassium), secondary biogenic elements (calcium, sulfur, magnesium), and also trace elements such as boron, manganese, iron, zinc, copper and molybdenum in the soil and compare them with reference tables indicating the ideal range of values for each nutrient. The reference tables must be specific to the analytical method used, as different analytical methods may give different results for the same soil sample.

In practice, it is advantageous if the soil analysis is carried out by a certified laboratory and the further treatment of nutrients in the soil is set by a professionally trained person, e.g., a pedologist or plant physiologist.

The tables below give the values for the Mehlich Ill analytical method, determined spectrometrically, for 66 microelements. The values determined by the methods:
Boron—hot water—according to Berger and Truog
Molybdenum—a mixture of ammonium oxalate and oxalic acid, according to Grig
Copper, manganese, zinc, and iron—group leach according to Lindsay and Norvell-DTPA mixture, CaCl2, and TEA

We evaluate the need for supplementation of individual elements in the soil, i.e., compare the status of the test results against reference values that fall into the category of “conforming” or “good,” more advantageously “good” or “medium content” for the microelements category.

### Evaluation of Phosphorus Content:

| Content | P content (mg · kg⁻¹) |
|---|---|
| Low | up to 55 |
| Conforming | 56-100 |
| Good | 101-170 |
| High | 171-245 |
| Very high | over 245 |

According to Annex No. 3 of [symbol] Č. 275/1998 Sb.,

[symbol]

[symbol]

[symbol]

### Evaluation of Potassium Content:

| | K content (mg · kg⁻¹) | | |
|---|---|---|---|
| Content | light soil | loam soil | heavy soil |
| Low | up to 100 | up to 125 | up to 180 |
| Conforming | 101-220 | 126-250 | 181-310 |
| Good | 221-340 | 251-400 | 311-490 |
| High | 341-500 | 401-560 | 491-680 |
| Very high | Over 500 | Over 560 | Over 680 |

According to Annex No. 3 of [symbol] Č. 275/1998 Sb., ve

[symbol]

[symbol]

[symbol]

### Evaluation of Calcium Content:

Ca content (mg · kg⁻¹)

| Content | light soil | loam soil | heavy soil |
|---|---|---|---|
| Low | up to 1,000 | up to 1,100 | up to 1,700 |
| Conforming | 1,001-1,800 | 1,001-2,000 | 1,701-3,000 |
| Good | 1,801-2,800 | 2,001-3,300 | 3,001-4,200 |
| High | 2,801-3,700 | 3,301-5,400 | 4,201-6,600 |
| Very high | over 3,700 | over 5,400 | over 6,600 |

According to Annex No. 3 of [symbol] Č. 275/1998 Sb., ve

[symbol]

[symbol]

[symbol]

Evaluation of available sulphur content, i.e., sulphur in soil solution (SH2O) and adsorbed sulphur determined by 0.032 mol/l NaH2PO4 (Sads):

| Content | S content (mg · kg⁻¹) |
|---|---|
| Very low | up to 10 |
| Low | 11-20 |
| Conforming | 21-30 |
| Good | 31-40 |
| High | over 40 |

[symbol]

, M. a kol: [symbol] [symbol] [symbol] [symbol] [symbol] 3. [symbol] [symbol] . [symbol] [symbol] [symbol] v Praze, Katedra agroenvironmentalní chemie a vyzivy rostlin. Praha 2018. ISBN 978-80-213-2893-8.

### Evaluation of Magnesium Content:

| | Mg content (mg · kg⁻¹) | | |
|---|---|---|---|
| Content | light soil | loam soil | Heavy soil |
| Low | up to 80 | up to 105 | up to 170 |
| Conforming | 81-180 | 106-225 | 171-300 |
| Good | 181-320 | 226-365 | 301-435 |
| High | 321-425 | 366-480 | 436-580 |
| Very high | over 425 | over 480 | over 580 |

According to Annex No. 3 of [symbol] Č. 275/1998 Sb., ve

[symbol]

[symbol]

[symbol]

### Evaluation of the Content of Microelements:

| | | | Con- | Con- | Con- | Con- |
|---|---|---|---|---|---|---|
| | Con- | Soil | tent | tent | tent | tent |
| Element | tent | type | Low | medium | High | Toxic |
| Mn/ | Total | — | 300 | 301-3000 | over 3000 | 10006 |
| Manganese | 1M HCl | light | 90 | 91-170 | over 171 | — |
| | | loam | 130 | 131-230 | over 230 | — |
| | | heavy | 190 | 191-280 | over 280 | — |
| | DTPA | — | 10 | 11-100 | over 40 | — |
| Zn/Zinc | Total | — | 30 | 31-100 | over 100 | 300 |
| | 1M HCl | light | 5 | 5.1-10 | over 10 | — |
| | | loam | 7 | 7.1-14 | over 14 | — |
| | | heavy | 9 | 9.1-16 | over 16 | — |
| | DTPA | — | 1.0 | 1.1-2.5 | over 2.5 | — |
| Cu/Copper | Total | — | 10 | 10.1-60.0 | over 60 | 125 |
| | 1M HCl | — | 3.5 | 3.51-9.0 | over 9.0 | — |
| | DTPA | — | 0.8 | 0.81-2.7 | over 2.7 | — |
| B/Boron | Total | — | 10 | 10.1-40.0 | over 40 | 100 |
| | Berger- | light | 0.4 | 0.41-0.7 | over 0.7 | — |
| | Truog | loam | 0.6 | 0.61-1.0 | over 1.0 | — |
| | | heavy | 0.8 | 0.81-1.5 | over 1.5 | — |
| Mo/ | Total | — | 0.3 | 0.31-3.0 | over 3.0 | 5 |
| Molybdenum | Molyb. | light | 6.4 | 6.41-7.0 | over 7.0 | — |
| | Number | loam | 6.8 | 6.81-7.8 | over 7.8 | — |
| | | heavy | 7.2 | 7.21-8.2 | over 8.2 | — |
| Fe/Iron | Total | — | 1.5 | 1.51-4.0 | over 4.0 | — |
| | DTPA | — | 8 | 8.1-75.0 | over 75 | — |

NEUBERG, J. et al. (1990). Komplexní metodika [symbol] rostlin. Metodiky pro [symbol] [symbol] [symbol] do [symbol] praxe, UVTIZ Praha, č.1.

### Assessment of the Need for Nitrogen Fertilization

Nitrogen is predominantly found in the soil in the organic form (98-99%), and only a small part is found in the mineral form (NH4+, NO3− or NO2−). The nitrogen fixed in organic form represents a stock form of N that plants can only use after mineralization. On the other hand, mineral nitrogen represents nutrients immediately available for use by the tree. Soil analyses often only result in a total mineral nitrogen (Nan) value, possibly broken down further into NH4+ and NO3−.

| | Nitrogen dose (kg [symbol] ) according to the Nan | | |
|---|---|---|---|
| Nan content in | content of the subsoil (30-60 cm) | | |
| topsoil (0-30 cm) | <10 mg | 10-20 mg | >20 mg |
| mg · N · kg⁻¹ | N · kg⁻¹ | N · kg⁻¹ | N · kg⁻¹ |
| <6.0 | 100 | 90 | 90 |
| 6.1-10.0 | 90 | 75 | 60 |
| 10.1-15.0 | 80 | 60 | 40 |
| 15.1-20.0 | 70 | 45 | 30 |
| 20.1-25.0 | 60 | 30 | 0 |
| 25.1-30.0 | 50 | 30 | 0 |
| 30.1-35.0 | 30 | 0 | 0 |
| >35.0 | 0 | 0 | 0 |

A simple visual assessment is an important factor in deciding whether or not to fertilize with nitrogen. Suppose the tree does not show symptoms of nitrogen deficiency (in particular, overall chlorosis, i.e., lightening of the leaves, starting on older leaves, overall small leaves, and other symptoms that are no longer typical of nitrogen deficiency alone). In that case, applying nitrogen fertilizer at all is not appropriate. If symptoms are present, and the test shows low levels of available forms of nitrogen in the soil, it is advisable to contact a trained professional for advice on how to proceed.

Then, we calculate the dose of mineral fertilizer to be applied to the entire root zone. In addition to these nutrients, mineral fertilizers contain other substances that do not have a direct fertilizing effect. It is, therefore, necessary to convert the amount of nutrients required into the amount of fertilizer concerned. For this calculation, it is necessary to know the percentage of the nutrient content the manufacturer states. In the case of nitrogen fertilizers, nitrogen is given in the ‘pure’ element (N). Nutrient contents are usually expressed in oxides (P2O5, K2O, MgO) for other fertilizers. Therefore, in the above fertilizer tables, the nutrient rate is quantified in both ways-oxide (element), e.g., P2O5 (P) rate=35 (15) kg·ha-1. For the case where the nutrient content is expressed in terms of an element, conversion factors are given for the conversion from element to oxide and vice versa.

| | | Coef- | | | Coef- | |
|---|---|---|---|---|---|---|
| Element | | ficient | Oxide | | ficient | Element |
| N | × | 4.42 = | NO3 | × | 0.22 = | N |
| N | × | 1.28 = | NH4 | × | 0.77 = | N |
| P | × | 2.292 = | P2O5 | × | 0.4363 = | P |
| K | × | 1.204 = | K2O | × | 0.8303 = | K |
| Ca | × | 1.399 = | CaO | × | 0.7148 = | Ca |
| Mg | × | 1.658 = | MgO | × | 0.6033 = | Mg |

Calculate the amount of fertilizer in kilograms or liters per hectare by dividing the specified rate (kg·ha-1) by the percentage of nutrient content in the fertilizer (%) and multiplying by 100. When calculating the amount of fertilizer in tonnes per hectare, the procedure is the same, but the result is multiplied by 0.1.

[symbol] [symbol] : [symbol] [symbol] [symbol] [symbol] [symbol] [symbol] [symbol] [symbol] , [symbol] [symbol] [symbol] . 2020. ISBN 978-80-7401-024-8

The amount of fertilizer thus derived is then applied to the area to be fertilized by calculation. This corresponds to the area of the entire root system, preferably with an increase of at least 10%. Fertilizing outside the existing root system will encourage the tree to expand its root system and will prevent girdling roots.

By visual assessment, we presume or estimate, alternatively by instrumental measuring using ground penetrating radar-based equipment, determine the extent of the tree's roots. We measure the distance from the trunk to the boundary of the root system r, and since we can approximate the shape of the tree root system to that of a circle, we calculate the area P of a circle of radius r.

$$P = 3.14 \times r$$

In case we want to include a 10% buffer, we calculate the area P according to the formula:

$$P = 3.14 \times r \times 1.1$$

It is advisable to divide the fertilizer application into at least two doses, which will be applied with a time gap.

### Organic Fertilizers

Nutrients can also be supplied to the tree by organic fertilizers, such as compost, manure, urea, and similar. These have the advantage of slowly releasing nutrients into the soil and enriching the substrate with organic matter. However, their disadvantage in implementing this invention is the variability in the content of individual nutrients, which makes precise dosage and targeted removal of deficiencies impossible. These are complex fertilizers, i.e., they contain several nutrients at once, so adding one element increases the supply of others, which can exacerbate the deficiency by blocking the absorption of the deficient element. As set S trees are located in populated areas, using manure on trees can be problematic for aesthetic and hygiene reasons. For the purpose of the present invention, using compost and its leachates is advantageous, particularly for promoting soil edaphon development, mycorrhizae, or infiltration and retention of rainwater.

Compost is applied by spreading a layer of 20-50 mm of mature compost on the surface of the substrate in part, advantageously, on the whole surface of the substrate where the tree roots are located. The compost must not be in contact with the tree trunk.

### Blanket Mulching

Mulching for the purpose of slow nutrient supply consists of covering at least part of the root zone area, advantageously the whole root zone area, with organic material that will release nutrients into the soil through its degradation over a long period of time and also create an environment suitable for the development of soil life, which will then help to convert the nutrients in the soil from inaccessible to accessible forms, for example in the form of mycorrhiza. An example of such organic material is wood chips from branches. The mulch will be applied in a 50-100 mm layer on the soil surface, where we presume the tree's root system is located. The mulch must not be in contact with the tree's trunk, leaving a gap of approximately 100 cm between the trunk and the starting mulch. Mulch will be checked once a year; organic mulch must be replenished to the original height as needed.

### Humates

Although products containing humic substances are not fertilizers as such, their use to improve the nutritional parameters of the soil in which the tree grows is very beneficial. They are substances that improve the uptake of nutrients already present in the soil but which are not in an accessible form and/or cannot be taken up by the tree because of the low organic matter content of the soil and the low abundance of soil microorganisms. They improve the soil structure, adjusting the soil pH towards a neutral value and thus facilitating better absorption of minerals.

Humates are amendments containing humic substances such as fulvic acids, humic acids, advantageously activated humic acids, or humins.

Amendments containing humic substances are made from coal, especially leonardite, found in some coal deposits and made from peat or wood. They are commercially available as powders, granules, or liquid products. Their primary use in soil improvement is agriculture or to promote turf growth. However, they are not yet used to maximize the ecosystem services of trees.

Its application is simple: throughout the year, preferably from early spring to late autumn, the granular or powdered product is regularly applied by sprinkling over the entire area of the tree root system on the soil surface. Alternatively, the powder or granules may be incorporated into the soil at a 0-20 cm depth from the surface. Alternatively, we can apply the appropriate dose in the entire volume of the substrate we are using for soil replacement in the area of the root system or if we are expanding the rootable space volume of the tree. In this case, the powder or granules are mixed in advance to the entire volume of the substrate to be added, and then the enriched substrate is used for the task.

Liquid amendments can be surface applied throughout the root system area to the soil or used as an addition to the watering liquid, where watering bags for mature trees can be used advantageously.

The total amount of humates applied for the purposes of the present invention should range from 0.5 g to 100 g per m2. The application should be repeated, generally after 3-5 years.

### Organic Matter Leachates

Compost leachate (compost tea) is liquid produced by leaching good quality compost in water, which is advantageously rainwater. This leached mixture of water, organic matter, and soil microorganisms is applied to the surface of the substrate by a hose connected to a mobile solution reservoir, more advantageously using a pressurized tree root injection apparatus operating on the principle of compressed air (U.S. Pat. Nos. 4,379,679A, 5,868,523A). A probe with a diameter of 1.5-5 cm and a length of 10-120 cm in the form of a metal needle fitted with openings for conducting air and liquids into the surrounding area is delivered to a depth of 1-100 cm from the soil surface. The probe is connected to a source of compressed air, e.g., a compressor, preferably an independent compressor, using a diesel or petrol generator to apply pressure. The connection is made by means of a pressure control valve in the form of a gun (e.g. U.S. D512122S1). With a second hose connected to the leachate reservoir, the leachate is pumped deep into the proximity of the roots.

### Adding of Superabsorbent Polymers and Wetting Agents

In times of climate change, not only precipitation totals but also rain distribution over time is changing. Trees face drought stress, which reduces tree biomass production. Situations arise when a high-intensity rainfall episode, such as a summer storm, occurs during the dry and hot season. Much water hits the surface, but almost all of it runs off the surface into storm drainage. The runoff is because there are many paved surfaces in cities, such as asphalt street surfaces, that do not allow water to infiltrate and drain away. In times of drought and heat, there is also a hard layer of completely dry soil on the surface of the open ground, which acts as a barrier and only lets the water through when it has soaked up a certain amount of water, which can occur, e.g., 1 hour after the start of the rain or even later. Very little of the water from a rainfall episode is used.

### Wetting Agents

For better use of rainwater, it is possible to use so-called wetting agents, i.e., products that reduce the surface tension of surfaces, especially polyacrylamides, e.g., sodium lauryl sulfate (SLS, chem. formula CH3(CH2)10CH2(OCH2CH2)nOSO3Na), and thus help to improve the absorption of rainwater. They are now mainly used to improve the growth and condition of lawns. The same group of products also includes products that inoculate the substrate surface with soil microorganisms, e.g., Bacilluslicheniformis, Cellulomonascellasea, Pseudomonasbalearica, and others., by means of an aqueous solution, which then disrupt the hydrophobic soil surface and thus improve water absorption.

The amendments are commercially available on the market and are either in powder, granules or liquid form.

The application is mainly surface application, either spot or full surface application over the entire area where the root system is located; for powdered or granular products, it is done by spreading by hand or using granule spreaders; for liquid products, application by addition to the irrigation fluid is suitable.

### Superabsorbent Polymers

For a better water supply over a longer period of time, it is advantageous to use so-called superabsorbent polymers, also called hydrogels. These are substances that are strongly hydrophilic and can bind water for a long time. Chemically, they are polyacrylates and polycarbonates. They are commercially available on the market and are used to overcome droughts, both for trees and in other areas of human activity such as agriculture. However, they are not used to maximize the growth of trees to combat climate change.

The application of superabsorbent polymers to existing trees must be made so that they do not remain on the soil surface but are transported below the soil surface, advantageously covered by a layer of soil, advantageously at least 5 cm. Otherwise, the superabsorbent polymers expand in the direction of least resistance after swelling, i.e., upwards to the surface, and its effectiveness is reduced. Their application to existing trees is therefore carried out in several ways:
Superabsorbent polymer is added to the new substrate, and the substrate is used for further modification of the habitat according to the present invention, e.g., for soil replacement at the habitat, for additional installation of soil cells, for radial trenching, or for vertical mulching.
Superabsorbent polymer is added to the mixture and injected into the ground by depth soil injection, according to the present invention, often in a mixture with other additives.
   Application of Amendments with Mycorrhizal Fungi

Mycorrhiza is the symbiotic coexistence of fungi with the roots of higher plants. Either fungal hyphae penetrate the root cells of the primary cortex (endomycorrhiza), or hyphae remain only in the intercellular space (ectomycorrhiza).

A common feature of mycorrhizal symbioses is that the fungal mycelium never extends into the middle cylinder of the plant root. Mycorrhiza is primarily a mutualistic relationship, i.e., mutually beneficial, although exceptions exist. It is based on a state of equilibrium between organisms.

The importance of mycorrhiza has long been underestimated, but recently, it appears that 70-90% of all plants are mycorrhizal. Therefore, mycorrhiza has a significant impact on plant life.

The tree supplies the fungus with carbon (energy) sources, and the fungus supplies the plant with water and dissolved minerals (such as H2PO4-ion). Mycorrhizal fungi stimulate the rhizosphere microflora and its enzymatic activities, which are essential for nutrition, growth, and plant health. This means that if nutrients are not available to the tree in the habitat in an accessible form, the mycorrhizal relationship makes the nutrients accessible for the tree to use. This phenomenon is significant for the embodiment of the present invention because very often, the situation arises that, for example, biogenic elements are present in the habitat in stock forms, i.e., not easily accessible to the tree. By fertilizing the tree, we solve the problem in the short term, and we have to repeat it. If we manage to start mycorrhizal processes, this need is often completely eliminated. The tree builds a long-term relationship with the fungal community, and the composition of the mycorrhizal organisms can change according to the tree's needs. Fertilizing, which often means brutal interference with the mycorrhizal community and its cooperation with the tree, causes part of the mycorrhizal community to die because the tree no longer supports it since it no longer needs the help of these fungi.

On open soils, especially in natural areas, mycorrhiza arises spontaneously and naturally in most tree habitats, mainly through the transfer of fungal spores by wind and subsequent attachment to a suitable habitat. In urban environments with altered anthropogenic soils, the natural establishment of mycorrhizal relationships is impaired and, in some habitats, may be completely inhibited. Negative effects include, for example, soil compaction, which prevents many species of mycorrhizal fungi from effectively colonizing the substrate, altered soil pH to extremes of less than 4 and more than 8, or lack of organic matter in the soil. This fact also suggests that the habitat improvement measures disclosed in the present invention should be taken as a complex of different measures with synergistic effects. For example, if one uses products containing mycorrhizal fungi to initiate substrate colonization, conducting depth soil injection or at least mechanical liquefaction of compacted soils before introducing mycorrhizal fungi makes sense.

Plants, including trees, are divided into two main groups regarding mycorrhiza: those with endomycorrhiza (most plants) and those with ectomycorrhiza (about 2000 species). Among the tree species that use ectomycorrhizal relationships are, for example, oak, pine, spruce, eucalyptus, birch, and olive trees.

The absence or insufficient colonization of the substrate by mycorrhizal fungi can be remedied by the application of amendments containing spores or cultures of mycorrhizal fungi, possibly supplemented with germs of other microorganisms that promote fungal colonization and other substances such as fertilizers to initiate colonization.

Fungi of the class Glomeromycota, especially those of the genus Glomus, particularly Glomus mosseae, Glomus etunicatum, Glomus claroideum, Glomus micro aggregatum, Glomus geosporum and others, are used for endomycorrhiza.

For ectomycorrhiza, specific amendments are designed that use a wide range of fungi species, most of which are basidiomycetes (Basidiomycota), as well as ascomycetes (Ascomycota) and also zygote fungi (Zygomycota), e.g. the genera Rhizopogon, Pisolithus, Scleroderma, Laccaria or Suillus, and others.

It is possible to find out which type of mycorrhiza a tree species uses, e.g. in the FungalRoot database at: https://www.gbif.org/dataset/744edc21-8dd2-474e-8a0b-b8c3d56a3c2d with accompanying explanation Soudzilovskaia, N. A., Vaessen, S., Barcelo, M., He, J., Rahimlou, S., Abarenkov, K., Brundrett, M. C., Gomes, S. I. F., Merckx, V. and Tedersoo, L. (2020), FungalRoot: global online database of plant mycorrhizal associations. New Phytol, 227:955-966. https://doi.org/10.1111/nph. 16569

An overview of the most important northern hemisphere trees with mycorrhizal type assignments is also given in Brundrett, M. C., Tedersoo, L. Resolving the mycorrhizal status of important northern hemispheretrees. Plant Soil 454, 3-34 (2020). https://doi.org/10.1007/s11104-020-04627-9

As a rough guide, this overview of tree genera that use ectomycorrhiza can be used: Alnus, Betula, Carpinus, Corylus, Ostrya, Ostryopsis, Cistus, Helianthemum, Acacia, Castanea, Castanopsis, Fagus, Chrysolepis, Lithocarpus, Quercus, Tilia, Eucalyptus, Leptospermum, Nothofagus, Abies, Cedrus, Larix, Picea, Pinus, Pseudolarix, Pseudotsuga, Tsuga, Dryas, Populus, Salix.

According to the determined mycorrhiza type, the product for application is selected.

The products can be in both bulk and liquid form (U.S. Pat. No. 8,883,679B2). All products are applied so that they come into contact with the roots of the tree.

For the purposes of the present invention, amendments in the form of powder are applied to shallow pits formed evenly throughout the root space of the tree, either directly as a powder or after activation in an aqueous solution, often in slurry form. The pits are then covered with soil to the original level.

Liquid products can be applied using a pressurized air injection device (U.S. Pat. Nos. 4,379,679A, 5,868,523A). A probe 1.5-5 cm in diameter and 10-120 cm long in the form of a metal needle with openings for conducting air and liquids into the surrounding area is introduced 1-100 cm from the soil surface. The probe is connected to a source of compressed air, e.g., a compressor, preferably an independent compressor, using an electric, diesel, or petrol generator to apply pressure. The connection is made by means of a pressure control valve in the form of a gun (e.g. U.S. D512122S1). Solution with the mycorrhizal fungi, their spores, auxiliary organisms, and excipients are pumped deep into the roots using a second hose connected to the leachate reservoir.

Further, both powder and liquid formulations can be added to substrates used for habitat enhancement according to the present invention. These include, in particular, substrates for soil exchange in the root zone, substrates used in vertical mulching or radial trenching, and expanding rootable space, e.g., using soil cells.

If the habitat environment is of such a nature that it allows mycorrhizal fungi to colonize the roots and develop, it will usually not be necessary to reapply the amendments. However, it is advantageous to monitor the treated trees and the nature of the soil in the root system and repeat the treatment if necessary.

Application of Preparations with Fungi of the Genus Trichoderma

Low nutrient availability in the soil and disease infestation reduce the tree's ability to generate new biomass.

Since the 1930s, there has been evidence that colonization of roots by fungi of the genus Trichoderma, in particular the species T. asperellum, T. harzianum, T. viride, T. hamatum, and others, contributes to whole plant resistance to pathogenic fungal diseases, including some foliar diseases, and contributes to improved nutrient utilization and increased growth (U.S. Pat. No. 8,877,481B2). The cooperation of fungi and the tree increases nitrogen utilization, leading to reduced need for nitrogen fertilization.

Fungi of the genus Trichoderma are also infrequently used in tree care, especially for supporting important, less vital trees to increase their vitality by colonizing their root system.

Fungi of the genus Trichoderma, e.g., T. atroviride and T. virens, can also be used for antagonistic colonization of tree parts against various fungal pathogens that attack the wood of the tree during branch pruning or mechanical damage to the tree surface, including its roots, where these pathogens cause damage mainly by penetrating the trunk and subsequently forming cavities. By applying to tree pruning wounds, it has been shown that fungi of the genus Trichoderma can prevent such damage and significantly extend the tree's life by suppressing colonization of the pruning wounds by other wood decay fungi. Schubert, Mark & Fink, Siegfried & Schwarze, Francis. (2008). Evaluation of Trichoderma spp. as a biocontrol agent against wood decay fungi in urban trees. Biological Control. 45. 111-123. 10.1016/j.biocontrol.2008.01.001

The application procedure aimed at root colonization consists of mixing the product in water according to the instructions and applying the mixture to the soil surface over the entire area where the tree's root system is expected to be. The application can be carried out by spraying with mechanical or machine sprayers, advantageously by drip irrigation systems, and most advantageously with watering bags for mature trees (CZ33544U1/WO2021027980A1).

For application to pruning wounds, it is advantageous to mix the spores with water in an aqueous solution, more advantageously in an aqueous solution containing nutrients, e.g., glucose, and most advantageously in an aqueous solution containing nutrients, e.g., glucose and a moisture-retaining agent, e.g., sodium polyacrylate. These solutions should then be applied to wounds by brush or mechanical sprayer.

### Expanding Rootable Space Volume Under Structures

The limited volume of rootable space available to trees prevents the tree's growth after filling the rootable space available to the tree and has a number of other adverse effects, including negative effects on the tree's stability. It is one of the stress factors for the tree. It is also often the cause of damage to paved surfaces, such as sidewalks, by tree roots growing through compacted material under the paved structure, lifting it and damaging both the structure itself, as well as its function. Limited rootable space can limit the growth of a tree to 10% of its size compared to the same taxon in its natural habitat.

For the implementation of the present invention, it is desirable that the rootable space is sufficient according to the natural size of an adult of the taxon.

Minimum volume of rootable space per tree size category

| | Minimum volume of | | Minimum open tree pit | |
|---|---|---|---|---|
| Tree size | rootable space | | diameter | |
| Large-crown trees | 25 | m³ | 1.2 | m |
| Medium-crown trees | 16 | m³ | 0.75 | m |
| Small-crown trees | 8 | m³ | 0.5 | m |

[symbol]

[symbol]

et al [symbol] [symbol] [symbol] [symbol] [symbol] standardy. 2020. [symbol] [symbol] [symbol] [symbol] [symbol] v [symbol] [symbol] [symbol] [symbol] a [symbol] ČR. Accessible at https://nature.cz/web/cz/platne-standardy.

If the volume of the rootable space is limited and the root system of the tree is limited by degraded or compacted anthropogenic soil, it is appropriate to expand the rootable space to a desirable level in order to carry out the present invention while at the same time creating optimal conditions for tree growth in such a space. The expansion is done by adding a suitable substrate with a suitable texture and nutrient content, ensuring optimum use of rainwater and other measures.

When expanding the rootable space, we prefer measures that interconnect the root zones of individual trees into planting strips.

If it is impossible to interconnect individual trees by a planting strip, the individual rootable spaces of the planting sites can be interconnected by a root zone bridge.

Rainwater must be brought into the rooting area under the structures by suitable technical measures to ensure the basic life needs of the tree.

A suitable drainage system must protect the rootable space against flooding due to the impermeability of the subsoil.

Structural elements encroaching into the rooting area (root zone bridge foundations, footings of protective grates, and similar) must not prevent rooting into the surrounding soil.

All measures to expand rootable space work effectively when combined with the maximum possible tree pit size.

When implementing measures to expand the rootable space volume of existing trees, non-destructive methods of removing existing soil shall be used in the area of potential rooting.

The roots in the area of the implemented root zone bridges or other parts of the purposefully created rootable space shall not be interrupted or disturbed by excavation activities during the installation of utility networks or similar. When utility lines run parallel to each other, the aim is to prevent such damage, which can be achieved by simultaneously laying reserve protectors or collectors in the area.

[symbol] , [symbol] et al.: [symbol] [symbol] [symbol] [symbol] . [symbol] [symbol] . 2020. [symbol] [symbol] [symbol] , [symbol] [symbol] v [symbol] , [symbol] [symbol] [symbol] a [symbol] ČR. Accessible at https://nature.cz/web/cz/platne-standardy.

The procedure for extending the rootable space volume of a tree starts with marking an area that provides sufficient rootable space and is in the least conflict with surrounding infrastructure such as underground lines, structures, and similar.

If there is a hard surface in this area, it is carefully removed. Non-invasive removal of the existing substrate and other structures shall be carried out. Advantageous, and substantially the only way to do this is to use a stream of compressed air generated by equipment for removing loose materials, e.g., soil, using high-pressure air (e.g. EP0251660A1. AT82027T, U.S. Pat. No. 5,966,847A), also called pneumatic spades with a pressure nozzle (e.g. U.S. Pat. No. 5,782,414A, U.S. D408830S) at the end, operating at a gas pressure of 50-200 psi, more advantageously 80-120 psi, most advantageously 90 psi. The pneumatic spade is connected to a compressed air source, such as a compressor, which is advantageously an independent compressor, using an electric, diesel, or gasoline generator to generate pressure. The connection is made by means of a pressure control valve in the form of a gun (e.g., U.S. D512122S1).

The soil is separated from the tree's roots by a high velocity and pressure air stream and blown away from the work area in one direction. The soil is then removed. In the space thus freed, a rootable space is created by applying a suitable substrate, which is advantageously a structural substrate, where a hard surface (e.g., paving) will be reinstalled on the surface. The structural substrate contains large pieces of inert material, usually aggregate, 5-50 cm in diameter, which provide support against soil re-compaction and create gaps into which the finer substrate material can be incorporated, usually by gradual flushing. This structure creates sufficient space to form new roots and ensures optimum soil gas exchange and water retention. The finer substrate material usually consists of other porous inert materials, e.g., charcoal (biochar), volcanic pumice, and similar, which increase the porosity of the substrate and create a suitable medium for the development of mycorrhizal relationships and colonization by soil micro-organisms. In addition, finer structural substrate material such as compost is added as a source of organic matter and nutrients, as well as a small amount of soil and other components. The hard surface is restored, and it is essential to maintain a free substrate surface below the hard surface. For this purpose, an air gap of 1-10 cm is left under the hardened surface. After about 10 years, it is advantageous to check the nutrient content of the substrate or monitor the trees continuously for symptoms of nutrient deficiency. Supplement these nutrients, preferably in liquid form, advantageously with watering bags for mature trees if necessary.

An advantageous measure for expanding the rootable space volume of a tree for the purpose of the present invention is the use of so-called soil cells (U.S. Pat. Nos. 8,065,831B2, 11,369,065B2, 9,085,887B2, to expand the rootable space for existing trees in areas where a hard surface is required (e.g., roadway, sidewalk). The limited rootable space stops or severely restricts tree growth when the accessible rootable space is filled with tree roots. Supplying additional rootable space using soil cells allows additional growth of tree biomass for the purpose of the present invention, thereby allowing additional carbon sequestration from the atmosphere.

The measure of using soil cells to build additional rootable space for the mature tree is proposed. The hard surface on the surface is removed. The substrate is removed from the area where the tree roots are located using a non-destructive technology, e.g., an air spade with a pressure nozzle. In the area where the tree's roots are not present and into which we want the root system to expand, the excavation is made to a depth of 50-150 cm. Depending on the nature of the habitat, drainage is carried out so that the newly built root space is not permanently flooded with water. The soil cells are then installed according to the manufacturer's instructions. The cells are placed at the bottom of the excavation and filled with substrate. The hard surface is restored; it is important to maintain the free soil surface of the substrate under the hard surface. For this purpose, an air gap of 1-10 cm is left under the reinforced surface.

Measures with the Main Objective of Preserving the Tree

If a tree grows very well and we maximize its ecosystem services through measures to promote sequestration but then has to be removed because of poor operational safety or conflict with new development, all the effort used to maximize the fight against climate change, according to this invention, is lost. Therefore, preserving the tree is highly desirable, and another set of measures serves this purpose. These measures can also contribute to improving the growth and biomass production of the tree.

### Tree Pruning and Stabilization

This set of techniques forms a large part of the entire field of arboriculture, and the individual tasks are performed based on individual tree assessments. The techniques are described in documents called arboricultural standards, which are country-specific and represent a binding or non-binding standard for the care of trees growing outside forests.

An example of such standards is the Czech arboricultural standards available on the AOPK website:
[symbol] : https://nature.cz/documents/20121/1199516/02002_Rez_stromu.pdf
[symbol] [symbol] a [symbol] [symbol] [symbol] https://nature.cz/documents/20121/1199516/02004_ [symbol] _ [symbol] .pdf.
The European Arboricultural Standards, available at http://www.europeanarboriculturalstandards.eu, apply throughout Europe:
European Tree Pruning Standard: http://www.europeanarboriculturalstandards.eu/etps
European Cabling & Bracing Standard: http://www.europeanarboriculturalstandards.eu/etcbs For North American countries or territories that do not have their own standards, these are the ANSI Standards and Best Management Practices documents of the International Society for Arboriculture (ISA Arbor), a US-based NGO.
American National Standards Institute. 2017. American National Standard—Tree, Shrub, and Other Woody Plant Management—Standard Practices (Pruning) (ANSI A300, Part 1). Londonderry (NH, USA): Tree Care Industry Association.
American National Standards Institute. 2018. American National Standard—Tree, Shrub, and Other Woody Plant Management—Standard Practices (Soil Management a. Assessment, b. Modification, c. Fertilization, and d. Drainage) (ANSI A300, Part 2). Manchester (NH, USA): Tree Care Industry Association.
American National Standards Institute. 2013. American National Standard—Tree, Shrub, and Other Woody Plant Management—Standard Practices (Supplemental Support Systems) (ANSI A300, Part 3). Londonderry (NH, USA): Tree Care Industry Association.
American National Standards Institute. 2014. American National Standard—Tree, Shrub, and Other Woody Plant Management—Standard Practices (Lightning Protection Systems) (ANSI A300, Part 4). Londonderry (NH, USA): Tree Care Industry Association.
American National Standards Institute. 2019. American National Standard for Tree Care Operations—Tree, Shrub, and Other Woody Plant Management—Standard Practices (Management of Trees and Shrubs During Site Planning, Site Development, and Construction) (ANSI A300, Part 5). Manchester (NH, USA): Tree Care Industry Association.
American National Standards Institute. 2018. American National Standard—Tree, Shrub, and Other Woody Plant Management—Standard Practices (Planting and Transplanting) (ANSI A300, Part 6). Manchester (NH, USA): Tree Care Industry Association.
American National Standards Institute. 2012. American National Standard for Tree Care Operations: Tree, Shrub, and Other Woody Plant Management—Standard Practices (Integrated Vegetation Management a. Utility Rights-of-Way) (ANSI A300 Part 7). Londonderry (NH, USA): Tree Care Industry Association.
American National Standards Institute. 2017. American National Standard—Tree, Shrub, and Other Woody Plant Management—Standard Practices (Root Management) (ANSI A300, Part 8). Champaign (IL, USA): International Society of Arboriculture.
American National Standards Institute. 2017. American National Standard—Tree, Shrub, and Other Woody Plant Management—Standard Practices (Tree Risk Assessment a. Tree Failure) (ANSI A300, Part 9). Londonderry (NH, USA): Tree Care Industry Association.
American National Standards Institute. 2016. American National Standard—Tree, Shrub, and Other Woody Plant Management—Standard Practices (IPM) (ANSI A300, Part 10). Londonderry (NH, USA): Tree Care Industry Association.
American National Standards Institute. 2017. American National Standard for Arboricultural Operations—Safety Requirements (ANSI Z133-2017). Champaign (IL, USA): International Society of Arboriculture.

For the implementation of the present invention, it must be as likely as possible that the wounds caused by trimming cuts are wholly healed, i.e., covered with new bark. This can be achieved by regularly trimming the tree throughout its life at suitable intervals, not all at once, only at an older age. Wounds from pruning must be as small as possible, namely up to a wound diameter of 5 cm for trees with weak wound healing capacity (compartmentalization) and up to a wound diameter of 10 cm for trees with good wound healing capacity (compartmentalization). Also, cuts must be only made in areas where healing tissues allow wound healing. Healing tissues are not present on branches or trunks near the branch. For the purposes of the invention, tree topping or deep crown reductions are not acceptable unless there is an imminent danger to human health or property on a large scale. Pruning and stabilization should be carried out according to these standards to preserve the tree and, where appropriate, enhance its vitality so that the tree can be preserved for the purpose of storing carbon in the biomass (the quantity C0) and so that it can continue to sequester carbon in subsequent periods t, thus generate C1 and C2.

Tree crown stabilization can be performed by installing dynamic or static cabling, bracing or placing supports (props) on destabilized branches. Several techniques can be used to stabilize tree crowns:
Installation of dynamic cables embracing stabilized stems (branches).
Installation of static cables and straps embracing stabilized stems (branches).
Installation of static cables fixed to elements drilled into stabilized stems (branches).
Direct drilling of destabilized parts of the crown with fixation by rods
Installation of compression belts and perimeter stabilization systems on stems
Placing supports (props) for destabilized branches (propping).

Pruning and stabilization should be carried out according to these standards to prevent tree disintegration and, where appropriate, to enhance tree vitality so that they can be retained for the purpose of storing carbon in biomass (C0) and so that they can continue to sequester carbon in subsequent periods t, generating C1 and C2.

### Special Interventions on Trees

Set S trees must be given the utmost care to ensure that they are not lost or damaged in a way that would significantly slow down biomass growth.

Special interventions pool measures that will be implemented continuously throughout the period t so that potential damage is avoided or its impact minimized.

### Treatment of Mechanical Injuries (Wounds)

Mechanical injury (a wound) to a tree is always an entry point for pests that leads, sooner or later, to damage and death of the tree specimen. They arise, for example, from car accidents, construction activities, or vandalism. For the purposes of the present invention, which aims at preserving a vital tree, it is best to prevent damage to the tree by prevention. If an injury already occurs, the tree must be treated immediately after it occurs. The following procedure is used for injuries to the trunk and the surface of large branches:
The wound must be treated as soon as possible before it dries out. The aim is to prevent the wound from drying out and to prevent light exposure until the wound is fully healed.
If there are remnants of bark left in the wound connected to the surrounding unwounded bark, the remnants of bark will be returned to their original place; the unconnected bark is no longer worth returning to its original place.
The wound is covered with porous material, e.g., moss, clay, and similar. This step is not obligatory; it is no longer the preferred way of wound treatment.
The wound is covered with a dark, airtight foil, and the edges are sealed hermetically. The foil shall be fixed so that it will not be withdrawn or cannot leak for the next 12 months. Advantageously, biodegradable plastic foils and tapes can be used. Transparent stretch cling foil used in logistics or the food industry can also be used for emergency fixing.
After about 4 months, the wound is checked, and if there is no healing wood growing over the wound, the measure has not been successful, and the film must be removed. If the application is correct and the wound starts healing, depending on the size and the tree's vitality, the wound will heal completely in about 12 months. Then, the foil and other materials should be removed.

### Tree Relocation

Suppose a tree should be lost or seriously endangered due to conflict with existing or newly constructed infrastructure (transport, telecommunications, water management, and similar) or buildings. In that case, it is desirable for the purposes of the present invention to move the mature valuable tree to a more suitable site. The same applies to repairing and reconstructing existing infrastructure and any other reason where the tree's very existence and the production of all its ecosystem services could be compromised.

Trees of almost any species can be relocated (replanted) at any age with a relatively high probability of long-term survival. However, the protection of the tree and biodiversity must always be taken into account, and the transplanting must be carried out so that the tree is not damaged or protected species of animals and plants are endangered. For the purpose of the present invention, it is advantageous if the tree is transplanted to a habitat that is not too distant from the original habitat, in particular, to minimize the carbon footprint generated by the transplanting and the subsequent care. The tree is also better able to re-establish, or thrive, in the environment to which it is adapted, whereas, in a different microclimate, e.g., when moving from a humid oceanic climate to a Mediterranean climate, there is a high probability that the tree will not thrive in the new site despite all the care it has received. For the purpose of the present invention, it is suitable to move the tree to a habitat a maximum distance of 500 km, more suitable to a distance of 200-400 km, even more, suitable 20-200 km, and most suitable 0-20 km from the original habitat. Preferably, the nature of the new habitat should not differ significantly from the nature of the original habitat.

The replanting procedure consists of preparing a project that presents a planned procedure for how the replanting will be carried out and how the tree will be cared for after the relocation. It is possible to transplant trees immediately without preparing them for transplanting, but it is preferable to prepare them for transplanting at least one season before moving; larger trees, ideally two seasons before moving. Preparation consists of crown reduction and root severing at the planned edge of the root ball for the relocation.

Optimally, the crown is reduced during the dormant season by removing about 25% of the assimilatory apparatus. Branches protruding from the habit are cut back, and crown thinning is performed. The terminal shoot is not reduced. The boundary of the root ball, which will remain with the tree when it is relocated, is marked out around the tree, and a trench approximately 1 m deep is made on the outside of the boundary. The roots on the border are cut smooth with a sharp tool. It is advisable to divide the trench excavation into two years, with 50% of the planned trench being created each year. After excavation and root cutting, the trench is backfilled with a good-quality horticultural substrate. During the growing season before transplanting, it is advantageous to ensure optimum conditions for maintaining the vitality of the tree, in particular sufficient water, preferably by using bags for watering of mature trees (CZ33544U1/WO2021027980A1).

The relocation of the tree takes place preferably during the dormant season. Just beyond the boundary of the trench made and backfilled in the preparatory phase, an excavation is again made to a depth of about 1 m, and the root ball is separated from the parent ground so that the root ball is at least 70 cm deep, preferably more. The separation is carried out, for example, by hammering steel pipes horizontally across the entire area at the required depth to separate the root ball from the substrate below. Undercutting, e.g., with a steel rope, can be used to separate the remaining roots going to depth.

The entire edge of the root ball is secured with suitable material, e.g., tarpaulins and wire mesh, or, e.g., matting or encasing the perimeter with a layer of woven natural material. The tree is lifted by the ball using a lifting structure of pipes located underneath it. The tree is advantageously secured by a crane with a rope or strap encircling the trunk, but this securing may not be used for the actual lifting or handling of the tree.

The tree is moved to a new site, where a planting pit that is large enough to accommodate the root ball and the moving structure must be prepared, and the structure can then be removed at the end. It is necessary to ensure that the root ball is adequately moist during the transfer and to prevent damage to any part of the tree.

The tree is anchored against movement or uprooting by anchoring, advantageously by a combination of underground and above-ground anchoring, and the tree pit is backfilled with a suitable substrate. Structural substrates may also be used, as well as soil cells in the case of the need to build a hard surface (e.g., pavement or road) near the transplanted tree.

Aftercare must create ideal conditions for establishing the tree and its growth. Watering must be provided, preferably by drip irrigation, most preferably by using bags for watering mature trees (CZ33544U1/WO2021027980A1), with emphasis on a design that ensures good rooting of the tree, including root extension in the direction from the trunk into the new substrate, and thus future stability and drought resistance of the tree.

### Protection Against Harmful Organisms Through the Use of Plant Protection Products

Infestation by harmful organisms, such as insect pests, fungal diseases, bacterial diseases, and similar, can lead to a decrease in the tree's ability to sequester carbon from the atmosphere, resulting in a decrease in C1 and C2 values. It can also lead to the gradual death of the tree, either by the pest itself or by the owner's decision to cut the tree down based on the presence of the pest, as its operational safety is compromised. If the tree is felled, the C0 value is lost both for the purpose of the invention and for climate protection, and the carbon is subsequently mostly released into the atmosphere. Now, protection with plant protection products is used as a preventive or curative intervention to protect the tree itself, not as a targeted protection of its value and potential to combat climate change.

For the purposes of the present invention, it is advantageous that the occurrence of harmful organisms is minimized, provided that this does not conflict with the requirements for protecting protected species of animals and plants or human health.

Suppose the tree manager or owner of the Set S trees has noticed visible changes in growth, signs of pest infestation such as changes in leaf color, feeding on or dropping leaves of needles, increased incidence of insects that may be harmful, and similar phenomenon, or even suspects that this may be the case or will be the case in the near future. In that case, it is best to contact a qualified person educated in plant phytopathology. This person will determine whether the tree is infested with a pest, what type of pest is infesting the tree, and whether the extent of the infestation may threaten the tree or significantly reduce its carbon sequestration. Based on an on-site assessment of the tree or analysis of samples taken in the laboratory, he or she shall determine the method of protection of the tree, the active substance, the dosage, the timing of application, and the method of application. The phytopathologist also knows the forecasts and trends in the incidences of harmful organisms in the region and can recommend preventive action, which is most advantageous for the purpose of the invention.

Chemical or other plant protection products are applied to trees by spraying, mist spraying, or fogging. The application is carried out by hand sprayers, mechanical pressure sprayers, motorized or pressure sprayers with compressors, mist sprayers, and other devices designed for this purpose.

Before application, the active ingredient is usually dissolved in a solvent, usually water, to which a wetting agent is often added to reduce the surface tension of liquids and solid surfaces and thus facilitate the application of the active ingredient solution to trees. It is common for individual active substances if more than one is required, to be mixed in a single application.

The mixture is poured into a tank and applied to the leaves, needles, the surface of the trunk and branches, or the ground surface under and around the tree.

Chemical or other plant protection products are also applied to trees by injection, which has the advantage that the active substance is injected directly into the tree, and there is no risk of leakage or drift into the surroundings, thus not endangering the health of people, animals or plants in the vicinity.

In this case, plant protection products are applied using so-called injectors (FIG. 5c) (e.g., JP6538749B2, U.S. Pat. No. 1,756,453A), i.e., devices for delivering the active substance solution to the tree trunk. The active substance is then distributed to all the tissues of the tree using the tree's lymphatic stream. The injections are categorized according to the pressure under which the liquid is delivered to the tree. High-pressure injections with application pressures of 60-100 psi use pressurized plastic plugs inserted into a pre-drilled hole in the trunk to tightly seal the space between the wood and the application needle. Injections with lower application pressures are applied directly into simple holes drilled into the tree trunk.

The active substance is filled into the injector reservoir. Holes are drilled into the tree trunk around its circumference, usually at the base of the trunk or, less frequently, at other heights from the base of the trunk to 200 cm from the ground, 2-30 cm apart, with a diameter sufficient to allow the insertion of an application plug or application needle. In the case of high-pressure injection, the high-pressure injection application plug is hammered into the trunk. Next, the solution with the active substance is injected through this hole/plug using pressure. The plugs are left in the wood after application; the application of high-pressure injection ends with filling all plugs inserted in the trunk; the plugs are left in the trunk, where they are covered with new bark and wood over time. Lower pressure injection applications end after filling all holes in the trunk and left open, healing over time.

If the pest pressure in the region persists, it is advisable to repeat the injections after a certain period, as the active substance levels in the tree tissues decrease over time. The interval of repetition should be considered according to the type of pest, the size of the tree, the dose injected, and other circumstances. The repeat interval is usually set at 1-5 years, more advantageously, 2-4 years. For example, the recommended treatment interval for ash trees when threatened or infected with ash borer (Agrilus planipennis), in the case of high-pressure injections applying emamectin benzoate or imidacloprid, is 2 years.

### Management of Hemiparasitic Shrubs

For the purpose of the present invention, hemiparasitic shrubs are plants that colonize trees, reducing their vigor and causing a decrease in biomass growth relative to the potential growth that would occur if the tree were not infested by the hemiparasitic shrub.

hemiparasitic shrubs include plants such as:
Family Loranthaceae (especially genus Loranthus)
Family Santalaceae (especially genus Viscum—mistletoe, genus Arceuthobium—dwarf mistletoe)

Hemiparasitic shrubs damage trees by extracting water and minerals from the transpiration flow of the host tree. Hemiparasitic shrubs are capable of independent photosynthesis because they have green leaves. These usually have a higher transpiration rate than the assimilation apparatus of the host tree, which causes water to be taken from the tree even when the water balance is in depression. This causes drought stress, which the tree cannot compensate for long term. This reduces the tree's ability to create biomass and sequester carbon from the atmosphere, and overall, it reduces the ecosystem services provided by the tree.

Remediation consists of actions aimed at reducing the incidence and activity of hemiparasitic shrubs on the Set S trees, advantageously removing them completely from their hosts and preventing their further spread to other trees.

Two methods can be used for this purpose. The first method involves mechanically removing the hemiparasitic shrubs from the host tree. The part of the branch on which the bush is located is cut off, or the bush is broken off. This method is only partially effective; part of the shrubs regrow, and the procedure has to be repeated. The method also has its limitations. This procedure is only suitable for trees that are not heavily infested and can only be used on smaller-diameter branches. Breaking the bushes on the main skeletal branches and trunk will not completely remove the bush so that regeneration will occur over several years.

The second method is chemical spraying the hemiparasitic shrub with a suitable biological or chemical agent to inhibit the growth or total elimination of the pest.

For the control of white mistletoe (Viscum album) and dwarf mistletoe (Arceuthobium spp.), spraying mistletoe bushes with a solution of the active substance ethephon during the dormant period of the host trees at temperatures above 4° C. (CZ32841U1).

For the eradication of white mistletoe (Viscum album), infestation by the fungus Phaeobotryosphaeria visci.

### Management of Lianas

Liana is a climbing plant with a woody stem. It roots in the ground and uses the trunk of the tree as a support for its stem. Examples for the purpose of this invention from the region of Central Europe include the ivy (Hedera helix), the honeysuckle (Lonicera periclymenum), the climbing ivy (Parthenocissus inserta, syn. Parthenocissus vitacea), the bittersweet (Celastrus scandens) or the five-leaved ivy (Parthenocissus quinquefolia).

Some lianas reduce carbon sequestration in trees by shading their assimilatory apparatus (leaves, needles) or their growth strangling the tree's trunk or branches, thus limiting the sap flow and weakening the structural strength of the main parts of the tree. Their weight can cause branches to break. They can also be a significant competitor for the tree regarding access to water and nutrients. This phenomenon is described in great detail in the scientific literature and concerns not only trees growing in temperate but also subtropical and tropical climates, where it very significantly reduces all aspects of ecosystem services: Estrada-Villegas Sergio, Pedraza Narvaez Sara Sofia, Sanchez Adriana, Schnitzer Stefan A. Lianas Significantly ReduceTree Performance and Biomass Accumulation Across Tropical Forests: A Global Meta-Analysis. Frontiers in Forests and Global Change, Volume April 2022. https://www.frontiersin.org/articles/10.3389/ffgc.2021.812066, DOI: 10.3389/ffgc.2021.812066, ISSN=2624-893X

For the purpose of the present invention, it is therefore desirable, unless it is contrary to the protection of biodiversity, to remove lianas from trees. The removal must be carried out in such a way that the tree is not damaged in any way, i.e., damage to the bark, trunk, branches, assimilatory apparatus, or roots, e.g., by machinery.

The lianas are removed in two ways, either by hand saws or with chainsaws: either they are cut at the ground and torn off the tree, or a strip of 10-20 cm of all stems is cut at the ground and the liana is left on the tree. The stem cuts towards the ground can be treated against further growth with chemical products such as fluroxypyr and triclopyr.

Tearing down of lianas is not permitted, if birds are nesting in the tree at the time or if it would otherwise endanger the existence of protected species.

Tree Growth Retarding with Growth Regulators

For the purposes of the present invention, it is necessary for the tree to both remain standing alive in its habitat (providing storage of stored carbon C0) and continue growing (sequestering carbon C1 and C2). If the tree potentially conflicts with obstructions (traffic and other underground and aboveground infrastructure), including buildings, or there is pressure from public opinion or any other reason to remove the tree, for example, simply because it will shade the windows of adjacent buildings in the future, a possible solution for the purposes of the present invention is to stop or retard the tree's growth. While this will not maximize the ecosystem services of the tree (dropping the C1 and C2 values up to 0), at least the tree (and the C0 value) and its standard or minimized ecosystem services will be maintained.

To retard tree growth, applications of growth inhibitors are used, especially those based on the active substance paclobutrazol. The active substance is diluted so that the application solution contains 0.1%-0.3% of the active substance. This diluted application solution shall be applied in a quantity corresponding to 40-200 ml for every 25 mm diameter of the tree trunk to which the application is made. The application of the inhibitor is carried out in one of two possible ways. Either a trench 5-12 cm deep and 5-15 cm wide is dug by hand just around the trunk. The inhibitor solution is applied by simply pouring it into the trench or from a hose connected to a reservoir of inhibitor liquid in the case of larger applications on more than one tree. Alternatively, the solution is injected with an injector (U.S. Pat. Nos. 4,379,679A, 5,868,523A) into the soil near the tree trunk, as described in the section on Depth soil injecting. Care should always be taken to ensure that neither the trunk nor the roots of the tree are damaged. In the case of growth regulator application, injection shall only be made to a depth of approximately 10-20 cm. The dose, calculated according to the trunk's diameter, is injected evenly around the trunk's circumference, close to the trunk, at 10-50 cm intervals.

The repetition frequency of such treatment depends mainly on the climate in the treated area and ranges from once a year to once every 4 years. Generally speaking, the longer the tree growing season, the shorter the dormancy period, the more frequently the trees must be treated. Conversely, if the growing season is short, the time required for repeat applications to achieve growth retardation may be longer.

### Validation and Reckoning

FIG. 10 describes the steps of the last phase of an embodiment cycle of the invention, which runs for period t. The last phase takes place at moment T1.

At moment T1, inventory of trees, particularly of the Set S trees, advantageously all trees in the territory, is performed again. The inventory of the Set S trees is needed to close one cycle of embodiment of the invention, running for period t, from moment T0 to moment T1. The inventory of all the trees will provide the basis for the next cycle of the invention in the period T1-T2. However, since not all trees were part of the Set S of the cycle at the period T0-T1, e.g., because of smaller trunk diameter, it is advantageous to perform inventory on all trees, some of which will be newly included in the new Set S, e.g., because their trunk diameter has increased so that they meet the criteria for inclusion to Set S. Again, we need at least the following data:
Taxon (species) of tree.
Location of the tree, ideally in geographical coordinates.
The height of the tree, ideally to the nearest mm or similar length equivalent in local units.
Tree diameter at breast height (DBH), ideally to the nearest mm or similar length equivalent in local units
Advantageously, tree health assessment
Advantageously, tree stability assessment
Advantageously, tree vitality assessment

We will perform a volumetric analysis of above- and below-ground tree biomass to determine the mass of carbon stored in the trees. For this, it is advantageous to use the state of the art, e.g., the certified methodology of Zemek et al. (2021). Hodnocení ekosystémových služeb veřejné sídelní zeleně. Ústav výzkumu globální změny AV ČR, v.v.i. ISBN 978-80-87902-31-8. or from abroad, e.g., i-Tree tools www.itreetools.org.

Advantageously, both biomass volume and mass of stored carbon are determined using the same methodology as the previous measurement. In this way, data consistency for the assessment of results is achieved.

Quantification at period T1 yields information about the mass of carbon stored in the tree biomass, denoted as C0(T1). Advantageously, the quantification is done to the level of individual trees for the following reasons:
Carbon credits are sold separately as C0, C1, and C2, or K0, K1, and K2, respectively, and their reversal pools are separated similarly. If the entire tree is lost during period t, we must subtract the C0 values corresponding to that particular lost tree. In the same way, we will quantify the mass of carbon C2, which again corresponds to one individual from Set S.
Credits are localized, based on a specific place, street, city, and similar. Without data on the individual tree level, we could not localize credits in the next period.
By comparing the data from the new measurement at the moment T1 with the data from the measurement at the moment T0, we define the trees that have disappeared during period t. If this has happened, we need to determine whether their removal was avoidable or unavoidable. In the case of avoidable demises, credits K0 and K1 will be withdrawn from circulation, and if they have already been sold, their value will be compensated to the buyer. If losses cannot be avoided, the losses will be deducted from the reversal pools established in the first phase of the process.

Next, a comparison will be made for each tree in the inventory, and the C2 carbon mass will be calculated using the formula:

$$C {2}_{( T 1 ) =} {C}_{0 ( T 1 ) -} {C}_{0 ( T 0 ) -} C {1}_{( T 0 )}$$

The mass of carbon in metric tonnes of C2 will be converted to CO2 equivalent in metric tonnes using the coefficient k, i.e., 3.664. For every 1 metric tonne of CO2, one K2 credit will be issued, which can be sold on the carbon credit market.

If surplus K0 and K1 credits remain in the tree reversal pools of one particular tree owner or manager after these two operations, they are also released for sale on the carbon credit market.

### BRIEF DESCRIPTION OF THE DRAWINGS

The present invention will hereinafter be described in conjunction with the appended drawing figures, wherein like reference numerals denote like elements, and:

FIG. 1 shows the basic steps of the basic embodiment of the invention running from moment T0 to moment T1, for period t;

FIG. 2 illustrates the basic steps of the basic embodiment of the invention, supplemented by advantageous intermediate steps;

FIG. 3 illustrates in detail the second step of the Selection of the basic embodiment of the invention, including the temporal sequence and advantageous connection to a tree inventory system, advantageously in a GIS, and the indication of moment T0, which, in this case, was chosen at the time when the biomass calculation of the Set S trees takes place. It also includes further advantageous steps which, after converting the carbon mass C0 and C1 to CO2 mass equivalent using the coefficient k, lead to the quantification of carbon credits K0 and K1, advantageously localized credits, related to a single tree in a defined location, with the possibility of combining and aggregating them into larger groups according to trees located in a specific territory, e.g., one street or one neighborhood. In addition to storing the data in a tree inventory system, carbon credits are offered on the market. It also includes displaying advantageous definition of supporting measures already within the tree inventory process;

FIG. 4 shows examples of the most common measures that can be advantageously implemented and optimized at period t to maximize ecosystem services, including carbon sequestration of Set S trees. These consist of both measures that prevent damage or removal of the tree, but also measures of a technical nature, which are nowadays proposed in contemporary practice and implemented randomly and to a minimal extent, but only in order to maintain the safety or, at best, increase the vitality of the trees. In the context of the invention, they are newly used to maximize the ecosystem services of trees, including maximizing carbon sequestration, in this case, at period t. For the purposes of the present invention, it is not necessary that all of the measures take place on every Set S tree, nor need any of them take place if the tree as such is preserved, in which case the value of C2 will be close to zero;

FIG. 5 illustrates the basic step of Implementing Supporting Measures of a basic embodiment of the invention, which proceeds up to moment T1 when a new tree inventory is made, supplemented by advantageous intermediate steps including the temporal sequence and connection to a tree inventory system, advantageously a GIS. It also includes a method for calculating the mass of C2(T1) from the measured mass of C0(T1). It also comprises further advantageous steps according to the present invention to quantify the amount of carbon credits K2 after converting the mass of carbon C2(T1) to CO2 equivalent. It also shows a method of reckoning for the reversal pools of credits K0 and K1 quantified at moment T0, where in the event of a negative balance, the negative balance must be addressed, e.g., by returning the money generated on the credits to the buyer, or in some other manner, and also further steps in the event that the balance of K0 and K1 is positive, i.e., they can be sold on the carbon credit market;

FIG. 6 illustrates the basic steps of a variant embodiment of the invention, which proceeds in three steps from moment T0 to moment T1, for period t, wherein the Implementation step advantageously includes implementing technical measures to maximize ecosystem services of trees, including carbon storage and sequestration;

FIG. 7 illustrates in detail the second step, Selection and Quantification of a variant embodiment of the invention, including the temporal sequence and the designation of the moment T0, which in this case was chosen at the moment of the tree inventory process. It also includes further advantageous steps which, after converting the carbon masses C0 and C1 to CO2 masses equivalents using the coefficient k, lead to the quantification of carbon credits K0 and K1, advantageously localized credits, related to a single tree in a defined location, with the possibility of combining and aggregating them into larger groups according to trees located in a specific territory, e.g., one street or one neighborhood. Credits are offered on the carbon credit market. It also includes the display of a definition of supporting measures advantageously already in the tree inventory process; supporting measures are adopted in the Implementation phase of this embodiment;

FIG. 8 illustrates the sub-steps of the third phase of the variant embodiment of the invention, which runs for most of period t up to moment T1. It advantageously consists of three sub-steps, where the Publication, throughout period t, gives the public the opportunity to find out what trees are included in Set S, what benefits they provide, and similar information, and advantageously also whether credits K0 and K1 for these trees are for sale, or who bought them if the buyer wants to disclose this information. It also includes the step Periodic monitoring when the trees are checked during period t, in particular, whether they are still alive in place, advantageously also how they are thriving and how their biomass is increasing, most advantageously how they are thriving and their biomass is increasing depending on the overall conditions at period t, most advantageously including the response of the trees to the measures being implemented. Monitoring may also advantageously include monitoring measurements of tree growth conditions, such as soil moisture or sap flow, so that changes or adverse conditions can be proactively responded to to prevent damage to the tree or limit its growth. It also provides examples of the most common measures that can be advantageously implemented and optimized at period t to maximize carbon sequestration in Set S trees. They consist of measures divided into those more likely to contribute to tree conservation and those more likely to promote carbon sequestration. These technical measures are today, in contemporary practice, proposed and implemented randomly and to a minimal extent, but only to maintain safety or, at best, increase tree vitality. In the context of the invention, the measures are newly used to maximize ecosystem services of trees, including maximizing carbon sequestration, in this case, at period t. For the purposes of the present invention, it is not necessary that all measures be carried out on every Set S tree, nor need any of them be carried out if the tree itself is conserved, in which case the value of C2 will be close to zero;

FIG. 8a shows basic facts about the biology of most trees from aspects that are particularly relevant to the watering of mature trees. It defines what a tree's canopy dripline is and where it is located. It describes how different types of roots are typically distributed, where roots called feeder roots are essential for successful irrigation, one of the most effective habitat improvement measures to maximize carbon sequestration by the tree. These are typically located at and behind the tree's canopy dripline and are, for the most part, distributed to a depth of typically 40 cm;

FIG. 8b demonstrates a typical ideal watering zone for tree watering, located at and behind the tree's canopy drip line. Watering in this zone is safe for the tree, promoting not only its growth but also its safety and long-term prospects, especially by expanding or at least not reducing the size of the tree's root system. This makes the tree more resistant to drought and uprooting;

FIG. 8c demonstrates the possible harmful effect of watering and its consequences for a mature tree. Frequent watering, watering only in dry and hot weather, and watering only to the trunk or under the crown have adverse effects on the size and location of the root system, even if only one of these three negative ways of watering occurs alone. The figure demonstrates how the root system can shrink and deform over a short period as the tree's roots, especially the feeder roots, grow where water and nutrients are available. After three to five years, most of the large support roots can demise, and the tree becomes unstable, i.e., it can uproot and cause damage to health or property;

FIG. 8d shows one of the theoretical bases for the claims made in FIGS. 8a to 8c, where it is confirmed that deformation of the root system of a tree can occur very frequently based on measurements of the life span of the fine roots. At the same time, however, this figure demonstrates how quickly trees can respond to technical measures, such as those shown in FIG. 4, whereby it is possible to initiate, essentially within one year, increased tree growth and thus increased carbon sequestration and production of other ecosystem services that are the purpose of the present invention;

FIG. 8e shows the difference in efficiency between drip irrigation, in this case a watering bag specifically designed to water mature trees, versus watering a tree with a hose, which is less efficient. In the case of drip irrigation, the water is absorbed to the required depth, whereas in the case of hose irrigation, it remains on the surface, evaporates and runs off the root system, especially since most large trees have a raised area at the base of the trunk caused by the growth of large roots;

FIG. 9 shows the process and options for applying fertilizers and habitat soil amendments. Advantageously, this application is carried out based on a soil analysis according to the present invention, whereby only the necessary nutrients are applied in the optimum amount, thus optimizing this measure. The soil analysis may also show us that no improvement is needed. The figure demonstrates the importance of optimizing the soil reaction (pH), where optimization alone can significantly improve the availability of nutrients to the tree, thereby improving its growth and greater carbon sequestration. A specific position is occupied by humides and their derivatives, which, according to the latest knowledge, reduce or increase soil pH towards neutral values. Advantageously, with the application of mycorrhizal products, the availability of nutrients to the tree is increased, and there is no need to apply additional synthetic fertilizers and other products containing soil amendments that generate a large carbon footprint during their production and transport. This is one way of optimizing the implementation of the technical measures according to the present invention. The amount of fertilizers and other substances can also be determined and optimized according to the type of soil determined since different soils react, absorb, store, and release nutrients with different intensities, and by reducing the amount of fertilizer needed to be supplied, the measures will again be optimized.

FIG. 10 describes the steps of the last phase of an embodiment cycle of the invention, which runs for period t. The last phase takes place at moment T1.

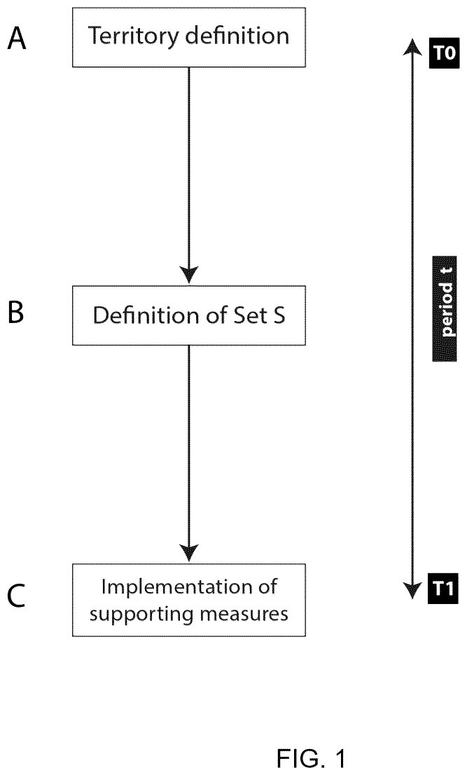

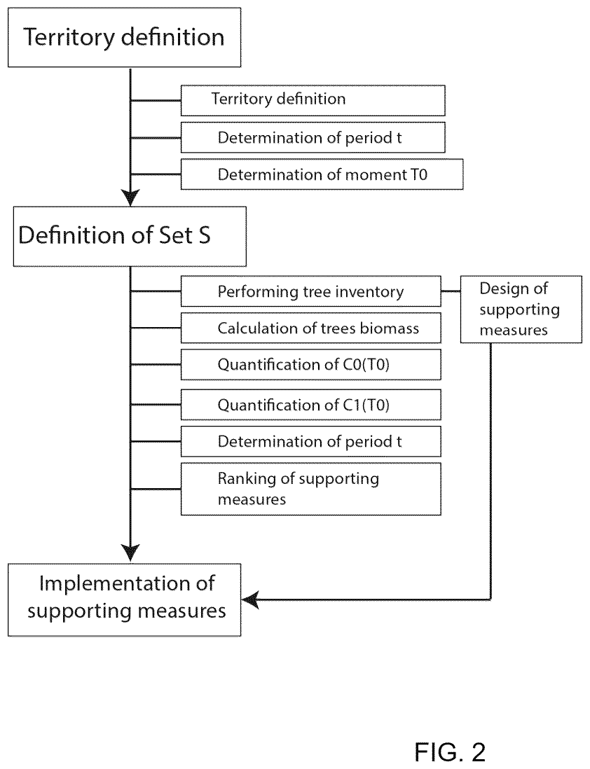

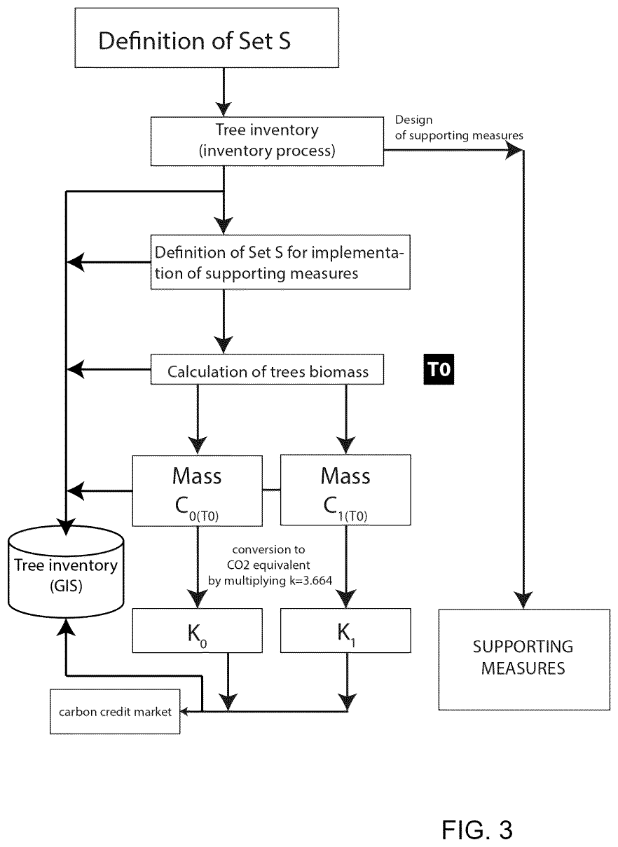

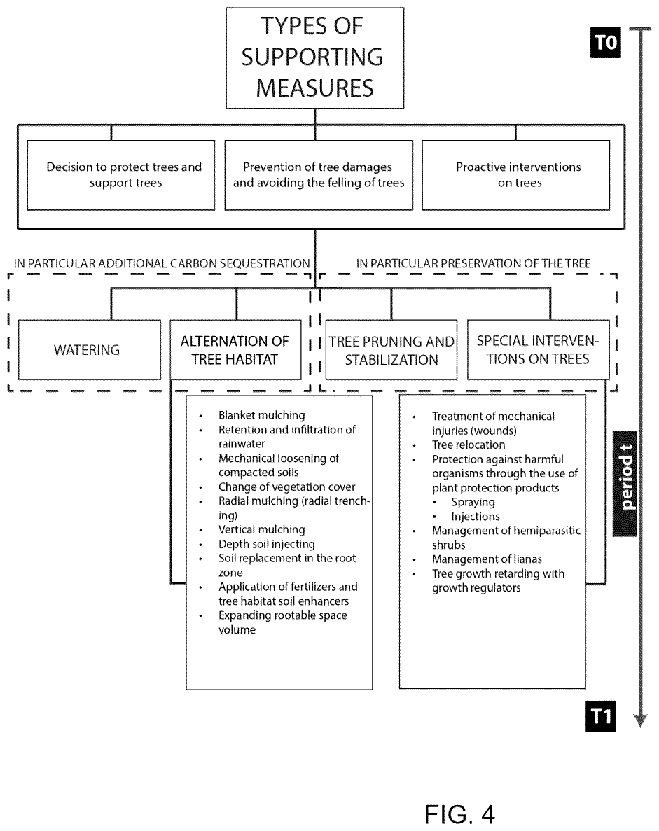

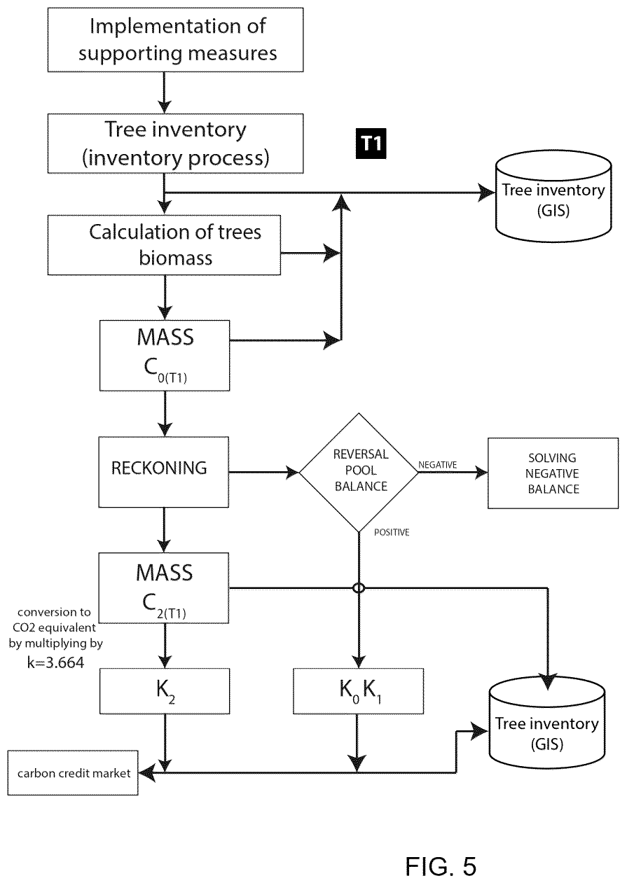

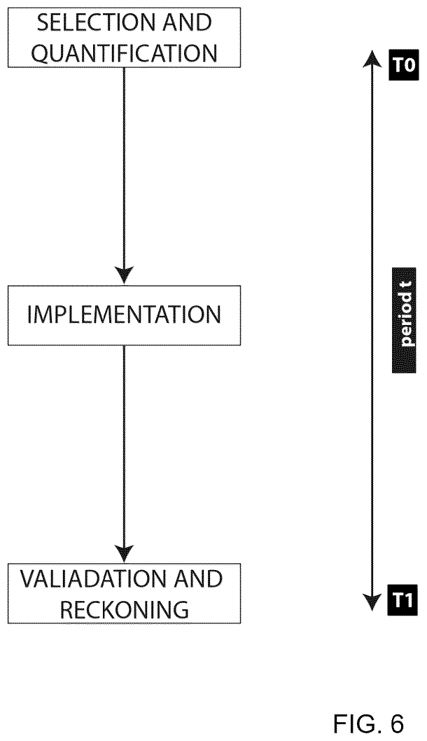

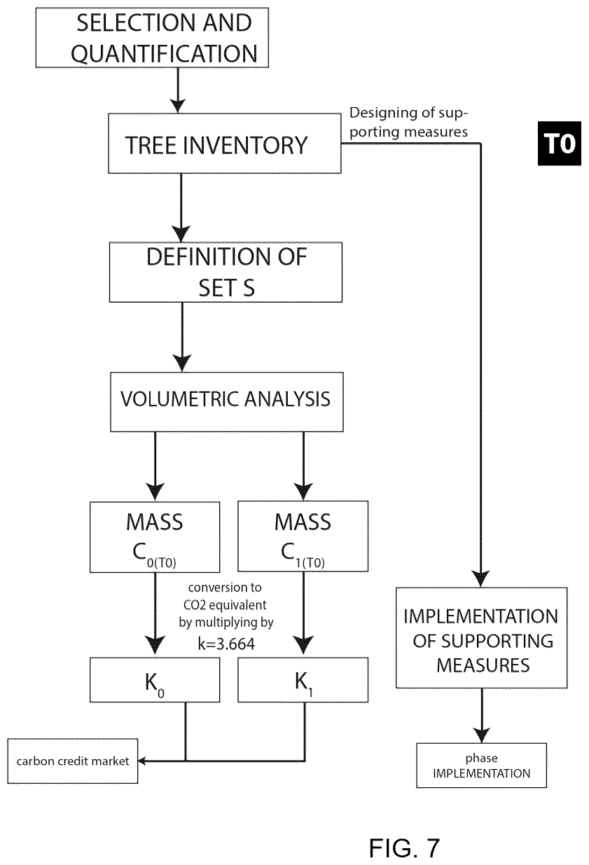

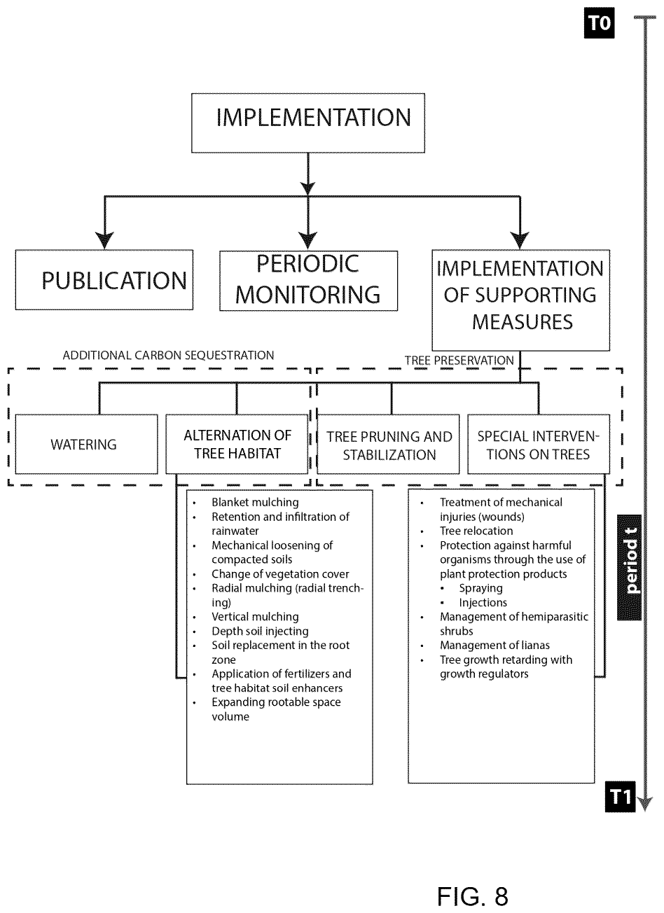

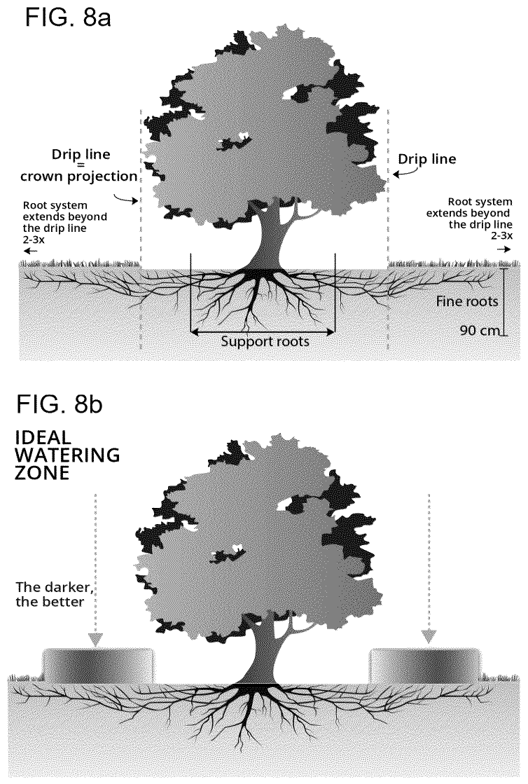

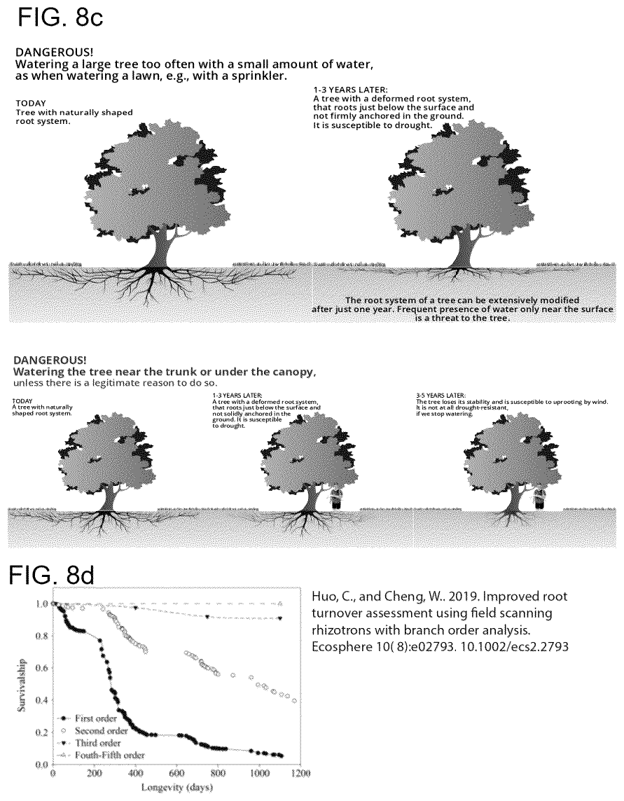

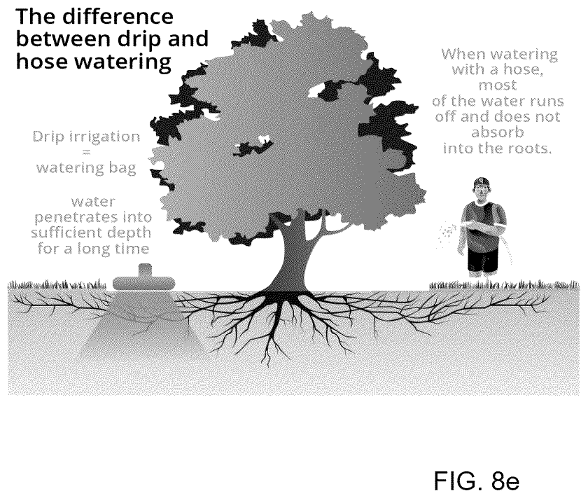

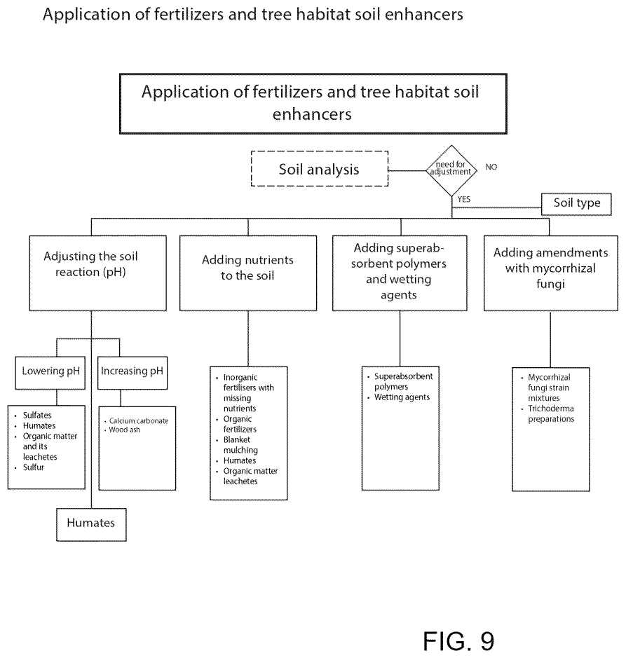

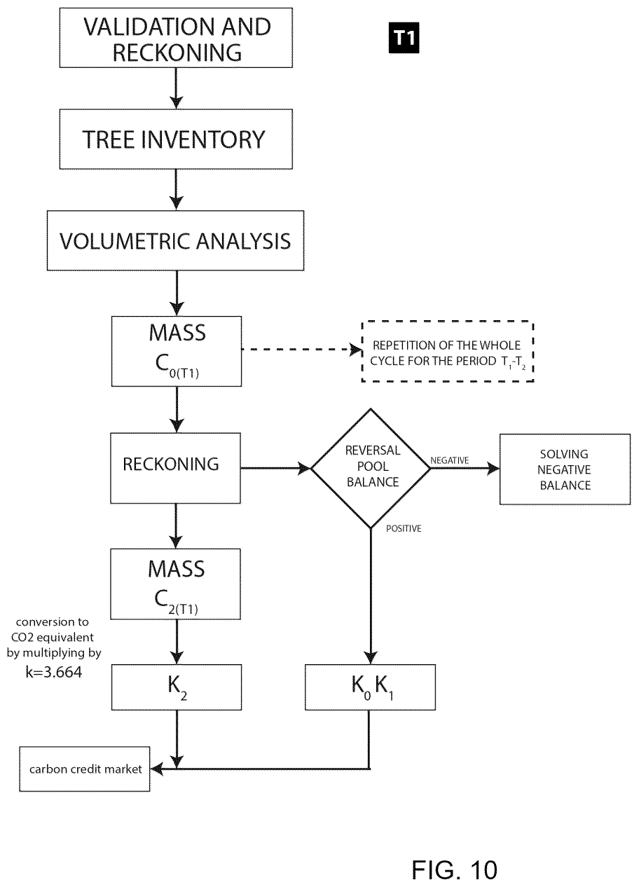

### DETAILED DESCRIPTION

The ensuing detailed description provides exemplary embodiments only, and is not intended to limit the scope, applicability, or configuration of the invention. Rather, the ensuing detailed description of the exemplary embodiments will provide those skilled in the art with an enabling description for implementing an embodiment of the invention. It should be understood that various changes may be made in the function and arrangement of elements without departing from the spirit and scope of the invention as set forth in the appended claims.

### EXAMPLES OF EMBODIMENTS OF THE INVENTION

### Example 1

In this embodiment of the invention, we assume that there is an owner of multiple trees, e.g., a city.

The local government of the city (hereafter referred to as the City) wants to actively fight climate change by reducing CO2 in the atmosphere and is interested in improving the lives of its residents by maximizing the ecosystem services of trees. The planning, implementation, and evaluation of maximizing tree ecosystem services is called the Project. The City has 100,000 trees on its property, located throughout the City.

The period t is defined as the period of 5 years from the moment when the values of C0 and C1 masses are calculated on Set S trees. The moment T0 is defined as the moment when the values of C0 and C1 masses are calculated on Set S trees.

It is resolved that as a reinforcement of the overall Project, a new local tree preservation legislation is adopted because the City recognizes that by applying this invention, each tree is an asset that is not only critical to the success of its efforts but also to the lives of the citizens of the City and the planet. The new legislation includes a tightening of the granting of tree removal permits so that felling becomes exceptional, strict compensation for mature tree removals, strict protection of trees during construction activity according to the applicable standards in the territory, and its control by the City's controlling authority. The legislation includes an obligation to prefer a large tree and replant it instead of cutting it down. Because the calculations presented in this invention indicate that it is not sufficient to plant one large tree to replace one felled tree, the legislation includes a requirement that compensation for the felling of a mature tree by planting shall not be compensated on a 1:1 basis, i.e., one felled tree for one planted tree, but compensation shall be based on an offset of the annual carbon sequestration that is determined for that particular tree within the C1 value and stored in the GIS. This compensation concept means that if the tree to be felled has a sequestration calculated for period t that is equivalent to 20 new trees, then 20 new trees must be planted, but if the annual potential of the tree is equivalent to 200 trees, then 200 trees must be planted. The legislation also includes an obligation for all staff involved in the Project to receive ongoing training in urban tree care so that they can perform their work on the Project to the highest standard according to the latest scientific knowledge. The legislation also includes an obligation for the City to inform citizens and other entities operating within the City that the Project is underway, that protecting trees and maximizing their ecosystem services is critical to their future, and to invite cooperation. This new legislation is an example of the chosen approach of preventing tree damage and avoiding tree cutting as an optimization step to reduce the overall cost of maximizing ecosystem services of trees on City property.

An inventory of green spaces is carried out. As part of the inventory, all trees are mapped to create a tree inventory maintained in GIS. Data obtained in the past can also be used in this step as long as their structure and completeness meet the minimum requirements for a proper inventory within the Project. The inventory includes, among other things, the tree taxon, tree location in geographical coordinates, tree height, and tree diameter (DBH) and advantageously assesses tree quality parameters such as health, stability, and vitality. Advantageously, the inventory already identifies the individual management measures that should be applied to each tree to maximize the production of ecosystem services, including carbon sequestration, while maintaining the safety and long-term perspective of the tree. This usually requires a person qualified in arboriculture or urban forestry. Advantageously, a sufficient number of soil analyses are carried out in the vicinity of large trees as part of the inventory so that the right mix of fertilizers and other soil-improving products can be set up on the site when technical measures are implemented.

A set of trees S is selected from all mapped trees. These are the trees that have the greatest potential to provide a large volume of ecosystem services, including carbon sequestration, and thus, the application of the invention will be most effective. The following criteria are chosen to define the Set S:
DBH of tree 25 cm and more
Health, stability, and vitality assessment results in grades 1-3 (rated on a five-point scale, where 1 is the best and 5 is the worst rating).
Biomechanical analysis 100%
Invasive tree species excluded.
Excludes trees where the owner is not fully known.

Of all the trees in the city, 30,000 trees fit the criteria, which is how Set S was defined. We know the location of the trees because their detailed coordinates are entered into the map in GIS, which is used for keeping results of the tree inventory, and we know what to do with the trees to maximize ecosystem services of trees. It has to be said that, apart from emergency pruning of dead branches, there are usually no other supporting measures implemented on trees typically belonging to Set S. In contrast, in implementing the present invention, supporting measures are intentionally adopted because, based on scientific knowledge, the Set S trees have the potential to achieve the best effort (cost) to performance ratio towards climate change mitigation of all trees in the city.

It was decided that in order to monitor the effectiveness of the measures in the next phase of the Project and to adjust their application if necessary, dendrometers are installed on 50 Set S trees, advantageously on all Set S trees, advantageously connected to the city's LPWAN or LPWA or similar data transmission network. The dendrometers will be placed on the trees for three reasons:
for accurate monitoring of tree trunk growth
for evaluation of responses to technical measures implemented for maximizing the production of ecosystem services
for early detection of drought stress by monitoring fluctuations in the water potential of the stem.

To assess the effectiveness of the measures, sensors for measuring the sap flow are installed on 50, advantageously 100, selected trees of Set S, advantageously connected to the City LPWAN, LPWA, or similar data transmission network.

Soil moisture sensors are also deployed throughout the City, at 30 and 60 cm depths, advantageously connected to the City LPWAN, LPWA, or similar data transmission network.

It was decided that the data from all sensors would be sent to one central database, preferably a GIS, where the inventory of trees is kept so that it can be continuously evaluated.

It was decided that the overall vegetation condition, including early drought monitoring, would be cross-monitored and evaluated using spectral reflectance within the Sentinel satellite network and compared with dendrometer drought-indicating data.

For all Set S trees, advantageously for all trees in the City, the tree biomass is calculated according to the allometric equations relevant to each tree species, the carbon stored (C_{0(T0)}) in below and above ground biomass is calculated, and the sequestration potential in the future period (C_{1(T0)}), lasting for a selected period t, i.e., 5 years, is calculated. These data are assigned to each tree in the database. This implies that we will also be able to find out the values of individual trees, and we will also be able to use them in the event that one or more specific trees are lost.

Calculations on the whole Set S showed that 90,000 metric tons of carbon (C_{0(T0)}) is stored in the whole Set S, representing 329,760 metric tons of stored CO2 (90,000 t C×3.664).

Furthermore, the calculation showed that if no special care is given to the Set S trees, they will sequester 6,000 metric tons of carbon (_{C1(T0)}), which is 21,984 metric tons of CO2 (which is an average of about 147 kg of CO2 per tree per year) over a period t (i.e., 5 years), until T1.

By completing the calculation, we are at moment T0. From our data stored in GIS, we can fetch the values of C0_{(T0)} and _{C1(T0)} to any Set S tree just as we can calculate these values for any set of trees, e.g., a street or a neighborhood.

Trees fitted with dendrometers and sensors to measure sap flow are also entered into the GIS. The locations of individual soil moisture sensors are also entered into the GIS.

The data obtained during the tree inventory and the calculations of C0 and C1 values are published on the City website, advantageously in the form of a map layer, which, when zoomed in, shows the data for each tree and for Set S trees, also shows the C0_{(T0)} and C_{1(T0)} values.

As soon as possible after moment T0, it is necessary to start implementing technical supporting measures for individual trees with the highest cost-effectiveness and lowest carbon footprint. Advantageously, to reduce the carbon footprint of implementing the measures, it is decided that they will only be carried out by local companies.

It is resolved that the City will prioritize efforts to address the 4 primary issues with existing trees that reduce their ecosystem service production and that were most frequently identified in the resulting recommendations for supporting measures:
Limited rootable space.
Compacted soil in the area of the root system
Drought
High soil pH.
Lack of nutrients in the rooting zone

It is advantageous to start with measures that can be implemented quickly, on a large scale, and with low costs. Other measures can be implemented staggered over the following years, considering the availability of resources for implementation, primarily financial and labor resources. Therefore, the main problems are ranked as follows:
Drought
High pH.
Lack of nutrients in the rooting zone.
Compacted soil in the area of the root system
Limited rootable space

As the implementation of some of the measures can be combined, it was determined that drought would be addressed as a separate task by watering, addressing high pH, nutrient deficiency, and compacted soil would be addressed as a combined task by air injection coupled with nutrient delivery if required and pH adjustment by surface application of elemental sulfur at a rate of 100 g/m2 if required. Limited rootable space will be addressed on a case-by-case basis.

### Implementation of Watering

Watering has been recommended for 20,000 trees in the inventory, with the other 10,000 growing on sites where watering is not needed or impossible. Watering will be carried out 4-5 times a year on Set S unless it is decided to stop due to sufficient rainfall based on meteorological observations and records from moisture and sap flow sensors. The watering dose was set in the range of 800-9,000 liters. In total, 400,000 m3 of water will be needed for the whole season unless the cycle is interrupted by sufficient rainfall, i.e., an average of 4,000 liters per tree. The water will be applied mainly by watering bags for mature trees (WO2021027980A1), which will also serve as advertising space for entities such as companies that will cover the cost of their purchase. In some cases, stationary drip irrigation will be installed.

Due to the geographical location of the city and its typical microclimate, watering will be carried out from the beginning of March to the end of October if the spoil temperature is not below 6° C. Although delivering water to trees by conventional water tankers for watering is feasible because the City has sufficient tankers, it was decided that an analysis would be conducted to determine which areas of the City would be better served by fire hydrants or watering from nearby natural water sources (streams, rivers, or rainwater reservoirs) to minimize the carbon footprint of irrigation.

Fixing compacted soil in the area of the root system, pH adjustment, and addressing nutrient deficiency.

These three causes of limited production of tree ecosystem services will be addressed in one operation. Out of 30,000 Set S trees, at least one of these three causes is present in 15,000. As this is a high number, the City will implement the measures by setting up 7 two-person teams within its staff, training them professionally, and renting depth soil injecting equipment such as the Biolift 1260 from MTM Spindler & Schmid GmbH.

This group of teams will move along routes optimized to avoid long transfers and treat designated trees for one season. With 10-15 trees per day per team, the workers should service all the trees in this period. They will perform the following operations according to the recommendations recorded in the GIS, but they may not all be applied to every tree:
aerating the compacted substrate with a depth soil injector.
the following substances will be added to the injection fluid:
   long-acting fertilizer for trees
   a mixture of mycorrhizal fungi specifically prepared for individual tree species
   superabsorbent polymer for drought-prone areas
a mixture of crystalline sulfur and humates in granules will be surface applied to the soil surface, advantageously to the entire surface of the root system, i.e., up to a distance equivalent to twice the crown projection from the trunk, which will allow better nutrient absorption in the long term by adjusting the pH downwards towards neutral. In areas of the root zone that are paved over, humates will be applied in powder form together with sulfur.

This measure will be repeated for each tree once every three years. As a precautionary measure against re-compaction of the soil, protective fences will be installed around the trees so that the overall need and cost of this measure will decrease over time.

### Proactive Measures

As part of the local legislation and subsequent practice, the following measures have also been taken to represent a proactive approach to tree care that will prevent damage to trees resulting in later removal for health or safety reasons:

A system for monitoring and elimination of stress factors for trees is developed and implemented, in particular:
Drought
Damage during construction activities
Soil compaction in the root zone
Damage by harmful organisms
Occurrence and elimination of semi-parasitic shrubs and lianas

All cutting wounds over 3 cm in diameter that occur during the trimming of trees in the City will be treated with Trichoderma virens to prevent infestation of the wounds with fungal pathogens, subsequent formation of cavities, and the need for tree removal.

All young trees will be pruned to avoid wounds larger than 3 cm, in particular:
Continuous formative or crown maintenance pruning each year after planting until the first 10 years on-site, at which time not a single pruning cut needs to be made during the inspection unless necessary.

This measure does not conflict with the measure for treating wounds with Trichoderma virens, as the rule applies mainly to young trees. In older trees, it is sometimes necessary to make a wound larger than 3 cm, mainly due to neglect of early formative pruning.

All trees, advantageously with a focus on the Set S trees, if feasible and advantageous in terms of the current situation, will be treated against potential damage by harmful organisms by macro or microinjection by applying biocidal products directly into the tree trunk. As a result of this rule, e.g. all horse chestnut trees in the City will be treated against horse-chestnut leaf miner as a preventive measure. The leaf miner causes premature leaf death and premature leaf drop, thus reducing the tree's assimilative capacity and ability to produce biomass. This results in less carbon being sequestered into the tree's tissues, so the carbon sequestration potential of the individual is not fully utilized. If the treatment is implemented, the tree's ability to produce ecosystem services will be maximized in combination with the other measures mentioned in this example.

Staff at all levels are trained in these measures and tree treatment technology to prevent future tree damage.

Limited rootable space will be addressed by expansion in any way, particularly by additional spaces filled with suitable substrate, in areas with traffic or human movement with structural substrate, or by retrofitting soil cells.

Expanding the rootable space will always be implemented when reconstruction of the roadway, sidewalk, construction, or similar occasion is underway and a Set S tree, preferably any prospective tree, is present in the working area of such operations. This may be, for example, a tree with a diameter smaller than the DBH set for the Project of more than 25 cm because after the end of the Project if it is decided to repeat the Project, a tree of this diameter may be already grown, become a member of Set S and provide more ecosystem services than would be the case without the measures. At the same time, the cost of expanding the rootable space of such a tree during the reconstruction is a fraction of the cost if this measure were carried out separately.

The expansion of the rootable space will be further implemented in stages to ensure that within 5 years of the period t, a sufficient rootable space, with a minimum depth of 0.5 m and a maximum depth of 1.5 m, of volume at least:
For large-crown trees: 25 m3
For medium-crown trees: 16 m3
For small-crown trees: 8 m3

The rule was adopted that, where possible, this rootable space will be at least double the values given above.

Data from dendrometers, moisture, and sap flow sensors are collected and evaluated. Accordingly, the deployment and implementation of already planned technical measures, such as watering, which may be interrupted due to sufficient water supply from rainfall, are adjusted.

Optimization of the management of waste produced by felling and trimming of trees in the City is underway, which has been burnt in piles or taken to landfill in the past. In larger projects, branches are left in place to protect the root space or converted into charcoal (biochar) by pyrolysis; the charcoal is then generally applied on-site to other growing trees as a means of soil amendment or is hauled away and used to plant new trees or to modify the substrate to expand the rootable space of existing trees.

In smaller projects, the waste is chipped and used for blanket mulching on surrounding trees, which supports soil microorganisms, including natural mycorrhizae. This avoids over-carriage, which creates a large carbon footprint, positively affects the trees' water management, and reduces the risk of soil compaction from trampling when people move under the tree.

Tree trunks that have so far been given to the citizens of the City for free as firewood are converted into permanent products, such as furniture, or left in place as lying dead wood so that they can be colonized by insects and fungi to support local biodiversity. This measure slows the release of carbon stored in tree biomass back into the atmosphere by either fixing the carbon completely in permanent products or slowing the release by slow decomposition of large pieces. By burning, the carbon would be immediately released into the atmosphere in the form of CO2. Alternatively, whole logs are converted to charcoal or buried deeply so that petrification, i.e., permanent storage of carbon underground, occurs. This measure is preferably carried out in the case of large soil manipulations and excavations during construction activity in the City, trenches are not dug separately for this purpose alone.

These technical measures are ongoing throughout period t.

It is advantageous that within the set period t, i.e., 5 years, the measures implemented are monitored and optimized. In this particular embodiment, the monitoring takes place at least once, advantageously twice, and most advantageously substantially continuously. The control focuses mainly on the following factors:
Whether a tree that is in Set S is still present and growing on the site, i.e., can its potential still be counted towards the production of ecosystem services. If the tree has been removed, it is necessary to determine the date of its removal, as this affects the overall balance of ecosystem services provided in the City.
According to the present invention, such removal of a Set S tree should only occur in the event of sudden damage by lightning, wind gusts, or other sudden event. In fact, Set S trees are selected to be able to perform their storage function well for a minimum of 5 years. If a tree is removed without justification, this is recorded in the tree inventory, and advantageously, the remover is forced to replace the ecosystem services of the tree with new planting according to a set rule where the annual carbon sequestration rate must be fully replaced by the annual carbon sequestration rate of the new planting.
Whether the measures being implemented are in line with the latest knowledge in the field and are correctly executed so as to maximize ecosystem services and not cause damage to trees that will lead to limitations in their stability and long-term prospects.
Whether the trees respond to the measures implemented, i.e., there is a visible, beneficial improvement in tree biomass growth. This can be seen, for example, by an increase in trunk diameter (DBH), the good healing of wounds on the tree, the visible growth of the tree on its shoots (branches), and other indicators of tree vitality.
Whether the data supplied by dendrometers, moisture- and sap flow sensors are correctly evaluated and the implementation of technical measures is adjusted accordingly.

It is advantageous to have this monitoring performed by an entity independent of the City to achieve objectivity in assessing the condition of individual trees. Advantageously, aerial photography or other remote sensing technologies may be used for this purpose.

After period t, i.e., at moment T1, an inventory of all Set S trees, advantageously all trees in the City, is taken. Advantageously, this inventory is performed using the same method as the inventory at moment T0. Advantageously, this inventory is entered into a GIS, more advantageously, the same GIS as the inventory at moment T0.

The minimum information requirements are the same as for the inventory in moment T0. Again, all data are stored in the GIS at the individual tree level.

The inventory showed that none of the 30,000 trees in Set S had been felled.

The total biomass of all Set S trees, advantageously all trees in the inventory, is calculated at the individual tree level. From this biomass mass, the mass of stored carbon in the tree C0 is determined by calculation, advantageously following the same procedure as the mass C0 was determined at moment T0. Moreover, in the same way, this mass C is converted to CO2 equivalent. Since the mass C was determined for moment T1, this mass will be called C0(T1). If the City chooses to repeat the project for another period t, which may take on a different value at the City's discretion (e.g., 10 years), it is appropriate at this point to also calculate the mass C1, i.e., the sequestration into the next period ending at moment T2. This amount of carbon is denoted as C1(T1).

The biomass calculation showed that at moment T1, 142,500 tonnes of carbon is stored in the Set S trees, which is 522, 120 tonnes of CO2. From these figures, it is possible to determine a value of C2(T1), which corresponds to the value of additional carbon sequestered in the Project at period t.

$${C}_{2 ( T 1 ) =} {C}_{0 {( T 1 )}^{-}} {C}_{0 {( T 0 )}^{-}} {C}_{1 ( T 0 )} = 142 , 500 - 90 , 000 - 6 , 000 = 46 , 500$$

Hence, 46,500 metric tons of carbon, equivalent to 170,376 metric tons of CO2, is the quantified main technical effect of the present invention in the form of additional carbon sequestration from the Earth's atmosphere. If we value this benefit at the value of a European emission allowance (EUR 100), we obtain a financial benefit of EUR 17,037,600.

Because the value of C0(T1) is greater than the value of C0(T0), the carbon stored in the Set S was kept from being released into the atmosphere and remained fixed in the tree tissues in the City. If it were to be released back into the atmosphere and were to be offset by the purchase of European emission allowances (€100), this volume of C0 would represent the equivalent of 329,760 tonnes of CO2 and a value of EUR 32,976,000.

Since the calculation of C2(T1) did not take a negative value that would have exceeded the value of C1(T0), the Project also maintained the sequestration potential for period t, which was 6,000 tonnes of carbon, i.e., the value of C1(T0). This mass of carbon converted to CO2 is 21,984 tonnes of CO2. If we value this contribution at the value of a European emission allowance (€100), we get a financial benefit of €2 198,400.

Not a single Set S tree was felled; only 10 large trees were replanted at other sites. It can be said that usually, without the application of the present invention, at least 200 trees would have been felled in period t. Since we do not know which specific trees would have been lost, the following calculation is approximate. If we calculate that these 200 trees contain, on average, only 2 tonnes of carbon (it may be more), we have therefore saved a total loss of 400 tonnes of stored carbon, which would probably have entered the atmosphere sooner or later. This amount represents 1465.60 tonnes of CO2. If we were to compensate for this volume of CO2 with European emission allowances (EUR 100 per tonne), this is a value of EUR 146 56.

If we calculate that these 200 trees would sequester only 150 kg of CO2 per year (it may be more, this average includes the effect of the situation where the tree was not cut down immediately after the beginning of period t, but also at the end of it), this is a fulfillment of the future sequestration potential of 30 tons of CO2 per year, and for the chosen period t it is 150 tons of CO2. That would not have occurred without the application of the invention. When valued at the value of a European emission allowance, this represents a saving of €15,000. This sequestration can, of course, continue beyond period t so that the savings can be more significant.

If we replaced these 200 potentially felled trees with new plantings at a 1:1 ratio, i.e., one new tree planted for every one felled, we would save the cost and loss of planting 200 trees. However, as the rule has been set that the replacement will be planted to replace CO2 sequestration in 1 year, more trees must be planted. Because the value of C1 varies for each Set S tree, and we cannot determine which tree would potentially be cut, we will assume that the value of annual sequestration will be the average value of C1(T0) per tree per year. This is, therefore, about 147 kg.

$$C 1 ( T 0 ) = 21 , 984 / 30 , 000 / 5 = 0.14656 tonnes = 146.56 kg$$

Typically, trees are planted in cities at the age of about 7 years. If we enter the parameters of such a tree into the allometric equation, we find that such a 7-year-old oak tree sequesters if it grows exceptionally well (DBH increment of 4 mm, height increment of 10 cm, which for a newly planted tree is exceptionally high value), approx. 2.14 kg of CO2. This means that 68 trees of this size would have to be planted for every large tree that felled. That is a total of 13,600 trees.

Data from our analysis of the Czech market and contracts concluded at the time of the invention's filing show that the cost of planting one tree in a city ranges from CZK 6,260 to CZK 302,090. If we take only a sober assumption of a price of CZK 15,000, the savings from planting trees is CZK 204,000,000.

Assuming that such a newly planted oak tree should reach maturity, it will need at least 50 m2 of land. That is 680,000 m2 of land needed to plant these 13,600 new trees. We do not have such an area available in the City, but if we did, and assumed that the price of buildable land per m2 would range from CZK 5,000 to CZK 69,870, and took into account the median price estimate of 1 m2 of such land, which is CZK 10,000, we would need CZK 136,000,000 to buy the land to plant 13,600 new trees.

In this example, where 200 trees are saved, there will also be a saving of planting material that is needed elsewhere, mainly to grow the overall tree canopy in the City's area. This will reduce the total number of trees the City needs in one year to accomplish its goals. This also significantly reduces the overall carbon footprint of new plantings in the City. If we assume that a newly planted tree leaves a carbon footprint of only 1.8 tCO2, the saving for not planting 13,600 new trees equates to 24,480 tCO2, which, in terms of the value of emission allowances, amounts to a saving of €2,448,000.

There are also savings from mitigating climate change immediately, not in 5 or 30 years. We cannot quantify this saving, but it is also a technical effect of the invention.

If we consider financial representation as a tool to evaluate the success of a project, its contribution, including just the basic benefits, can be summarized as follows:

| | |
|---|---|
| C2 | 17,037,600.00 € |
| C1 | 2,198,400.00€ |
| C0 | 32,976,000.00 € |
| Saving C avoiding felling | 146,560.00 € |
| Saving C1 avoiding felling | 15,000.00 € |
| Savings on planting costs | 8,500,000.00 € |
| Savings on land costs | 5,666,666.67 € |
| Savings for planting emissions | 2,448,000.00 € |
| Total savings | 68,988,226.67 € |

In addition to these relatively easily quantifiable benefits, the maximization of other ecosystem services can be considered a benefit of the Project. Such services include the cooling effect, the impact on the population's health, and many others.

If we wanted to know the overall economic effect of the Project, it would be necessary to know the costs of implementing the technical measures over period t. These are costly operations, but they certainly do not eliminate the amount of the Project's financial benefits.

We can assess the carbon footprint of the measures taken. If we convert the additional carbon sequestered in this case into the distance traveled by an average passenger car, which produces 251 g CO2/km (source: EPA, USA), the volume of carbon additionally sequestered is enough to offset 678 788 845 km driven.

With reckoning, the Project of the City ends. The City may or may not repeat the Project. The City chooses to repeat the Project because it is advantageous for two reasons. It will continue to meet the goals the City established at the beginning, and second, it will no longer be as costly to implement. Many of the most costly measures, such as expanding the rootable space, purchasing equipment to implement the measures, or conducting a detailed tree inventory, have already been done, which means that the costs of implementing another Project are significantly lower.

### Example 2

All as in Example 1 with the following difference.

The City shall include in the Project trees that grow on private property, company property, and other land, i.e., all other trees not owned by the City but located within the municipal territory of the City.

Because approximately 60% of the trees located within the municipal territory of the City grow on these properties, and 10% of the owners refuse to participate in the Project, the number of trees in the Project will double. Thus, the Project covers 200,000 trees, and their age and health status structure is roughly the same. Then, the Project's results can be expected to be roughly double.

### Example 3

All as in Example 1 and/or 2, except that there is at least one entity, called the Operator, widely recognized as being authorized to quantify and verify carbon credits and that there is a voluntary market for carbon credits. The City chooses to partially or fully finance technical measures to maximize the production of ecosystem services by selling carbon credits to be generated by Set S trees.

The City shall enter into a contract with the Operator that includes, but is not limited to:
The City's commitment to adhere to the Operator Protocol, a document that describes, among other things, how credits are quantified, the process for maximizing ecosystem services, and how losses are accounted for.
The City's commitment to protect Set S trees from being cut or damaged, and if this fails, the loss of carbon credit, if already sold, will be offset.
Operator's commitment to provide quantification and authentication of credits according to market practice so that credits can be sold in the market. The money from the sale belongs to the owner of the trees, in this case, the City, which advantageously undertakes to use it only to implement technical measures to maximize ecosystem services.

The Project thus becomes an Offset Project.

The Market Operator shall verify that the City's tree inventory is conducted in accordance with the Protocol and in a fair manner to ensure that carbon stocks are not overestimated, that carbon is not double counted by repeatedly including the same trees, that correct accounting occurs, and that the tree inventory system and the information therein is sufficient to quantify tree biomass.

If the information in the tree inventory is insufficient, the Operator shall order the inventory to be carried out again. The inventory can be carried out by the Operator as well as the biomass calculation, quantification of C0, C1 and C2 values.

The value of C0 is converted to K0 credits, where one K0 credit represents one metric tonne of CO2 stored in existing Set S trees.

The value of C1 is converted into K1 credits, where one K1 credit represents one metric tonne of CO2 to be sequestered in period t by the Set S trees. The correctness of the credit value shall be verified and confirmed by the Operator or another independent person, as appropriate.

Advantageously, these credits are localized so that the customer can purchase credit from a tree that grows in their neighborhood, thereby supporting not only carbon sequestration but also the production of other ecosystem services not only for themselves but also for loved ones or colleagues. Localization opens up opportunities for e.g. companies to look after a selected part of the City, e.g. because of the company's location or the intention to directly impact a specific location.

The Operator shall advantageously hold or create a reversal pool where credits (K0 and K1 separately) will be held in escrow to be used in the event of tree losses that the City could not have avoided (accidental explosion, windstorm, disease for which there is no countermeasure, and similar). The reversal pool shall be 0-50% of the total K0 and K1 credits, advantageously 10-40%, more advantageously 10-30%, and most advantageously 20%. These credits will be deposited, separately for K0 and K1, in the Operator's depository and can only be sold when the project is reckoned, and the balance shows that they are not needed to cover losses.

A reinsurance pool may also be created within these reversal pools to hold a portion of the credits from the reversal pools, advantageously 5-40%, more advantageously 5-20%, and most advantageously 10%. The Operator's reinsurance pool will be shared with all projects that the Operator manages and is used to cover large-scale losses to one project from the assets of other projects. Credits from the reinsurance pool will never be sold and will be used to cover large-scale damage, such as windstorms, where losses occur that are greater than the reversal pool of the damaged project and cannot be covered by the reversal pool of the project where the losses occurred. Alternatively, a level will be set that the reinsurance pool must reach to cover the risk of losses sufficiently. If the reinsurance pool reaches the required level, no further credits will be transferred from the reversal pools to the reinsurance pool. This minimum amount may be set, e.g., as a percentage of all credits issued by the Operator, or it may be set as an absolute number. The size and existence of the reinsurance pool are at the discretion of the Operator, who must be a trusted partner in the carbon credit market. The role of both types of pool is that if the tree from which a buyer purchased credits is lost, that value will be replaced by an existing credit representing the same volume and quality of offset.

The Operator or another entity will offer the credits on the carbon credit market. If the customer purchases the credits, the Operator shall provide the customer with a confirmation that the customer has offset his/her carbon footprint with such credits with a unique identification. The sold credit shall be marked, blocked, or otherwise restricted in the Operator's records to prevent it from being sold again. After resale, it would not represent the actual removal of 1 tonne of CO2 from the atmosphere. Advantageously, blockchain can be used for this purpose.

The Operator or another independent entity monitors the Project for a period t to ensure that the credits K0 and K1 still represent the actual removal of CO2 from the atmosphere. Once the monitoring determines that a Set S tree has been removed or, e.g., has demised, it is flagged, blocked, or otherwise restricted in the Operator's records so that it is not sold again. Advantageously, blockchain can be used for this purpose.

At the end of period t, at moment T1, when the second tree inventory is made, the Operator checks the completeness and accuracy of the inventory and quantifies and verifies the K2 credits from the C2 value, where 1 K2 credit represents 1 metric ton of CO2 additionally sequestered from the atmosphere by the Project.

An analysis of losses is made. After the reckoning, it is clear whether any losses have been incurred during the period t. If so, it is determined whether they were avoidable or unavoidable on the part of the City. The method of qualifying avoidable and unavoidable losses is set out in the Operator's Protocol. Losses are compensated for, with unavoidable losses being compensated from the reversal pool, and if losses exceed the reversal pool, from the reinsurance pool. Avoidable losses must be fully compensated by the City so that the customer can be reimbursed. This can be done, for example, by financial refund for the offset or by a commitment from a project that the City will do in the future as the next in the row.

Credits from the Project's reversal pool are sold on the market, as are K2 credits. The price of K0, K1, and K2 credits may not be the same because they are of different quality. K0 credits are conservation credits, usually priced lower, whereas K2 credits represent the most accurately measured, clearly, and unambiguously additional carbon offset that is unique.

The money for the credits sold is transferred to the City's account. The Operator may charge a fee for quantification, verification, and other services, such as a percentage of the quantified, verified, and sold credits.

If the credits were sold at the market price at the time of filing of this invention, and no losses occurred as in Example 1 embodiment of this invention, the City would receive these funds:

| | price for 1 credit | credits | Total price |
|---|---|---|---|
| K0 | 40.00 € | 329,760 | 13,190,400.00 € |
| K1 | 60.00 € | 21,984 | 1,319,040.00 € |
| K2 | 100.00 € | 170,376 | 17,037,600.00 € |
| Total | | | 31,547,040.00 € |

### Example 4

Everything is the same as in Example 3, except that the Operator only audits and verifies the credits, and the City or another market entity sells the credits at the price it can sell them. Thus, the Operator performs only an audit and verification function.

### Example 5

All as in examples 1, 2, 3, and 4, except that no technical measures are implemented to support the maximization of ecosystem services, but only measures to protect trees from being felled and to continue their natural sequestration rate will be implemented. This will generate credit K0 and K1 and may also generate credit K2, but will not take on the same values as in Examples 2 and 3. The main influences that may affect the natural increased carbon sequestration include, for example, fertile soils where fertility is above the average for which the standard allometric equations apply. Another such factor may be an increase in precipitation with an even distribution throughout the season, the optimal temperature throughout the season, no extreme temperature fluctuations and other meteorological phenomena, or prolongation of the season due to higher temperatures in spring and autumn. However, with climate change, such seasons will diminish.

### Example 6

All as before, but with the difference that no K0 credit will be sold and the Project will focus only on the additionally created, most accurately measured C1 and C2.

### Example 7

Remote sensing, advantageously using LIDAR, more advantageously using a combination of LIDAR and still cameras or video cameras, advantageously carried on mobile ground devices or flying devices or mobile phones or tablets with a LIDAR camera, is used to create a tree inventory and advantageously also to monitor the condition of the Set S trees. This inventory advantageously takes place when there are no leaves on the trees, and the biomass calculation is represented directly by the measured biomass, including the thinnest branches. If the wind is blowing, it is necessary to use an algorithm to eliminate branches swayed by the wind error in the point cloud.

### Example 8

All as in the previous examples, where instead of a carbon credit, an Ecosystem Credit is defined to represent all or selected ecosystem services provided by the tree. It, therefore, represents a value many times higher and is directly related to the fact that the customer pays not only for offsetting his carbon footprint but also for a healthy and pleasant stay in a place where he frequents or a place he chooses.

### Example 9

Everything as in other examples, but the Project is created and executed at the request of the customer interested in buying such credits, e.g., because his company is located in the area.

### Example 10

All as in the previous examples, but the project organizer, i.e., the owner of the trees, is not a city, a local government, or their appointed tree manager, but a person who has a tree or several trees on his/her private property, e.g., a garden. This case helps motivate private owners to take intensive care and mitigate climate change.

### Example 11

All as in the previous examples, but the project organizer is not a city or a private person, but a company that owns the trees in the company's premises.

### Example 12

All as in the previous examples, but the project is organized by an owner of an institutional green space, e.g., a school, hospital, zoo, and similar institutions.

### Example 13

All as in the previous examples, but the project is organized by an owner of a linear green space, e.g., a road administration or an electricity distribution network administration, which manages the green space near the power lines.

### Example 14

All as in the previous examples, but the project organizer is a forest owner or a manager appointed by him who, in addition to commercial timber production, owns one or more significant trees that provide a significant amount of ecosystem services. In this way, the owner does not cut these trees, maintains a large production of ecosystem services for society, including carbon storage and sequestration, and is rewarded for this. He can also profitably apply measures to maximize ecosystem services and thereby optimize his/her profit.

### Example 15

All as in the previous examples, vehicles and devices that capture map images (e.g., googlemaps street view vehicles) will be used for the green spaces inventory and biomass quantification.

### Example 16

All as in the previous examples, but the costs of technical measures will be paid by the citizens just to have, for example, a more beautiful tree in front of their house.

### Example 17

All as in the previous examples, but the project is organized by an owner or manager of a non-forest land outside the municipality built-up area where a tree with significant production of ecosystem services grows alone or in a group. This is, for example, a group of trees or a solitary tree in a meadow used as a production area for forage for animals.

### Example 18

All as in the previous examples, except that in addition, saving large trees, promoting their growth, and watering trees are used intentionally to cool the microclimate of the place where they grow on hot days, using the principle of maximizing evapotranspiration with sufficient water supply. The measure consists of watering trees on hot days, advantageously in the early morning hours, when tree watering takes place, instead of street sprinkling or similar measures. Hot periods are generally associated with a decrease in the water content of the soil and a reduction in the sap flow in the tree. Sufficient water availability keeps the sap flow and evapotranspiration rate at their maximum, leading to maximum utilization of the tree's ability to cool the surrounding area. The result is not only a maximum use of the tree's ability to cool the space but also a more even distribution of microclimate cooling over time because cooling occurs gradually, mainly through leaf stomata, and cooler air is kept in the canopy space and not escape from the space as with other measures. It also results in a more significant shading effect because, especially in some tree species, trees' natural heat defense mechanism, turning the leaves from horizontal to vertical to reduce the leaf area sun exposure, is reduced. This affects the Leaf Area Index (LAI) in a situation without watering; it is reduced because vertically positioned leaves cast less shade on the area under the tree. Reducing this natural phenomenon causes the lower branches not to receive as much sunlight and keep cooler air in the crown, and also more sunlight is reflected back upwards into the space by the leaves on the upper levels of the crown. This is also noticeable at night when the trees can be warmer than the surroundings, radiating heat and warming the surroundings. Reducing energy radiation overnight leads to a reduction in thermal discomfort for inhabitants and other biota in space, as well as the associated health complications and financial and energy losses. This prevents further greenhouse gas emissions and the worsening of climate change because these losses, among other things, cause greenhouse gas emissions, especially CO2, by, for example, having to cool rooms with air conditioning, providing more intensive health care, and similar.

All as in the previous examples, but the K1 credits from moment T0 will be sold after moment T1, when it is confirmed that the tree still exists on the site.

### INDUSTRIAL APPLICABILITY

The invention is applicable for the purpose of reducing the CO2 levels in the atmosphere by additional carbon sequestration in existing trees through appropriate tree selection and the implementation and optimization of supporting measures, in particular for improving their habitat, and the method according to the present invention is effective in combating climate change.

What is claimed is:

1. A method of reducing atmospheric CO2 levels by additional carbon sequestration in existing trees through appropriate tree selection and optimization of supporting measures, comprising the following steps:
(A) definition of a territory where measures under this method are to be implemented;
(B) selection of a Set S trees, where the Set S of trees represents trees that are important for carbon sequestration into biomass and are suitable candidates for implementation of supporting measures and to be included in a conservation scheme; and
(C) implementation of supporting measures on Set S trees that ensure maximum carbon sequestration over a longest possible period and minimize costs of managing and implementing these supporting measures.

2. The method according to claim 1, further comprising the following intermediate steps, such that step A comprises:
determination of period t for which the supporting measures are to be implemented according to step C; and
determination of moment T0, starting with a tree biomass calculation or a moment of performing an inventory of a specific tree;
whereby step B concerning the selection of Set S includes:
performing a tree inventory, with a definition of technical measures for the implementation during period t;
calculating the biomass of trees, advantageously all of the trees, less advantageously only on Set S trees, down to a single tree level;
determination of C0(T0) for each tree for which a biomass calculation has been performed, where C0(T0) is a total mass of carbon, typically given in metric tons, contained in an above-ground biomass of the tree, advantageously in the above-ground and below-ground biomass of the Set S tree at moment T0;
determination of C1(T0) for each tree for which a biomass calculation has been performed, where C1(T0) is a total mass of carbon, usually given in metric tons, that is assumed, at moment T0, based on current scientific knowledge, to be sequestered naturally by the Set S tree over period t if the tree is allowed to grow, will not be felled and no other technical measures will be carried out on the tree that will cause additional growth;
ranking the measures designed within the inventory process into groups and prioritizing these groups of measures, with speed and lowest cost being main decision-making factors, or a most favorable ratio between resource requirement and achieved performance, where CO2 emissions are also a resource, and where the measures work synergistically together;
whereby the supporting measures according to step C are implemented at period t and optimized during period t, such that:
after an end of period t, at moment T1, the inventory of Set S trees is made, advantageously of all the trees in the territory, advantageously with designing recommended measures for a next round at period t2, where period t2 represents a following time period chosen for repeating the implementation of the steps according to the above-described procedure, and advantageously immediately following moment T1;
followed by a determination of C0(T1) and advantageously also C1(T1), for Set S trees, advantageously for all trees in the territory, as preparation for the next round at period t2, wherein C0(T1) is a total mass of carbon, typically given in metric tons, contained in the above-ground, advantageously in the above-ground and below-ground biomass of the tree at moment T1, wherein C1(T1) is the total mass of carbon, typically given in metric tons, which is predicted, at moment T1, based on current scientific knowledge, to be sequestered naturally by the Set S tree throughout period t2 if the tree is allowed to grow, is not cut down, and no other technical measures are performed on the tree to cause additional growth of the tree, and
a calculation is made of C2(T1), where C2(T1) is the total mass of carbon, usually given in metric tons, that has been additionally sequestered by the Set S tree only due to the adoption and implementation of the supporting measures during period t, where the additionally sequestered carbon of mass C2 is calculated according to the following formula:
$$C {2}_{( T 1 ) =} {C}_{0 ( T 1 ) -} {C}_{0 ( T 0 ) -} {C}_{1 ( T 0 )}$$
alternatively, C2 is expressed in CO2 equivalent, in metric tons.

3. The method according to claim 2, further comprising steps of promoting the implementation of the supporting measures, wherein, after calculating C0, C1, and C2, the mass of carbon represented by these quantities is advantageously converted into a CO2 mass equivalent and this mass is converted into localized carbon credits K0, K1, and K2, which represent an expression of a value of the stored or sequestered CO2 in the Set S tree, wherein one carbon credit corresponds to a predefined mass of CO2, wherein advantageously one credit corresponds to one metric ton of a given category C0, C1 and C2 converted to a CO2 equivalent, wherein the carbon credits are further expressed such that:
K0 credits represent the conservation strategy, and a total of the K0 credits corresponds to the mass of CO2 stored in the tree at moment T0;
K1 credits represent a transition between conservation and sequestration strategies, and a total number of K1 credits is equal to a mass of CO2 most likely to be sequestered in the tree in future period t naturally, without any additional intervention, and
K2 credits represent a sequestration strategy, additional carbon sequestered through supporting measures with the coproduction of co-benefits serving as a representation of a volume of carbon stored or sequestered for sale in the carbon offset market;
whereby K0 and K1 credits, like K2, can be sold on the carbon credit market.

4. The method according to claim 1, wherein in the selection of Set S trees according to step B, one or more of the following criteria are met:
the criterion of trunk diameter, where the trunk diameter exceeds 15 cm, advantageously 20 cm, and most advantageously 25 cm;
and/or a health criterion where trees in worse than good health are excluded from selection;
and/or a vitality criterion describing a viability of the tree as a living organism, where trees with worse than slightly reduced vitality are excluded from selection, and/or a stability criterion consisting of an estimate of a potential threat to operational safety posed by the individual based on observable branching defects, trunk infections, presence of cavities or cracks in the trunk and crown, or visible root disturbance, excluding trees whose stability is worse than that corresponding to a moderate disturbance of the stability conditions,
and/or a value of a biomechanical analysis, as determined by a system using a LIDAR scan on a mobile device or mobile phone or tablet, or photographic analysis, takes on values for which the tree is qualified as safe by the originator of such a system.

5. The method according to claim 1, wherein the supporting measures according to step C comprise a proactive approach to avoid threats to the Set S tree, consisting of the existence of factors including drought and/or damage during construction activities and/or soil compaction in a root zone and/or damage by pest organisms and/or a presence of semi-parasitic shrubs and lianas.

6. The method according to claim 1, wherein, in order to check the effectiveness of the support measures according to step C, a dendrometer is installed on any Set S tree, preferably on all Set S trees, advantageously connected to a city LPWAN or LPWA or similar data transmission network, wherein the dendrometer is used for accurate monitoring of tree stem growth and/or for evaluating a response to technical measures to maximize ecosystem service production and/or for early detection of drought stress by monitoring fluctuations in stem water potential.
